(19) United States
(12) Patent Application Publication
(10) Pub. No.: US 2016/0344708 A1
(43) Pub. Date: Nov. 24, 2016

(54) CRYPTOGRAPHIC SYSTEM, RE-ENCRYPTION KEY GENERATION DEVICE, RE-ENCRYPTION DEVICE, AND CRYPTOGRAPHIC COMPUTER READABLE MEDIUM

(71) Applicant: MITSUBISHI ELECTRIC CORPORATION, Tokyo (JP)

(72) Inventors: Yutaka KAWAI, Tokyo (JP); Katsuyuki TAKASHIMA, Tokyo (JP)

(73) Assignee: MITSUBISHI ELECTRIC CORPORATION, Tokyo (JP)

(21) Appl. No.: 15/111,227

(22) PCT Filed: Jan. 14, 2014
(86) PCT No.: PCT/JP2014/050445

§ 371 Date: Jul. 13, 2016

(51) Int. Cl. H04L 29/06

(52) U.S. Cl. CPC H04L 63/0464; H04L 63/061

(57) ABSTRACT

An encryption device (200) outputs a ciphertext ct₀ in which is set one of attribute information x₀ and attribute information v₀ corresponding to each other. A decryption device (300) receives a decryption key k* in which is set the other one of the attribute information x₀ and the attribute information v₀, and outputs a re-encryption key rk₁ that includes a decryption key k*^{rk}₀ obtained by converting the received decryption key k* with conversion information r₁, and includes a ciphertext ct′₁ obtained by encrypting the conversion information r₁ with one of attribute information x₁ and attribute information v₁ corresponding to each other being set. A re-encryption device (400) outputs a re-encrypted ciphertext ct₁ that includes a session key K′₀ obtained by decrypting the ciphertext ct₀ with the decryption key k*^{rk}₀, and includes the ciphertext ct′₁.

### TECHNICAL FIELD

The present invention relates to a functional proxy re-encryption (FPRE) scheme.

### BACKGROUND ART

Proxy re-encryption (PRE) is a system which allows decryption rights for ciphertexts to be delegated to third parties without decrypting the ciphertexts. Non-Patent Literature 1 describes an identity-based PRE (IBPRE) scheme. Non-Patent Literature 2 describes an attribute-based PRE (ABPRE) scheme. According to the PRE scheme described in Non-Patent Literature 2, only attributes consisting of AND and negative elements can be specified for ciphertexts.

Patent Literature 1 describes a functional encryption (FE) scheme. Non-Patent Literature 3 describes an FPRE scheme.

### CITATION LIST

### Patent Literature

Patent Literature 1: JP 2012-133214 A

### Non-Patent Literature

Non-Patent Literature 1: M. Green, and G. Ateniese, Identity-Based Proxy Re-encryption. In Applied Cryptography and Network Security. volume 4521 of LNCS, pp 288-306, 2007.

Non-Patent Literature 2: Xiaohui Liang, Zhenfu Cao, Huang Lin, Jun Shao. Attribute based proxy re-encryption with delegating capabilities. ASIA CCS 2009 pp.276-286.

Non-Patent Literature 3: Yutaka Kawai and Katsuyuki Takashima, Fully-Anonymous Functional Proxy-Re-Encryption. Cryptology ePrint Archive: Report 2013/318

Non-Patent Literature 4: Canetti and S. Hohenberger. Chosen-Ciphertext Secure Proxy Re-encryption. In ACMCCS 2007.

Non-Patent Literature 5: Okamoto, T Takashima, K.: Decentralized Attribute-Based Signatures. ePrint http://eprint.iacr.org/2011/701

Non-Patent Literature 6: Okamoto, T Takashima, K.: Fully Secure Unbounded Inner-Product and Attribute-Based Encryption. ePrint http://eprint.iacr.org/2012/671

Non-Patent Literature 7: Okamoto, T., Takashima, K.: Achieving Short Ciphertexts or Short Secret-Keys for Adaptively Secure General Inner-Product Encryption. CANS 2011, LNCS, vol. 7092, pp. 138-159 Springer Heidelberg (2011).

### SUMMARY OF INVENTION

### Technical Problem

In the FPRE scheme described in Non-Patent Literature 3, when an original ciphertext created by an encryption algorithm is re-encrypted, the size of the ciphertext increases threefold. When the re-encrypted ciphertext is further re-encrypted, the size of the ciphertext further increases threefold. That is, when re-encryption is executed n times, the size of the ciphertext becomes 3ⁿ times as large compared to the size of the original ciphertext. The size of the ciphertext increases exponentially with the number of re-encryption times.

It is an object of the present invention to implement an FPRE scheme that reduces the amount of increase in the size of a ciphertext caused by re-encryption.

### Solution to Problem

A cryptographic system according to the present invention implements a proxy re-encryption function in a cryptographic scheme according to which when two pieces of information correspond to each other, a ciphertext in which is set one of the two pieces of information is capable of being decrypted with a decryption key in which is set the other one of the two pieces of information, and the cryptographic system includes:

an encryption device to output a ciphertext ct₀ in which is set one of attribute information x₀ and attribute information v₀ corresponding to each other;

a re-encryption key generation device to acquire a decryption key k* in which is set the other one of the attribute information x₀ and the attribute information v₀, and output a re-encryption key rk₁ that includes a decryption key k*^{rk}₀ obtained by converting the acquired decryption key k* with conversion information r₁, and includes a ciphertext ct′₁ obtained by encrypting the conversion information r₁ with one of attribute information x₁ and attribute information v₁ corresponding to each other being set; and

a re-encryption device to output a re-encrypted ciphertext ct₁ that includes a session key K′₀ obtained by decrypting the ciphertext ct₀ with the decryption key k*^{rk}₀, and includes the ciphertext

### Advantageous Effects of Invention

In a cryptographic system according to the present invention, a re-encryption key rk includes a session key obtained by decrypting a ciphertext with a decryption key converted with conversion information, and also includes a ciphertext obtained by encrypting the conversion information so as to allow decryption by a user at a forwarding destination. This makes it possible to reduce the amount of increase in the size of a ciphertext caused by re-encryption.

### BRIEF DESCRIPTION OF DRAWINGS

FIG. 1 is an explanatory drawing of a matrix M̂;

FIG. 2 is an explanatory drawing of a matrix M_{δ};

FIG. 3 is an explanatory drawing of s₀;

FIG. 4 is an explanatory drawing of s^{→T};

FIG. 5 is a configuration diagram of a cryptographic system 10 that implements a CP-FPRE scheme;

FIG. 6 is a functional block diagram illustrating the function of a key generation device 100;

FIG. 7 is a functional block diagram illustrating the function of an encryption device 200;

FIG. 8 is a functional block diagram illustrating the function of a decryption device 300;

FIG. 9 is a functional block diagram illustrating the function of a re-encryption device 400;

FIG. 10 is a functional block diagram illustrating the function of a re-encrypted ciphertext decryption device 500;

FIG. 11 is a flowchart illustrating the process of a Setup algorithm;

FIG. 12 is a flowchart illustrating the process of a KG algorithm;

FIG. 13 is a flowchart illustrating the process of an Enc algorithm;

FIG. 14 is a flowchart illustrating the process of an RKG algorithm;

FIG. 15 is a flowchart illustrating the process of an REnc algorithm;

FIG. 16 is a flowchart illustrating the process of a Dec1 algorithm;

FIG. 17 is a flowchart illustrating the process of a Dec2 algorithm;

FIG. 18 is a flowchart illustrating the process of the Setup algorithm;

FIG. 19 is a configuration diagram of a cryptographic system 10 that implements a KP-FPRE scheme;

FIG. 20 is a functional block diagram illustrating the function of a key generation device 100;

FIG. 21 is a functional block diagram illustrating the function of an encryption device 200;

FIG. 22 is a functional block diagram illustrating the function of a decryption device 300;

FIG. 23 is a functional block diagram illustrating the function of a re-encryption device 400;

FIG. 24 is a functional block diagram illustrating the function of a re-encrypted ciphertext decryption device 500;

FIG. 25 is a flowchart illustrating the process of a KG algorithm;

FIG. 26 is a flowchart illustrating the process of an Enc algorithm;

FIG. 27 is a flowchart illustrating the process of an RKG algorithm;

FIG. 28 is a flowchart illustrating the process of an REnc algorithm;

FIG. 29 is a flowchart illustrating the process of a Dec1 algorithm;

FIG. 30 is a flowchart illustrating the process of a Dec2 algorithm; and

FIG. 31 is a diagram illustrating an example of a hardware configuration of each device of the cryptographic system 10 presented in Embodiments 1 to 4.

### DESCRIPTION OF EMBODIMENTS

Notations to be used in the following description will be described.

When A is a random variable or distribution, Formula 101 denotes that y is randomly selected from A according to the distribution of A. That is, y is a random number in Formula 101.

y [symbol] A [Formula 101]

When A is a set, Formula 102 denotes that y is uniformly selected from A. That is, y is a uniform random number in Formula 102.

y [symbol] A [Formula 102]

Formula 103 denotes that y is set, defined, or substituted by z.

y:=z [Formula 103]

When a is a fixed value, Formula 104 denotes that a machine (algorithm) A outputs a on input x.

A(x)→α [Formula 104]

For example,

A(x)→1

Formula 105, namely F_{q}, denotes a finite field of order q.

[symbol]

_{q} [Formula 105]

A vector symbol denotes a vector representation over the finite field F_{q}, as indicated in Formula 106.

\vec{x} denotes

(x₁, . . . , xₙ)∈ [symbol] _{q}ⁿ. [Formula 106]

Formula 107 denotes that the inner-product, indicated in Formula 109, of two vectors x\vec{} and v\vec{} indicated in Formula 108.

\vec{x}·\vec{v} [Formula 107]

\vec{x}=(x₁, . . . , xₙ),

\vec{v}=(v₁, . . . , vₙ₎, [Formula 108]

Σᵢ₌₁ⁿxᵢvᵢ [Formula 109]

Note that X^{T} denotes the transpose of a matrix X.

For a basis B and a basis B* indicated in Formula 110, Formula 111 is established.

[symbol]

:=(b₁, . . . , b_{N}),

[symbol]

*:=(b*₁, . . . , b*_{N}) [Formula 110]

(x₁, . . . , x_{N}) [symbol] :=Σᵢ₋₁^{N}xᵢbᵢ,

(y₁, . . . , y_{N}) [symbol] *:=Σᵢ₌₁^{N}yᵢb*ᵢ [Formula 111]

Note that e\vec{}ⱼ denotes a normal basis vector indicated in Formula 112.

$${\vec{e}}_{j} \text{:} ( \overbrace{0 … 0}^{j - 1} , 1 , \overbrace{0 … 0}^{n - j} ) ∈ {𝔽}_{q}^{n} for j = 1 , … , n , \qquad [ Formula 112 ]$$

In the following description, when Vt, nt, wt, zt, nu, wu, and zu are each represented as a subscript or superscript, these Vt, nt, wt, zt, nu, wu, and zu respectively denote Vₜ, nₜ, wₜ, zₜ, nᵤ, wᵤ, and zᵤ. Likewise, when δi,j is represented as a superscript, this δi,j denotes δ_{i,j}. Likewise, when φj is represented as a superscript, this φj denotes φⱼ.

When→denoting a vector is attached to a subscript or superscript, it is meant that this→is attached as a superscript to the subscript or superscript.

### Embodiment 1

This embodiment describes a basic concept for implementing an FPRE scheme, and then describes a structure of the FPRE scheme according to this embodiment.

First, FPRE will be briefly described.

Second, a space having a rich mathematical structure called “dual pairing vector spaces (DPVS)” which is a space for implementing the FPRE scheme will be described.

Third, a concept for implementing the FPRE scheme will be described. Here, a span program, an inner-product of attribute vectors and an access structure, and a secret distribution scheme (secret sharing scheme) will be described.

Fourth, the FPRE scheme according to this embodiment will be described. In this embodiment, a ciphertext-policy FPRE scheme (CP-FPRE) scheme will be described. First, a basic structure of the CP-FPRE scheme will be described. Then, a basic configuration of a cryptographic system 10 that implements the CP-FPRE scheme will be described. Then, the CP-FPRE scheme and the cryptographic system 10 according to this embodiment will be described in detail.

<1. FPRE>

FPRE is a proxy re-encryption scheme which provides more sophisticated and flexible relations among an encryption key (ek), a decryption key (dk), and a re-encryption key (rk).

FPRE has the following two properties.

First, attribute information x and attribute information v are respectively set in an encryption key and a decryption key. If and only if a relation R(x, v) holds, a decryption key dkᵥ can decrypt a ciphertext encrypted with an encryption key ekₓ.

Second, in addition to the attribute information x and the attribute information v being respectively set in the encryption key and the decryption key, two pieces of attribute information (x′, v) are set in a re-encryption key. If and only if R(x, v) holds, a re-encryption key rk_{(x′,v)} can transform a ciphertext encrypted with the encryption key ekₓ to a ciphertext which can be decrypted with a decryption key dk_{v′} with which R(x′, v′) holds, that is, to a ciphertext encrypted with an encryption key ek_{x′}.

In a case where a relation R is an equality relation, that is, R(x, v) holds if and only if x=v, this PRE scheme is IDPRE.

ABPRE is available as more generalized PRE than IDPRE. In ABPRE, attribute information which is set in an encryption key and attribute information which is set in a decryption key are each a set of attribute information. For example, the attribute information which is set in the encryption key is X:=(x1, . . . , xd), and the attribute information which is set in the decryption key is V:=(v1, . . . , vd)

An equality relation for each pair of components of the attribute information (for example, {xₜ=vₜ}t ∈ {1, . . . , d}) is input to an access structure S, and R(X, V) holds if and only if the access structure S accepts this input. That is, a ciphertext encrypted with the encryption key can be decrypted with the decryption key. Non-Patent Literature 2 proposes a ciphertext-policy PRE scheme according to which an access structure S is embedded in a ciphertext. The access structure in this case consists of only AND and negative elements.

There is ordinary FE in which a ciphertext forwarding function does not exist, that is, a re-encryption key does not exist. In FE, a re-encryption key and a re-encryption process do not exist, and attribute information x and attribute information v are respectively set in an encryption key and a decryption key. If and only if a relation R(x, v) holds, a decryption key dkᵥ:=(dk, v) can decrypt a ciphertext encrypted with an encryption key ekₓ:=(ek, x).

<2. Dual Pairing Vector Spaces>

First, symmetric bilinear pairing groups will be described.

Symmetric bilinear pairing groups (q, G, G^{T}, g, e) are a tuple of a prime q, a cyclic additive group G of order q, a cyclic multiplicative group G^{T} of order q, g≠0 ∈ G, and a polynomial-time computable nondegenerate bilinear pairing e:G×G→G_{T}. The nondegenerate bilinear pairing signifies e(sg, tg)=e(g, g)^{st}, and e(g, g)≠1.

In the following description, let G_{bpg} be an algorithm that takes as input 1^{λ} and outputs values of a parameter param_{G}:=(q, G, G_{T}, g, e) of bilinear pairing groups with a security parameter λ.

Dual pairing vector spaces will now be described.

Dual pairing vector spaces (q, V, G_{T}, A, e) can be constructed by a direct product of the symmetric bilinear pairing groups (param_{G}:=(q, G, G_{T}, g, e)). The dual pairing vector spaces (q, V, G_{T}, A, e) are a tuple of a prime q, an N-dimensional vector space V over F_{q} indicated in Formula 113, a cyclic group G_{T} of order q, and a canonical basis A:=(a₁, . . . , a_{N}) of the space V, and have the following operations (1) and (2), where aᵢ is as indicated in Formula 114.

$$\begin{matrix}𝕍 := \overbrace{𝔾 \times … \times 𝔾}^{N} & [ Formula 113 ] \\ {a}_{i} := ( \overbrace{0 , … , 0}^{i - 1} , g , \overbrace{0 , … , 0}^{N - i} ) & [ Formula 114 ]\end{matrix}$$

Operation (1): Nondegenerate bilinear pairing

A pairing in the space V is defined by Formula 115.

e(x, y):=Πᵢ₌₁^{N}e(Gᵢ,Hᵢ)∈ [symbol] _{T} [Formula 115]

where

(G₁, . . . G_{N}):=x∈ [symbol] ,

(H₁, . . . H_{N}):=y∈

[symbol]

This is nondegenerate bilinear, that is, e(sx, ty)=e(x, y)^{st} and if e(x, y)=1 for all y ∈ V, then x=0. For all i and j, e(aᵢ, aⱼ)=e(g, g)^{δi,j}, where δ_{i,j}=1 if i=j, and δ_{i,j}=0 if i≠j, and e(g, g)≠1 ∈ G_{T}.

Operation (2): Distortion Maps

Linear transformations φ_{i,j} on the space V indicated in Formula 116 can achieve Formula 117.

$$\begin{matrix}If {φ}_{i , j} ( {a}_{j} ) = {a}_{i} and \\ k \neq j , then {φ}_{i , j} ( {a}_{k} ) = 0. & [ Formula 116 ] \\ {φ}_{i , j} ( x ) := ( \overbrace{0 , … , 0}^{i - 1} , {g}_{j} , \overbrace{0 , … , 0}^{N - i} ) & [ Formula 117 ] \\ where \\ ( {g}_{1} , … {g}_{N} ) := x . & \end{matrix}$$

The linear transformations φ_{i,j} will be called distortion maps.

In the following description, let G_{dpvs} be an algorithm that takes as input 1^{λ} (λ ∈ natural number), N ∈ natural number, and values of a parameter param_{G}:=(q, G, G_{T}, g, e) of bilinear pairing groups, and outputs values of a parameter paramᵥ:=(q, V, G_{T}, A, e) of dual pairing vector spaces with a security parameter λ and an N-dimensional space V.

Description will be directed herein to a case where the dual pairing vector spaces are constructed using the above-described symmetric bilinear pairing groups. The dual pairing vector spaces can also be constructed using asymmetric bilinear pairing groups. The following description can easily be adapted to a case where the dual pairing vector spaces are constructed using asymmetric bilinear pairing groups.

<3. Concept for Implementing FPRE Scheme>

<3-1. Span Program>

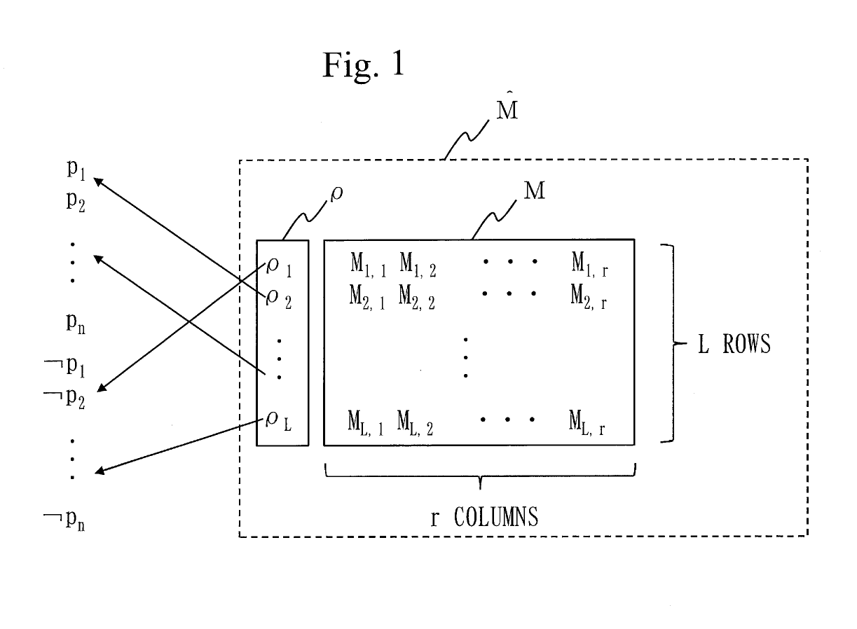

FIG. 1 is an explanatory drawing of a matrix M̂.

Let {p₁, . . . , pₙ} be a set of variables. M̂:=(M, ρ) is a labeled matrix. The matrix M is an (L rows×r columns) matrix over F_{q}, and ρ is a label of columns of the matrix M and is related to one of literals {p₁, . . . , pₙ, [symbol] p₁, . . . , [symbol] pₙ}. A label ρᵢ (i=1, . . . , L) of each row of M is related to one of the literals. That is, ρ:{1, . . . , L}→{p₁, . . . , pₙ, [symbol] p₁, . . . , [symbol] pₙ}.

For every input sequence δ ∈ {0, 1}ⁿ, a submatrix M_{δ} of the matrix M is defined. The matrix M_{δ} is a submatrix consisting of those rows of the matrix M the labels ρ of which are related to a value “1” by the input sequence δ. That is, the matrix M_{δ} is a submatrix consisting of the rows of the matrix M which are related to pᵢ such that δ=1 and the rows of the matrix M which are related to [symbol] pᵢ such that δᵢ=0.

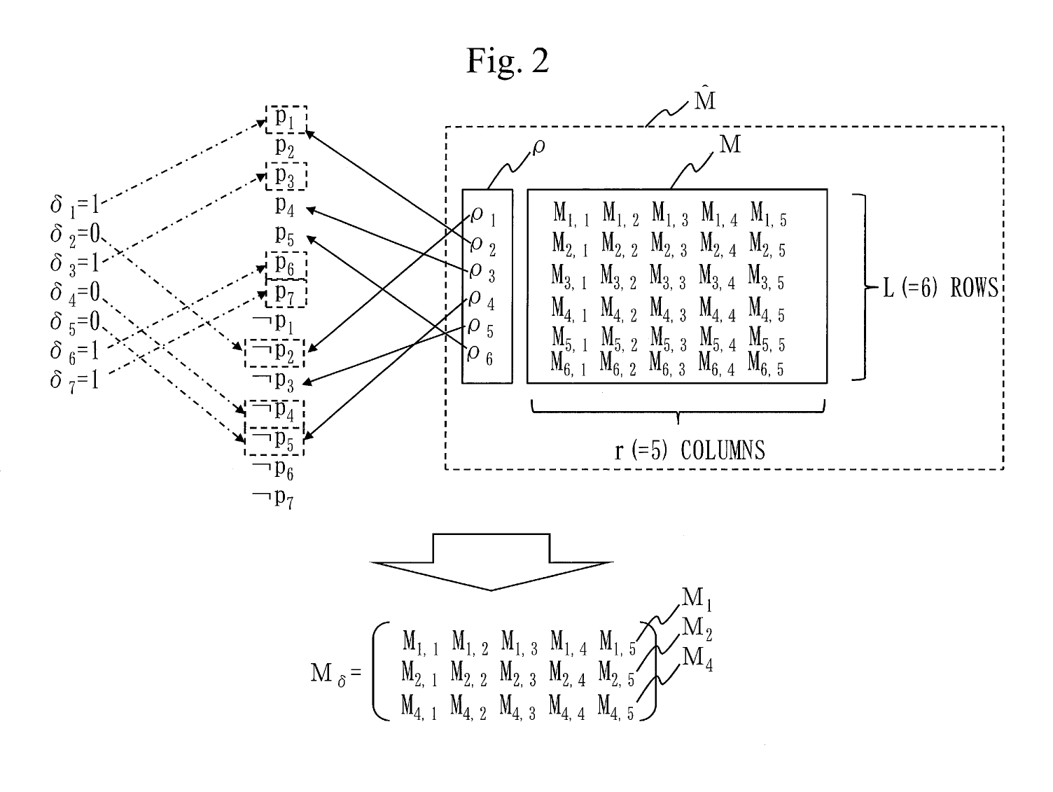

FIG. 2 is an explanatory drawing of the matrix M_{δ}. In FIG. 2, note that n=7, L=6, and r=5. That is, the set of variables is {p₁, . . . , p₇}, and the matrix M is a (6 rows×5 columns) matrix. In FIG. 2, assume that the labels ρ are related such that ρ₁ is related to [symbol] p₂, ρ₂ to p₁, ρ₃ to p₄, ρ₄ to [symbol] p₅, ρ₅ to [symbol] p₃, and ρ₆ to p₅.

Assume that in an input sequence δ ∈ {0, 1}⁷, δ₁=1, δ₂=0, δ₃=1, δ₄=0, δ₅=0, δ₆=1, and δ₇=1. In this case, a submatrix consisting of the rows of the matrix M which are related to literals (p₁, p₃, p₆, p₇, [symbol] p₂, [symbol] p₄, [symbol] p₅) surrounded by broken lines is the matrix M_{δ}. That is, the submatrix consisting of the first row (M₁), second row (M₂), and fourth row (M₄) of the matrix M is the matrix M_{δ}.

In other words, when map γ:{1, . . . , L}→{0, 1} is [ρ(j)=pᵢ] [symbol] [δᵢ=1] or [ρ(j)= [symbol] pᵢ] [symbol] [δᵢ=0], then γ(j)=1; otherwise γ(j)=0. In this case, M_{δ}:=(Mⱼ)_{γ(j)=1}. Note that Mⱼ is the j-th row of the matrix M.

That is, in FIG. 2, map γ(j)=1 (j=1, 2, 4), and map γ(j)=0 (j=3, 5, 6). Hence, (Mⱼ)_{γ(j)=1} is M₁, M₂, and M₄, and is the matrix M_{δ}.

More specifically, whether or not the j-th row of the matrix M is included in the matrix M₆₇ is determined by whether the value of the map y(j) is “0” or “1”.

The span program M̂ accepts an input sequence δif and only if 1^{→} ∈ span<M_{δ}>, and rejects the input sequence δ otherwise. That is, the span program M̂ accepts the input sequence δ if and only if linear combination of the rows of the matrix M_{δ} which are obtained from the matrix M̂ by the input sequence δ gives 1^{→}. 1^{→} is a row vector which has a value “1” in each element.

For example, in an example of FIG. 2, the span program M̂ accepts the input sequence δ if and only if linear combination of the respective rows of the matrix M₆₇ consisting of the first, second, and fourth rows of the matrix M gives 1^{→}. That is, if there exist α₁, α₂, and α₄ with which α₁(M₁)+α₂(M₂)+α₄(M₄)=1^{→}, the span program M̂ accepts the input sequence δ.

The span program is called monotone if its labels p are related to only positive literals {p₁, . . . , pₙ}. The span program is called non-monotone if its labels ρ are related to the literals {p₁, . . . pₙ, [symbol] p₁, . . . , [symbol] pₙ}. It is assumed herein that the span program is non-monotone. An access structure (non-monotone access structure) is constructed using the non-monotone span program. Briefly, an access structure controls access to encryption, that is, it controls whether a ciphertext is to be decrypted or not.

As will be described in detail later, the span program being non-monotone, instead of being monotone, allows for a wider range of applications of the FPRE scheme constructed using the span program.

<3-2. Inner-Product of Attribute Information and Access Structure >

The above-described map γ(j) is computed using the inner-product of attribute information. That is, the inner-product of attribute information is used to determine which row of the matrix M is to be included in the matrix M_{δ}.

Uₜ(t=1, . . . , d and Uₜ⊂{0, 1}*) is a sub-universe and a set of attributes. Each Uₜ includes identification information (t) of the sub-universe and an n-dimensional vector (v^{→}). That is, Uₜ is (t, v^{→}), where t ∈ {1, . . . , d} and v^{→} ∈F_{q}ⁿ.

Let Uₜ:=(t, v^{→}) be a variable p of the span program M̂:=(M, ρ). That is, p:=(t, v^{→}). Let the span program M̂:=(M, ρ) having the variable (p:=(t, v^{→}), (t, v′^{→}), . . . ) be an access structure S.

That is, the access structure S:=(M, ρ) and ρ:{1, . . . , L}→{(t, v^{→}), (t, v′^{→}), . . . , [symbol] (t, v^{→}), [symbol] (t, v′^{→}), . . . }.

Let Γ be a set of attributes. That is, Γ:={(t, x^{→}ₜ)|x^{→}ₜ∈F_{q}ⁿ, 1≦t≦d}.

When Γ is given to the access structure S, map γ:{1, . . . , L}→{0, 1} for the span program M̂:=(M, ρ) is defined as follows. For each integer i=1, . . . , L, set γ(j)=1 if [γ(i)=(t, v^{→}ᵢ)] [symbol] [(t, x^{→}ₜ)∈Γ] [symbol] [v^{→}ᵢ·x^{→}ₜ=0] or [π(i)= [symbol] (t, v^{→}ᵢ)] [symbol] [(t, x^{→}ₜ)∈ Γ] [symbol] [v^{→}ᵢ·x^{→}ₜ≠0]. Set _{γ(j)=}0 otherwise.

That is, the map γ is computed based on the inner-product of the attribute information v^{→} and x^{→}. As described above, which row of the matrix M is to be included in the matrix M_{δ} is determined by the map γ. More specifically, which row of the matrix M is to be included in the matrix M_{δ} is determined by the inner-product of the attribute information v^{→} and x^{→}. The access structure S:=(M, ρ) accepts Γ if and only if 1^{→} ∈ span<(M₁)_{γ(i)=1}>.

<3-3. Secret Distribution Scheme>

A secret distribution scheme for the access structure S:=(M, ρ) will be described.

The secret distribution scheme is distributing secret information to render it nonsense distributed information. For example, secret information s is distributed into 10 pieces to generate 10 pieces of distributed information. Each of the 10 pieces of distributed information does not have information on the secret information s. Hence, even when one of the pieces of distributed information is obtained, no information can be obtained on the secret information s. On the other hand, if all of the 10 pieces of distributed information are obtained, the secret information s can be recovered.

There is another secret distribution scheme according to which the secret information s can be recovered if some (for example, 8 pieces) of distributed information can be obtained, without obtaining all of the 10 pieces of distributed information. A case like this where the secret information s can be recovered using 8 pieces out of 10 pieces of distributed information will be called 8-out-of-10. That is, a case where the secret information s can be recovered using t pieces out of n pieces of distributed information will be called t-out-of-n. This t will be called a threshold.

There is still another secret distribution scheme according to which when 10 pieces of distributed information d₁, . . . , d₁₀ are generated, the secret information s can be recovered with 8 pieces of distributed information d₁, . . . , d₈, but the secret information s cannot be recovered with 8 pieces of distributed information d₃, . . . , d₁₀. In other words, secret distribution schemes include a scheme according to which whether or not the secret information s can be recovered is controlled not only by the number of pieces of distributed information obtained, but also the combination of distributed information obtained.

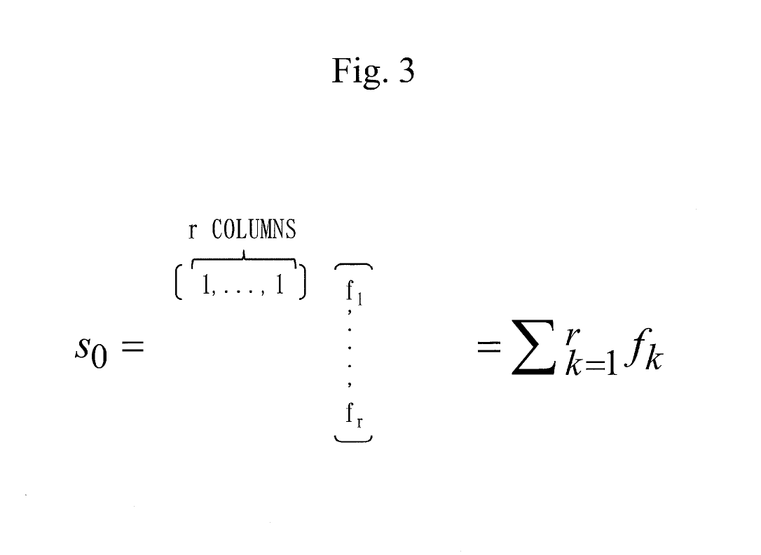

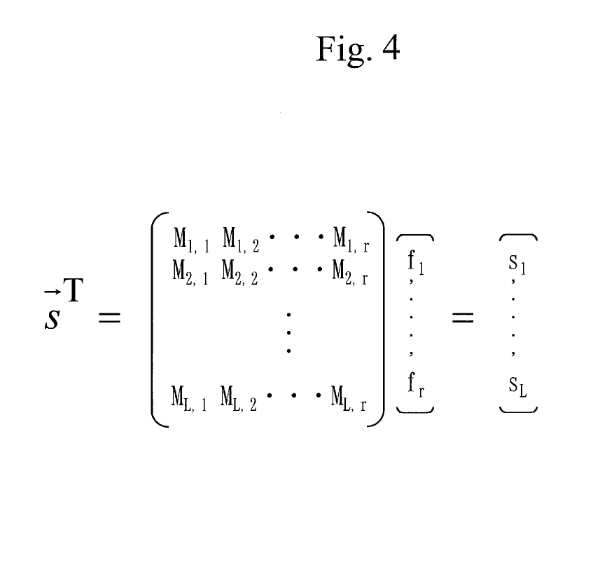

FIG. 3 is an explanatory drawing of s₀. FIG. 4 is an explanatory drawing of s^{→T}.

Let a matrix M be an (L rows×r columns) matrix. Let f^{→T} be a column vector indicated in Formula 118.

$${\vec{f}}^{T} := {( {f}_{1} , … {f}_{r} )}^{T} {}^{U} {𝔽}_{q}^{r} \qquad [ Formula 118 ]$$

Let s₀ indicated in Formula 119 be secret information to be shared.

s₀:=\vec{1}·\vec{f}^{T}:=Σₖ₌₁^{r}fₖ [Formula 119]

Let s^{→T} indicated in Formula 120 be a vector of L pieces of distributed information of s₀.

\vec{s}^{T}:=(s₁, . . . s_{L})^{T}:32 M·\vec{f}^{T} [Formula 120]

Let the distributed information sᵢ belong to γ(i).

If the access structure S:=(M, ρ) accepts Γ, that is, 1^{→}∈ span<(M₁)_{γ(i)=1}>for γ:{1, . . . , L}→{0, 1}, then there exist constants {αᵢ∈F_{q}|i∈I} such that I⊂{i∈{1, . . . , L}|γ(i)−=1}.

This is obvious from the explanation about the example of FIG. 2 that if there exist α₁, α₂, and α₄ with which α₁(M₁)+α₂(M₂)+α₄(M₄)=1^{→}, the span program M̂ accepts the input sequence δ. That is, if the span program M̂ accepts the input sequence δ when there exist α₁, α₂, and α₄ with which α₁(M₁)+α₂(M₂)+α₄(M₄)=1^{→}, then there exist α₁, α₂, and α₄ with which α₁(M₁)+α₂(M₂)+α₄(M₄)=1^{→}.

Note Formula 121.

Σ_{i∈I}αᵢsᵢ:=s₀ [Formula 121]

Note that the constants {αᵢ} can be computed in time polynomial in the size of the matrix M.

With the FPRE scheme according to the following embodiments, an access structure is constructed by applying the inner-product predicate and the secret distribution scheme to the span program, as described above. Therefore, access control can be designed flexibly by designing the matrix M in the span program and the attribute information x and the attribute information v (predicate information) in the inner-product predicate. That is, access control can be designed very flexibly. Designing of the matrix M corresponds to designing of conditions such as a threshold of the secret distribution scheme.

For example, the attribute-based encryption scheme described above corresponds to a case where designing of the inner-product predicate is limited to a certain condition in the access structure in the FPRE scheme according to the following embodiments. That is, when compared to the access structure in the FPRE scheme according to the following embodiments, the access structure in the attribute-based encryption scheme has a lower flexibility in access control design because it lacks the flexibility in designing the attribute information x and the attribute information v (predicate information) in the inner-product predicate. More specifically, the attribute-based encryption scheme corresponds to a case where attribute information {x^{→}ₜ}_{t∈{}1, . . . , d} and {v^{→}ₜ}_{t∈{1, . . . , d}} are limited to two-dimensional vectors for the equality relation, for example, x^{→}ₜ:=(1, xₜ) and v^{→}ₜ:=(vₜ, −1).

An inner-product predicate PRE scheme corresponds to a case where designing of the matrix M in the span program is limited to a certain condition in the access structure in the FPRE scheme according to the following embodiments. That is, when compared to the access structure in the FPRE scheme according to the following embodiments, the access structure in the inner-product predicate encryption scheme has a lower flexibility in access control design because it lacks the flexibility in designing the matrix M in the span program. More specifically, the inner-product predicate encryption scheme corresponds to a case where the secret distribution scheme is limited to 1-out-of-1 (or d-out-of-d).

In particular, the access structure in the FPRE scheme according to the following embodiments constitutes a non-monotone access structure that uses a non-monotone span program. Thus, the flexibility in access control designing improves.

More specifically, since the non-monotone span program includes a negative literal ( [symbol] p), a negative condition can be set. For example, assume that First Company includes four departments, A, B, C, and D. Assume that access control is to be performed such that only users belonging to departments other than department B of First Company are capable of access (capable of decryption). In this case, if a negative condition cannot be set, a condition that “the user belongs to any one of departments A, C, and D of First Company” must be set. On the other hand, if a negative condition can be set, a condition that “the user is an employee of First Company and belongs to a department other than department B” can be set. In other words, since a negative condition can be set, natural condition setting is possible. Although the number of departments is small in this case, this scheme is very effective in a case where the number of departments is large.

<4. Basic Structure of FPRE Scheme>

<4-1. Basic Structure of CP-FPRE Scheme>

The structure of the CP-FPRE scheme will be briefly described. Note that CP (ciphertext policy) means that a policy, namely an access structure, is embedded in a ciphertext.

The CP-FPRE scheme includes seven algorithms: Setup, KG, Enc, RKG, REnc, Dec1, and Dec2.

(Setup)

A Setup algorithm is a probabilistic algorithm that takes as input a security parameter λ, an attribute format n^{→}:=(d; n₁, . . . , n_{d}; u₁, . . . , u_{d}; z₁, . . . , z_{d}), and a value Q indicating an upper limit value of the number of re-encryption times, and outputs a public parameter pk and a master key sk.

(KG)

A KG algorithm is a probabilistic algorithm that takes as input an attribute set Γ:={(t, x^{→}ₜ)|x^{→}∈F_{q}^{nt}, 1≦t≦d}, the public parameter pk, and the master key sk, and outputs a decryption key sk_{Γ}.

(Enc)

An Enc algorithm is a probabilistic algorithm that takes as input a message m, an access structure S=(M, ρ), and the public parameter pk, and outputs a ciphertext ctⁿ_{S}.

(RKG)

An RKG algorithm is a probabilistic algorithm that takes as input the decryption key sk_{Γ}, an access structure S′:=(M′, ρ′), the public parameter pk, and a value n indicating the number of times the ciphertext ctⁿ_{S} to be re-encrypted has been re-encrypted, and outputs a re-encryption key rkⁿ_{Γ.S′}.

(REnc)

An REnc algorithm is a probabilistic algorithm that takes as input the ciphertext ctⁿ_{S}, the re-encryption key rkⁿ_{Γ.S′}, and the public parameter pk, and outputs a re-encrypted ciphertext ctⁿ⁺¹_{S′}.

(Dec1)

A Dec1 algorithm is an algorithm that takes as input a re-encrypted ciphertext ctⁿ_{S′}, a decryption key sk_{Γ′}, and the public parameter pk, and outputs the message m or a distinguished symbol ⊥.

(Dec2)

A Dec2 algorithm is an algorithm that takes as input the ciphertext ctⁿ_{S} (ct⁰_{S}), the decryption key sk_{Γ}, and the public parameter pk, and outputs the message m or a distinguished symbol ⊥.

<4-2. Cryptographic System 10>

The cryptographic system 10 that executes the algorithms of the CP-FPRE scheme will be described.

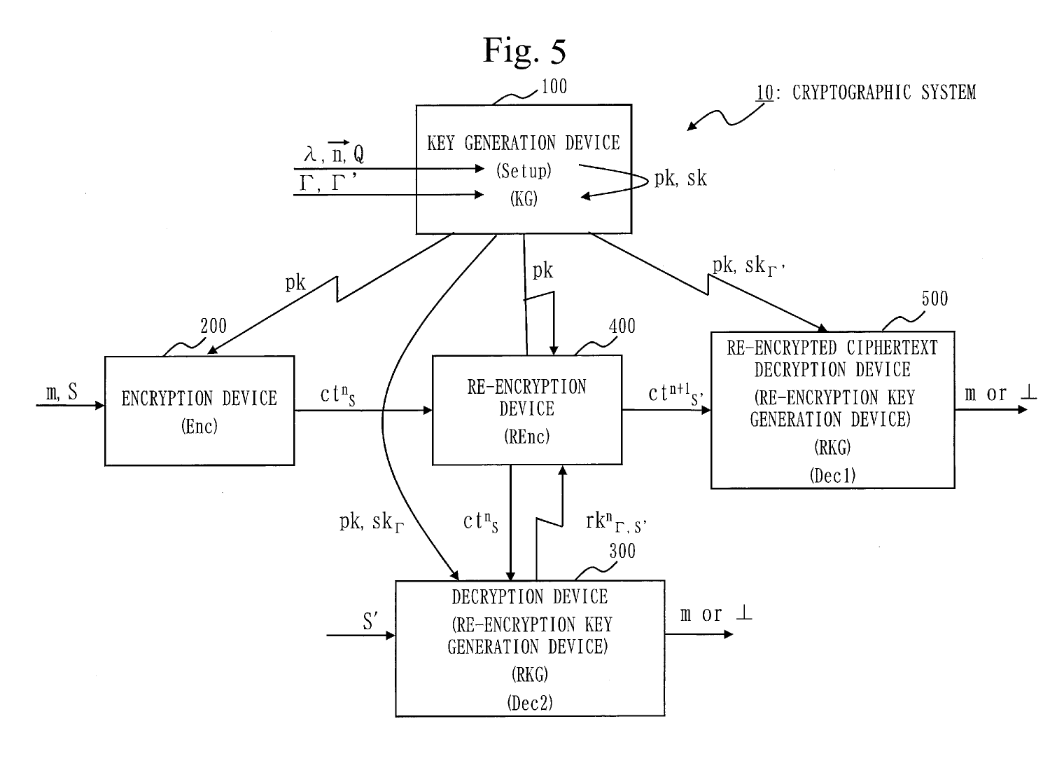

FIG. 5 is a configuration diagram of the cryptographic system 10 that implements the CP-FPRE scheme.

The cryptographic system 10 includes a key generation device 100, an encryption device 200, a decryption device 300 (re-encryption key generation device), a re-encryption device 400, and a re-encrypted ciphertext decryption device 500 (re-encryption key generation device).

The key generation device 100 executes the Setup algorithm taking as input a security parameter λ, an attribute format n^{→}:=(d; n₁, . . . , n_{d}; u₁, . . . , z₁, . . . , z_{d}), and a value Q, and thus generates a public parameter pk and a master key sk.

Then, the key generation device 100 publishes the public parameter pk. The key generation device 100 also executes the KG algorithm taking as input an attribute set F, and thus generates a decryption key skᵣ, and transmits the decryption key skᵢ- to the decryption device 300 in secrecy. The key generation device 100 also executes the KG algorithm taking as input an attribute set Γ′, and thus generates a decryption key sk_{Γ′}, and transmits the decryption key sk_{Γ′} to the re-encrypted ciphertext decryption device 500 in secrecy.

The encryption device 200 executes the Enc algorithm taking as input a message m, an access structure S, and the public parameter pk, and thus generates a ciphertext ctⁿ_{S}. The encryption device 200 transmits the ciphertext ctⁿ _{S} to the re-encryption device 400.

The decryption device 300 executes the RKG algorithm taking as input the public parameter pk, the decryption key sk_{Γ}, an access structure S′, and a value n, and thus generates a re-encryption key rkⁿ_{Γ.S′}. The decryption device 300 transmits the re-encryption key rkⁿ_{Γ.S′} to the re-encryption device in secrecy.

The decryption device 300 also executes the Dec2 algorithm taking as input the public parameter pk, the decryption key sk_{Γ}, and the ciphertext ctⁿ_{S} (ct⁰_{S}), and outputs the message m or a distinguished symbol ⊥.

The re-encryption device 400 executes the REnc algorithm taking as input the public parameter pk, the re-encryption key rkⁿ_{Γ.S′}, and the ciphertext ctⁿ_{S}, and thus generates a re-encrypted ciphertext ctⁿ⁺¹_{S′}. The re-encryption device 400 transmits the re-encrypted ciphertext ctⁿ⁺¹_{S.′}to the re-encrypted ciphertext decryption device 500.

The re-encrypted ciphertext decryption device 500 executes the Dec1 algorithm taking as input the public parameter pk, the decryption key sk_{Γ′}, and the re-encrypted ciphertext ctⁿ⁺¹_{S′}, and outputs the message m or a distinguished symbol ⊥.

<4-4. CP-FPRE Scheme and Cryptographic System 10 in Detail>

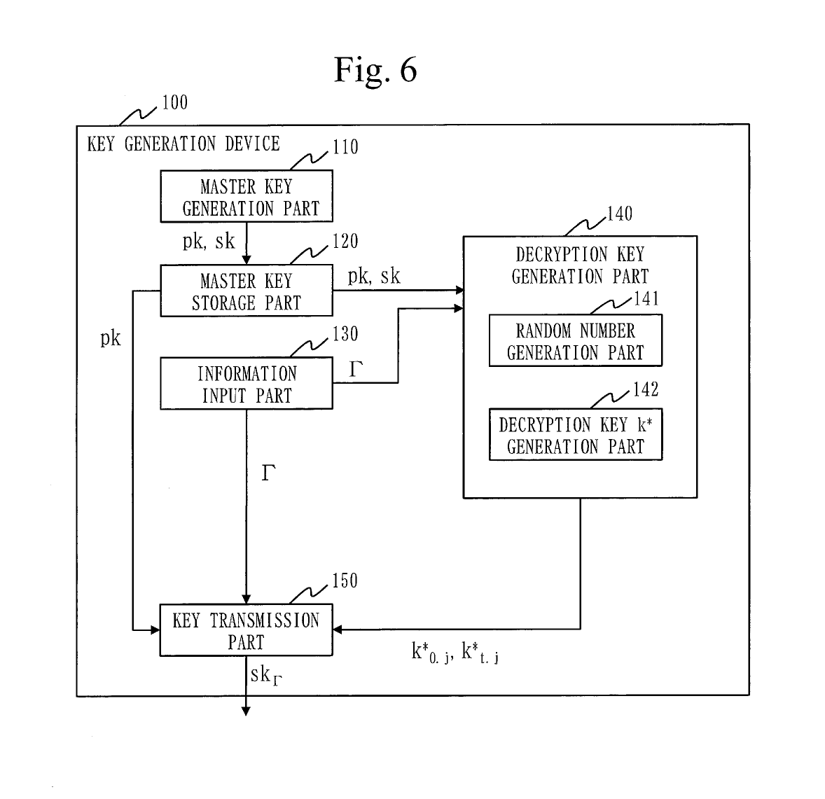

With reference to FIG. 6 through FIG. 17, the CP-FPRE scheme will be described, and the function and operation of the cryptographic system 10 that implements the CP-FPRE scheme will be described.

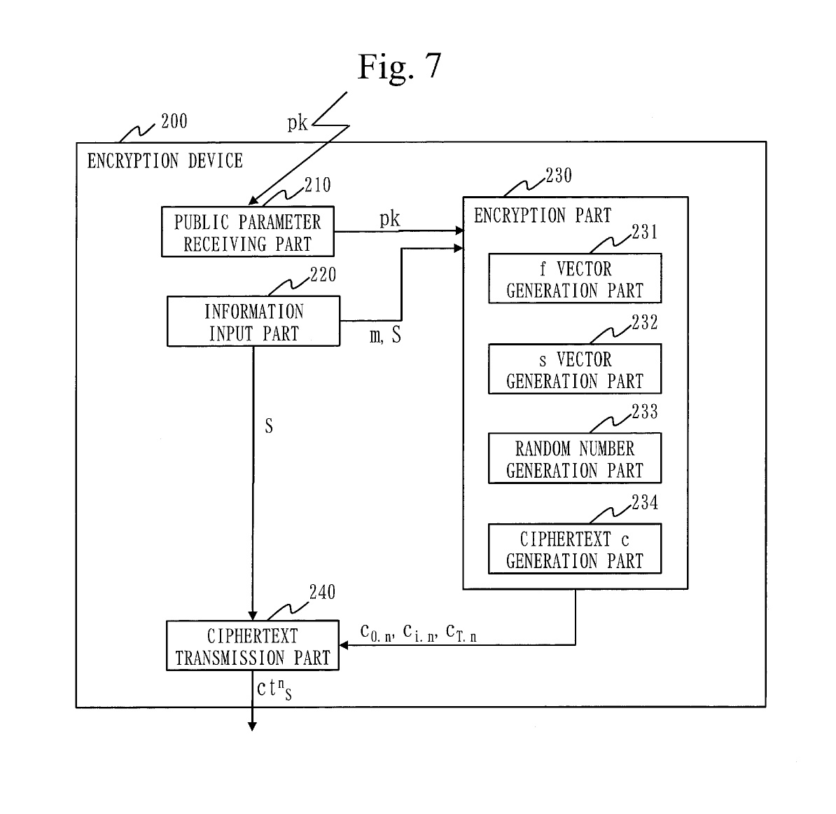

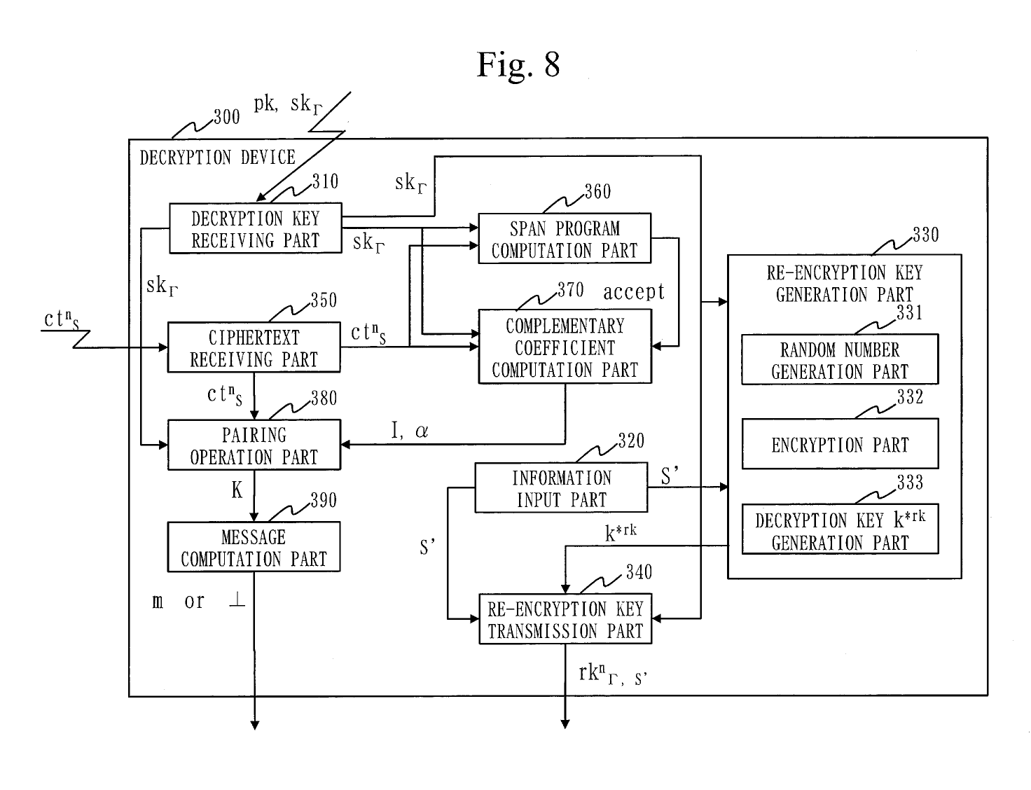

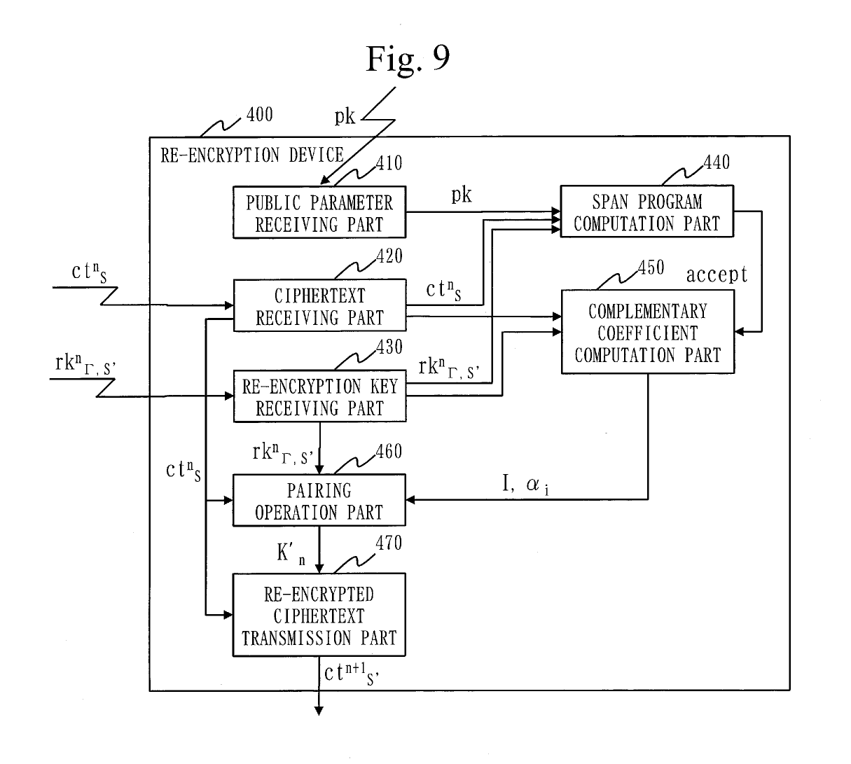

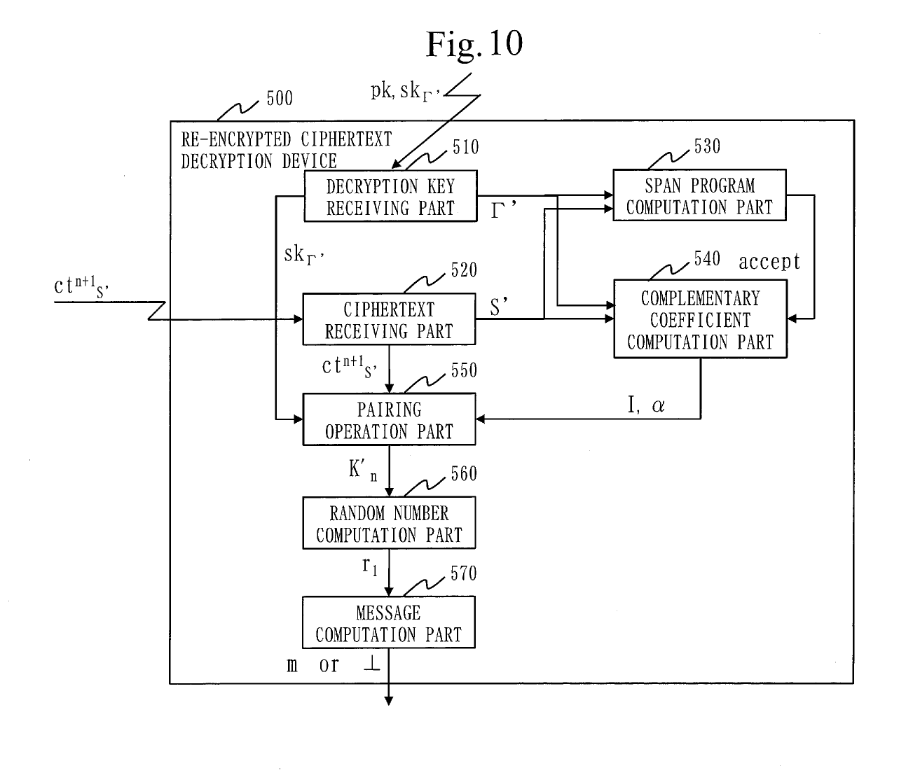

FIG. 6 is a functional block diagram illustrating the function of the key generation device 100. FIG. 7 is a functional block diagram illustrating the function of the encryption device 200. FIG. 8 is a functional block diagram illustrating the function of the decryption device 300. FIG. 9 is a functional block diagram illustrating the function of the re-encryption device 400. FIG. 10 is a functional block diagram illustrating the function of the re-encrypted ciphertext decryption device 500.

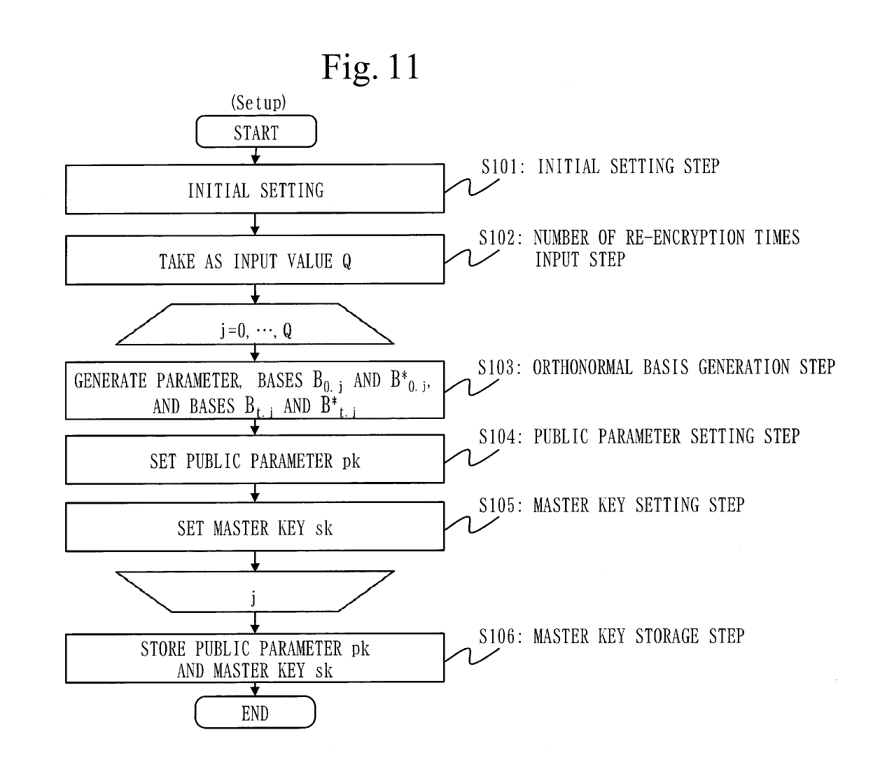

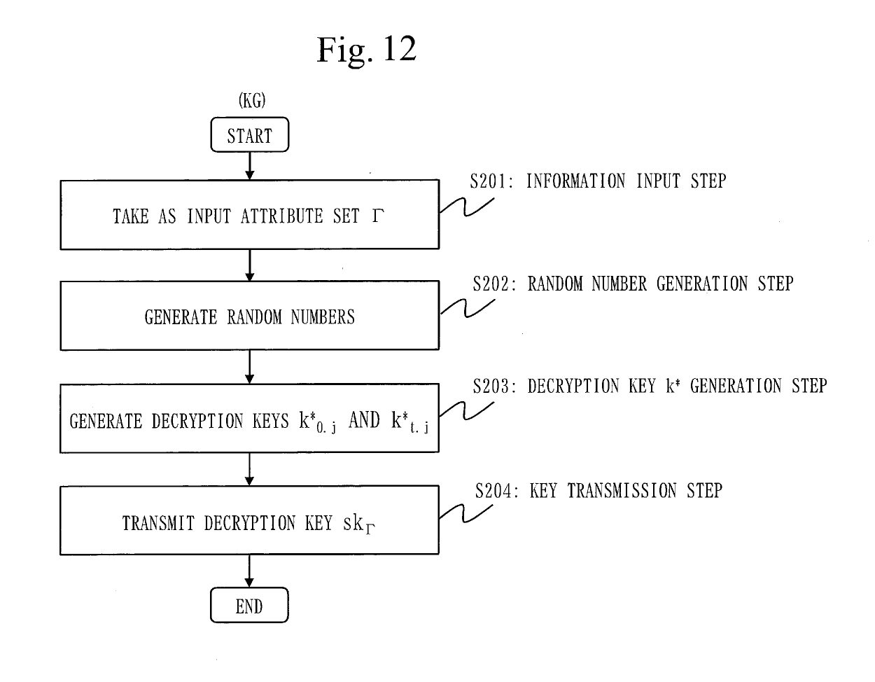

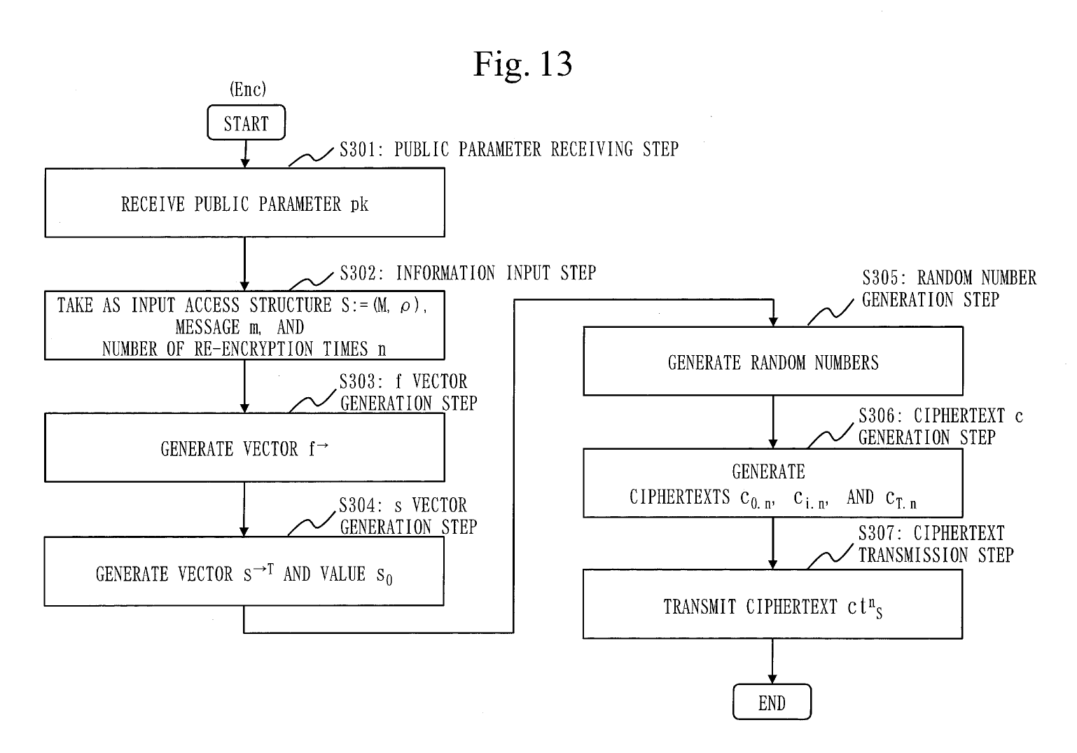

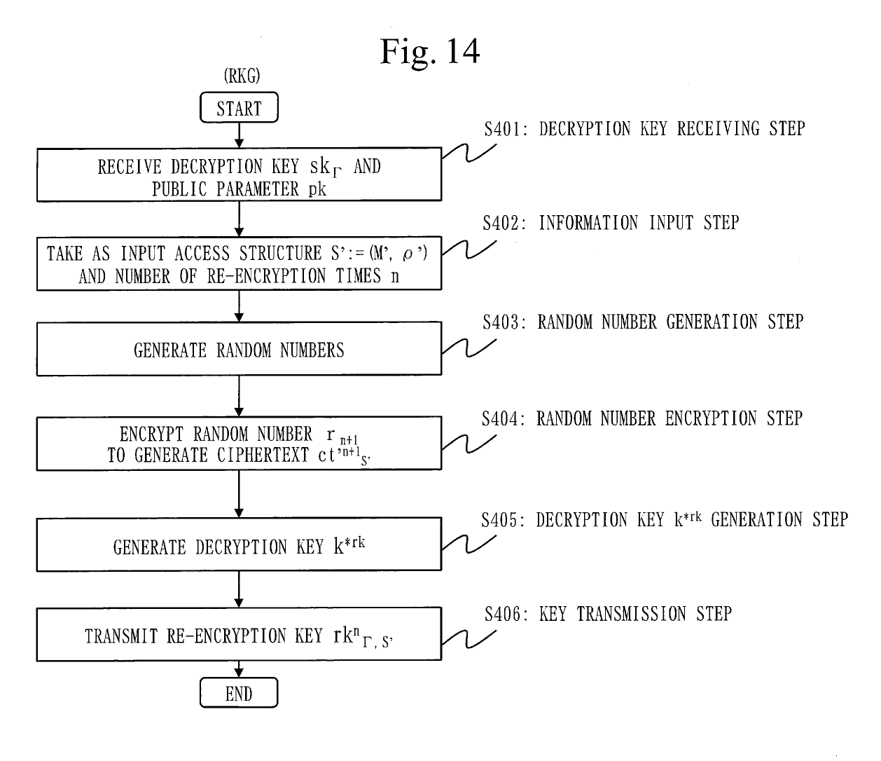

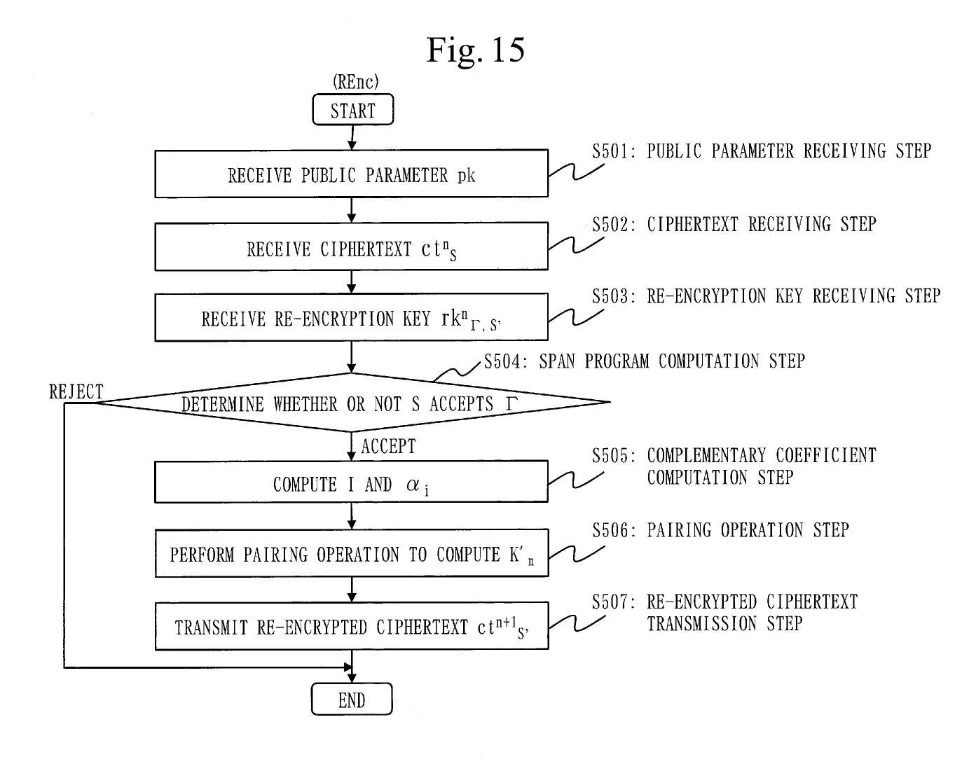

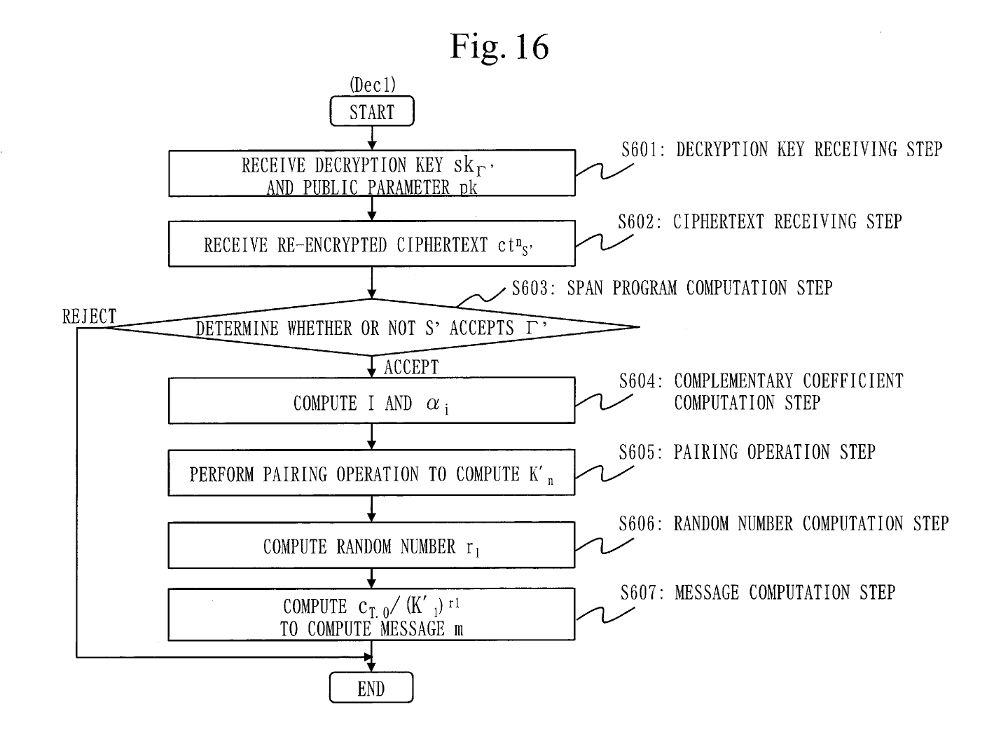

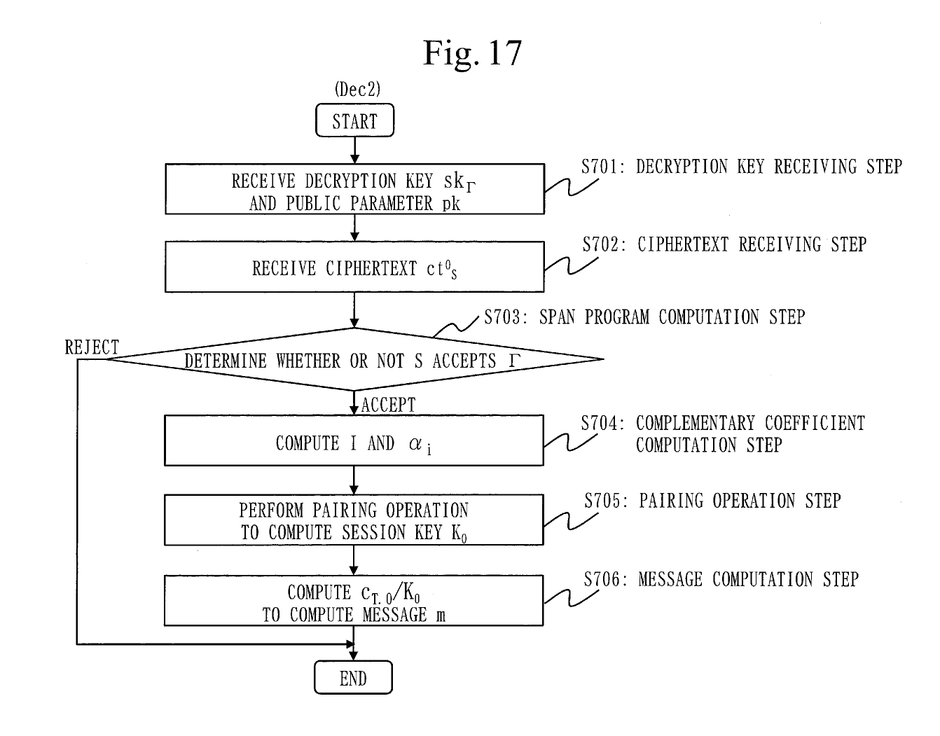

FIGS. 11 and 12 are flowcharts illustrating the operation of the key generation device 100. FIG. 11 is a flowchart illustrating the process of the Setup algorithm, and FIG. 12 is a flowchart illustrating the process of the KG algorithm. FIG. 13 is a flowchart illustrating the operation of the encryption device 200 and illustrating the process of the Enc algorithm. FIG. 14 is a flowchart illustrating the operation of the decryption device 300 and illustrating the process of the RKG algorithm. FIG. 15 is a flowchart illustrating the operation of the re-encryption device 400 and illustrating the process of the REnc algorithm. FIG. 16 is a flowchart illustrating the operation of the re-encrypted ciphertext decryption device 500 and illustrating the process of the Dec1 algorithm. FIG. 17 is a flowchart illustrating the operation of the decryption device 300 and illustrating the process of the Dec2 algorithm.

The function and operation of the key generation device 100 will be described.

As illustrated in FIG. 6, the key generation device 100 includes a master key generation part 110, a master key storage part 120, an information input part 130, a decryption key generation part 140, and a key transmission part 150 (key output part). The decryption key generation part 140 includes a random number generation part 141 and a decryption key k* generation part 142.

With reference to FIG. 11, the process of the Setup algorithm will be described.

(S101: Initial Setting Step)

The master key generation part 110 executes initial setting.

Specifically, the master key generation part 110 executes the following process (1) through (3).

(1) Using an input device, the master key generation part 110 takes as input a security parameter λ(1^{λ}) and an attribute format n^{→}:=(d; n₁, . . . , n_{d}; w₁, . . . , w_{d}; z₁, . . . , z_{d}). Note that d is an integer of 1 or more, and that nₜ is an integer of 1 or more, and wₜ and zₜ are each an integer of 0 or more, for each integer t=1, . . . , d.

(2) Using a processing device, the master key generation part 110 executes the algorithm G_{bpg} taking as input the security parameter λ input in (1), and thus generates values of a parameter param_{G}:=(q, G, G_{T}, g, e) of bilinear pairing groups.

(3) The master key generation part 110 sets 5 in N₀, and sets nₜ+wₜ+zₜ+1 in Nₜ for each integer t=1, . . . , d.

(S102: Number of Re-encryption Times Input Step)

Using the input device, the master key generation part 110 takes as input a value Q indicating an upper limit of the number of re-encryption times. The value Q is an integer of 1 or more.

The master key generation part 110 executes the process of S103 through S105 below repeatedly for j=0, . . . , Q.

(S103: Orthonormal Basis Generation Step)

Using the processing device, the master key generation part 110 computes Formula 122 for each integer t=0, . . . d, and thus generates a parameter param_{n→}, a basis B_{0.j} and a basis B*_{0.j}, and a basis B_{t.j} and a basis B*_{t.j}.

$$\begin{matrix}[ Formula 122 ] & \\ {ψ}_{j} {←}^{U} {𝔽}_{q}^{\times } , {g}_{T . j} := {e ( g , g )}^{{ψ}_{j}} & ( 1 )\end{matrix}$$

The process (2) through (4) is executed for each integer t=0, . . . , d.

$$\begin{matrix}{param}_{{𝕍}_{t}} := ( q , {𝕍}_{t} , {𝔾}_{T} , {𝔸}_{t} , e ) {←}^{R} {𝒢}_{dpvs} ( {1}^{λ} , {N}_{t} , {param}_{𝔾} ) & ( 2 ) \\ {X}_{t} = ( \begin{matrix}{{χ}^{->}}_{t , 1} \\ ⋮ \\ {{χ}^{->}}_{t , {N}_{t}}\end{matrix} ) := {( {χ}_{t , i , {j}^{′}} )}_{i , {j}^{′}} {←}^{U} GL ( {N}_{t} , {𝔽}_{q} ) & ( 3 ) \\ ( \begin{matrix}{{v}^{->}}_{t , 1} \\ ⋮ \\ {{v}^{->}}_{t , {N}_{t}}\end{matrix} ) := {( {v}_{t , i , {j}^{′}} )}_{i , {j}^{′}} := ψ \cdot {( {X}_{t}^{T} )}^{- 1} & ( 4 ) \\ {b}_{t . j , i} := {\sum }_{j = 1}^{{N}_{t}} {χ}_{t , i , {j}^{′}} {a}_{t , {j}^{′}} , {𝔹}_{t . j} := ( {b}_{t . j , 1} , … , {b}_{t . j , {N}_{t}} ) \\ {b}_{t . j , i}^{*} := {\sum }_{j = 1}^{{N}_{t}} {v}_{t , i , j} {a}_{t , j} , {𝔹}_{t . j}^{*} := ( {b}_{t . j , 1}^{*} , … , {b}_{t . j , {N}_{t}}^{*} ) & ( 5 ) \\ {param}_{{n}^{->} . j} := ( {g}_{T . j} , {\{ {param}_{{𝕍}_{t}} \}}_{t = 0 , … , d} ) & ( 6 )\end{matrix}$$

That is, the master key generation part 110 executes the following process.

(1) The master key generation part 110 generates a random number ψⱼ. The master key generation part 110 also sets e(G,G)^{ψj} in g_{T.j}.

The process (2) through (5) is executed for each integer t=0, . . . , d.

(2) The master key generation part 110 executes the algorithm G_{dpvs} taking as input the security parameter λ, Nₜ, and the values of param_{G}:=(q, G, G_{T}, g, e), and thus generates values of a parameter param_{Vt}:=(q, Vₜ, G_{T}, Aₜ, e) of dual pairing vector spaces.

(3) The master key generation part 110 takes as input Nₜ and F_{q}, and randomly generates a linear transformation Xₜ:=(χ_{t,i,j′})_{i,j′}. Note that GL stands for general linear. In other words, GL is a general linear group, a set of square matrices with nonzero determinants, and a group under multiplication. Note that (χ_{t,i,j′})_{i,j′} denotes a matrix concerning the suffixes i and j′ of the matrix χ_{t,i,j′}. Note that i,j′=1, . . . , Nₜ in (χ_{t,i,j′})_{i,j′}.

(4) Based on the random number ψ and the linear transformation Xₜ, the master key generation part 110 generates (ν_{t,i,j′})_{i,j′}:=ψ·(Xₜ^{T})⁻¹. Like (χ_{t,i,j′})_{i,j′}, (ν_{t,i,j′})_{i,j′} denotes a matrix concerning the suffixes i and j′ of the matrix ν_{t,i,j′}. Note that i,j′=1, . . . , Nₜ in (ν_{t,i,j′})_{i,j′}.

(5) Based on the linear transformation Xₜ generated in (3), the master key generation part 110 generates a basis B_{t,j} from the canonical basis Aₜ generated in (2). Based on (ν_{t,i,j′})_{i,j′} generated in (4), the master key generation part 110 generates a basis B*_{t.j} from the canonical basis Aₜ generated in (2).

(6) The master key generation part 110 sets g_{T.j} generated in (1) and {param_{νt}}ₜ=0, . . . , d generated in (2) in param_{n→.j}.

(S104: Public Parameter Generation Step)

Using the processing device, the master key generation part 110 generates a subbasis B̂_{0.j} of the basis B_{0.j}, a subbasis B̂_{t.j} of the basis B_{t.j}, a subbasis B̂*_{0.j} of the basis B*_{0.j}, and a subbasis B̂*_{t.j} of the basis B*_{t.j}, as indicated in Formula 123.

[symbol]

_{0.j}:=(b_{0.j,1}b_{0.j,2}, b_{0.j,5}),

[symbol]

_{t.j}:=(b_{t.j,1}, . . . , b_{t.j,n}_{ₜ}, b_{t.j,N}_{ₜ}) for t=1, . . . , d,

[symbol]

*_{0.j}:=(b*_{0.j,2}, b*_{0.j,4}),

[symbol]

*_{t.j}:=(b*_{t.j,1}, . . . , b*_{t.j,n}_{ₜ}, b*_{t.j,n}_{ₜ}_{+w}_{ₜ}₊₁, . . . , b*_{t.j,n}_{ₜ}_{+w}_{ₜ}_{+z}_{ₜ}) for t=1, . . . , d, [Formula 123 ]

The master key generation part 110 generates a public parameter pk which is constituted by the security parameter λ, param_{n→.j}, and the subbases B̂_{0.j}, B̂_{t.j}, B̂*_{0.j}, and B̂*_{t.j}.

(S105: Master Key Generation Step)

The master key generation part 110 generates a master key sk which is constituted by a basis vector b*_{0.j.1}.

(S106: Master Key Storage Step)

The master key storage part 120 stores the public parameter pk generated in (S104) in a storage device. The master key storage part 120 also stores the master key sk generated in (S105) in the storage device.

In brief, in (S101) through (S105), the key generation device 100 generates the public parameter pk and the master key sk by executing the Setup algorithm indicated in Formula 124. In (S106), the key generation device 100 stores the generated public parameter pk and master key sk in the storage device.

The public parameter is published, for example, via a network, and is made available for the encryption device 200, the decryption device 300, the re-encryption device 400, and the re-encrypted ciphertext decryption device 500.

$$[ Formula 124 ]$$

$$Setup ( {1}^{λ} , \vec{n} = ( d ; {n}_{1} , … , {n}_{d} ; {w}_{1} , … , {w}_{d} ; {z}_{1} , … , {z}_{d} ) ) \text{:}$$

$${param}_{𝔾} := ( q , 𝔾 , {𝔾}_{T} , g , e ) {}^{R} {𝒢}_{bpg} ( {1}^{λ} ) , \\ {N}_{0} := 5 , {N}_{t} := {n}_{t} + {w}_{t} + {z}_{t} + 1 for t = 1 , … , d , \\ for j = 0 , … , Q , \\ {ψ}_{j} {}^{U} {𝔽}_{q}^{x} , {g}_{T . j} := {e ( g , g )}^{{ψ}_{j}} , \\ for t = 0 , … , d$$

$${param}_{{𝕍}_{t}} := ( q , {𝕍}_{t} , {𝔾}_{T} , {𝔸}_{t} , e ) {}^{R} {𝒢}_{dpvs} ( {1}^{λ} , {N}_{t} , {param}_{𝔾} ) , \\ \begin{matrix}{X}_{t} = ( \begin{matrix}{\vec{χ}}_{t , 1} \\ ⋮ \\ {\vec{χ}}_{t , {N}_{t}}\end{matrix} ) := {( {χ}_{t , i , {j}^{′}} )}_{i , {j}^{′}} {}^{U} GL ( {N}_{t} , {𝔽}_{q} ) , \\ ( \begin{matrix}{\vec{v}}_{t , 1} \\ ⋮ \\ {\vec{v}}_{t , {N}_{t}}\end{matrix} ) := {( {v}_{t , i , {j}^{′}} )}_{i , {j}^{′}} := ψ \cdot {( {X}_{t}^{T} )}^{- 1} ,\end{matrix}$$

$${b}_{t . j , i} := {\sum }_{j = 1}^{{N}_{t}} {χ}_{t , i , {j}^{′}} {a}_{t , {j}^{′}} , {𝔹}_{t . j} := ( {b}_{t . j , 1} , … , {b}_{t . j , {N}_{t}} ) , , \\ {b}_{t . j , i}^{*} := {\sum }_{j = 1}^{{N}_{t}} {v}_{t , i , {j}^{′}} {a}_{t , {j}^{′}} , {𝔹}_{t . j}^{*} := ( {b}_{t . j , 1}^{*} , {b}_{t . j , {N}_{t}}^{*} ) , \\ {param}_{\vec{n} . j} := ( {g}_{T . j} , {\{ {param}_{{𝕍}_{t}} \}}_{t = 0 , … d} ) , \\ {\hat{𝔹}}_{0. j} := ( {b}_{0. j , 1} , {b}_{0. j , 2} , {b}_{0. j , 5} ) , \\ {\hat{𝔹}}_{t . j} := ( {b}_{t . j , 1} , … , {b}_{t . j , {n}_{t}} , {b}_{t . j , {N}_{t}} ) for t = 1 , … , d , \\ {\hat{𝔹}}_{0. j}^{*} := ( {b}_{0. j , 2}^{*} , {b}_{0. j}^{*} , 4 ) , \\ {\hat{𝔹}}_{t . j}^{*} := ( {b}_{t . j , 1}^{*} , … , {b}_{t . j , {n}_{t}}^{*} , {b}_{t . j , {n}_{t} + {w}_{t} + 1}^{*} , … , {b}_{t . j , {n}_{t} + {w}_{t} + {z}_{t}}^{*} )$$

$$for t = 1 , … , d , \\ return p k = ( {1}^{λ} , {\{ {param}_{\vec{n} . j} \}}_{j = 0 , … , Q} , {\{ {\hat{𝔹}}_{t . j} , {\hat{𝔹}}_{t . j}^{*} \}}_{t = 0 , … , d ; j = 0 , … , Q} ) , \\ sk = ( {\{ {b }_{0. j , 1}^{*} \}}_{j = 0 , … Q} ) .$$

With reference to FIG. 12, the process of the KG algorithm will now be described.

(S201: Information Input Step)

Using the input device, the information input part 130 takes as input an attribute set Γ:={(t, x^{→}ₜ:=(x_{t,1}, . . . , x_{t,nt}∈F_{q}^{nt}\{0^{→}}))|1≦t≦d}. Note that t may be at least some of integers from 1 to d, instead of being all of integers 1 to d. Attribute information of a user of a decryption key sk_{Γ} is set in the attribute set Γ, for example.

(S202: Random Number Generation Step)

Using the processing device, the random number generation part 141 generates random numbers, as indicated in Formula 125.

$${δ}_{j} , {ϕ}_{0. j} {}^{U} {𝔽}_{q}^{r} for j = 0 , … , Q , \\ {\vec{ϕ}}_{t . j} {}^{U} {𝔽}_{q}^{{Z}_{t}} for j = 0 , … , Q ; ( t , {\vec{x}}_{t} ) ∈ Γ \qquad [ Formula 125 ]$$

(S203: Decryption Key k* Generation Step)

Using the processing device, the decryption key k* generation part 142 generates a decryption key k*_{0.j} for each integer j=0, . . . , Q, as indicated in Formula126.

k*_{0.j}:=(1,δⱼ, 0, φ_{0.j}, 0) [symbol] *_{0.j} , for j=0, . . . , Q [Formula 126]

For the basis B and the basis B* indicated in Formula 110, Formula 111 is established. Thus, Formula 126 means that 1 is set as the coefficient of the basis vector b*_{0.j.1} of the basis B*₀, δⱼ is set as the coefficient of the basis vector b*_{0.j.2}, 0 is set as the coefficient of the basis vector b*_{0.j.3}, φ_{0.j} is set as the coefficient of the basis vector b*_{0.j.4}, and 0 is set as the coefficient of the basis vector b*_{0.j.5}.

Using the processing device, the decryption key k* generation part 142 also generates a decryption key k*_{t.j} for each integer t included in the attribute set Γ and each integer j=0, . . . , Q, as indicated in Formula 127.

$${k}_{t . j}^{*} := {( \overbrace{{δ}_{j} {\vec{x}}_{t}}^{{n}_{t}} , \overbrace{ {0}^{{w}_{t}}}^{{w}_{t}} , \overbrace{ {{ϕ}^{->}}_{t . j}}^{{z}_{t}} , \overbrace{0}^{1} )}_{{𝔹}_{t . j}^{*}} \\ for ( t , {\vec{x}}_{t} ) , ∈ Γ ; j = 0 , … , Q \qquad [ Formula 127 ]$$

Formula 127 means that δ_{jXt.1}, . . . , δ_{jXt.nt} are respectively set as the coefficient of the basis vectors of the basis b*_{t.j.1}, . . . , b*_{t.j.nt} of the basis B*ₜ, 0 is set as the coefficient of each of the basis vectors b*_{t.j.nt+1}, . . . , b*_{t.j.nt+wt}, φ_{t.j.1}, . . . , φ_{t.j.zt} are respectively set as the coefficient of the basis vectors b*_{t.j.nt+wt+1}, . . . , b*_{t.j.nt+wt+zt}, and 0 is set as the coefficient of the basis vector b*_{t.j.nt+wt+zt+1}.

(S204: Key Transmission Step)

Using a communication device and via the network, for example, the key transmission part 150 transmits the decryption key sk_{Γ}, having as elements, the attribute set Γ and the decryption keys k*_{0.j} and k*_{t.j} to the decryption device 300 in secrecy. As a matter of course, the decryption key sk_{Γ} may be transmitted to the decryption device 300 by another method.

In brief, in (S201) through (S203), the key generation device 100 generates the decryption key sk_{Γ} by executing the KG algorithm indicated in Formula 128. In (S204), the key generation device 100 transmits the decryption key sk_{Γ} to the decryption device 300.

$$KG = ( p k , sk , Γ = ( \{ t , {\vec{x}}_{t} ) \vert {\vec{x}}_{t} ∈ {𝔽}_{q}^{{n}_{t}} \backslash \{ \vec{0} \} , 1 \leq t \leq d \} ) \text{:} \\ for j = 0 , … , Q \\ {δ}_{j} , {ϕ}_{0. j} {}^{U} {𝔽}_{q} , {\vec{ϕ}}_{t . j} {}^{U} {𝔽}_{q}^{{Z}_{t}} for ( t , {\vec{x}}_{t} ) ∈ Γ , \\ {k}_{0. j}^{*} := {( 1 , {δ}_{j} , 0 , {ϕ}_{0. j} , 0 )}_{{𝔹}_{0 , j}^{*}} , \\ {k}_{t . j}^{*} := {( \overbrace{{δ}_{j} {\vec{x}}_{t}}^{{n}_{t}} , \overbrace{ {0}^{{w}_{t}}}^{{w}_{t}} , \overbrace{ {\vec{ϕ}}_{t . j}}^{{z}_{t}} , \overbrace{0}^{1} )}_{{𝔹}_{t . j}^{*}} for ( t , {{x}^{->}}_{t} ) , ∈ Γ , \\ return {sk}_{Γ} := ( Γ , \{ {k}_{0. j}^{*} , \{ {k}_{t . j}^{*} \} ( t , {{x}^{->}}_{t} ) ∈ Γ \} j = 0 , … , Q ) . \qquad [ Formula 128 ]$$

In (S201), the key generation device 100 generates a decryption key sk_{Γ′} by executing the KG algorithm taking as input an attribute set Γ′:={(t, x′^{→}ₜ:=(x′_{t,1}, . . . , x′_{t,nt}∈ F_{q}^{nt}\{0^{→}}))|1≦t≦d} in which attribute information of a user of the decryption key sk_{Γ′} is set. Then, the key generation device 100 transmits the decryption key sk_{Γ′}:=(Γ′, {k′*_{0.j}, {(k′*_{t.j}}_{(t,x→t)∈Γ′}}_{j=0, . . . ,Q}) to the re-encrypted ciphertext decryption device 500.

The function and operation of the encryption device 200 will be described.

As illustrated in FIG. 7, the encryption device 200 includes a public parameter receiving part 210, an information input part 220, an encryption part 230, and a ciphertext transmission part 240 (ciphertext output part). The encryption part 230 includes an f vector generation part 231, an s vector generation part 232, a random number generation part 233, and a ciphertext c generation part 234.

With reference to FIG. 13, the process of the Enc algorithm will be described.

(S301: Public Parameter Receiving Step)

Using the communication device and via the network, for example, the public parameter receiving part 210 receives the public parameter pk generated by the key generation device 100.

(S302: Information Input Step)

Using the input device, the information input part 220 takes as input an access structure S:=(M, ρ). The access structure S is to be set according to the conditions of a system to be implemented. Attribute information of a user capable of decrypting a ciphertext ct⁰ _{S} is set in ρ of the access structure S, for example. Note that ρ(i)=(t, v^{→}ᵢ:=(v_{i,1}, . . . , v_{i,nt})∈F_{q}^{nt}\{0^{→}) (v}_{i,nt} ≠0). Note that M is an L-row and r-column matrix.

Using the input device, the information input part 220 also takes as input a message m to be transmitted to the decryption device 300.

Using the input device, the information input part 220 also takes as input the number of re-encryption times n. The number of re-encryption times n to be input here is normally 0, and takes a value specified in the RKG algorithm when the Enc algorithm is invoked in the RKG algorithm to be described later.

(S303: f Vector Generation Step)

Using the processing device, the f vector generation part 231 generates a vector f^{→}, as indicated in Formula 129.

$$\vec{f} {}^{U} {𝔽}_{q}^{r} \qquad [ Formula 129 ]$$

(S304: s Vector Generation Step)

Using the processing device, the s vector generation part 232 generates a vector s^{→T}, as indicated in Formula 130.

\vec{s}^{T}:=(s₁, . . . , s_{L})^{T}:=M·\vec{f}T [Formula 130]

Using the processing device, the s vector generation part 232 also generates a value s₀, as indicated in Formula 131.

s₀:=\vec{1}·\vec{f}T [Formula 131]

(S305: Random Number Generation Step)

Using the processing device, the random number generation part 233 generates random numbers, as indicated in Formula 132.

$${η}_{0. n} , ζ {}^{U} {𝔽}_{q} , \\ {θ}_{i . n} , {η}_{i . n} {}^{U} {𝔽}_{q} for i = 1 , … , L \qquad [ Formula 132 ]$$

(S306: Ciphertext c Generation Step)

Using the processing device, the ciphertext c generation part 234 generates a ciphertext c_{0.n}, as indicated in Formula 133.

co_{0.n}:=(ζ, −s₀, 0, 0, η_{0.n}) [symbol] _{0.n} [Formula 133]

Using the processing device, the ciphertext c generation part 234 also generates a ciphertext c_{i.n} for each integer i=1, . . . , L, as indicated in Formula 134.

$$for i = 1 , … , L , \\ if ρ ( i ) = ( t , {{v}^{->}}_{i} ) , \\ {c}_{i . n} := {( \overbrace{{s}_{i} {{e}^{->}}_{t , 1} + {θ}_{i . n} {{v}^{->}}_{t} ,}^{{n}_{t}} \overbrace{{0}^{{w}_{t}} ,}^{{w}_{t}} { \overbrace{{0}^{{z}_{t}} ,}^{{z}_{t}}}^{ } \overbrace{{η}_{i . n}}^{1} )}_{{𝔹}_{t . n}} , \\ \begin{matrix}if ρ ( i ) = ( t , {{v}^{->}}_{i} ) , \\ {c}_{i . n} := {( \overbrace{{s}_{i} {{v}^{->}}_{t ,}}^{{n}_{t}} \overbrace{{0}^{{w}_{t}} ,}^{{w}_{t}} { \overbrace{{0}^{{z}_{t}} ,}^{{z}_{t}}}^{ } \overbrace{{η}_{i . n}}^{1} )}_{{𝔹}_{t . n}} & \end{matrix} \qquad [ Formula 134 ]$$

Using the processing device, the ciphertext c generation part 234 also generates a ciphertext c_{T.n}, as indicated in Formula 135.

c_{T.n}=m·g_{T.n}^{ζ} [Formula 135]

(S307: Ciphertext Transmission Step)

Using the communication device and via the network, for example, the ciphertext transmission part 240 transmits a ciphertext ctⁿ_{S}, having as elements, the access structure S, the ciphertexts c_{0.n}, c_{1.n}, . . . , c_{L.n}, and c_{T.n}, and the number of re-encryption times n to the decryption device 300. As a matter of course, the ciphertext ctⁿ_{S} may be transmitted to the decryption device 300 by another method.

In brief, in (S301) through (S306), the encryption device 200 generates the ciphertext ctⁿ_{S} by executing the Enc algorithm indicated in Formula 136. In (S307), the encryption device 200 transmits the generated ciphertext ctⁿ_{S} to the decryption device 300.

$$Enc = ( pk , m , 𝕊 = ( M , ρ ) , n ) \text{:} \\ {f}^{->} {←}^{U} {𝔽}_{q}^{r} , \\ {{s}^{->}}^{T} := {( {s}_{1} , … , {s}_{L} )}^{T} := M \cdot {{f}^{->}}^{T} , {s}_{0} := {1}^{->} \cdot {{f}^{->}}^{T} , \\ {η}_{0. n} , ζ {←}^{U} {𝔽}_{q} , \\ {c}_{0. n} := {( ζ , - {s}_{0} , 0 , 0 , {η}_{0. n} )}_{{𝔹}_{0. n}} , {c}_{T . n} := m \cdot {g}_{T . n}^{ζ} , \\ for i = 1 , … , L , \\ if ρ ( i ) = ( t , {{v}^{->}}_{i} ) , {θ}_{i . n} , {η}_{i . n} {←}^{U} {𝔽}_{q} , \\ {c}_{i . n} := {( \overbrace{{s}_{i} {{e}^{->}}_{t , 1} + {θ}_{i . n} {{v}^{->}}_{t} ,}^{{n}_{t}} \overbrace{{0}^{{w}_{t}} ,}^{{w}_{t}} { \overbrace{{0}^{{z}_{t}} ,}^{{z}_{t}}}^{ } \overbrace{{η}_{i . n}}^{1} )}_{{𝔹}_{t . n}} , \\ if ρ ( i ) = ( t , {{v}^{->}}_{i} ) , {θ}_{i . n} , {η}_{i . n} {←}^{U} {𝔽}_{q} , \\ {c}_{i . n} := {( \overbrace{{s}_{i} {{v}^{->}}_{t ,}}^{{n}_{t}} \overbrace{{0}^{{w}_{t}} ,}^{{w}_{t}} { \overbrace{{0}^{{z}_{t}} ,}^{{z}_{t}}}^{ } \overbrace{{η}_{i . n}}^{1} )}_{{𝔹}_{t . n}} , \\ return {ct}_{𝕊}^{n} := ( 𝕊 , {\{ {c}_{i . n} \}}_{i = 0 , … , L} , {c}_{T . n} , n ) . \qquad [ Formula 136 ]$$

The function and operation of the decryption device 300 will be described.

As illustrated in FIG. 8, the decryption device 300 includes a decryption key receiving part 310 (decryption key acquisition part), an information input part 320, a re-encryption key generation part 330, a re-encryption key transmission part 340 (re-encryption key output part), a ciphertext receiving part 350, a span program computation part 360, a complementary coefficient computation part 370, a pairing operation part 380, and a message computation part 390. The re-encryption key generation part 330 includes a random number generation part 331, an encryption part 332, and a decryption key k*^{rk} generation part 333.

With reference to FIG. 14, the process of the RKG algorithm will now be described. The Dec2 algorithm will be described later.

(S401: Decryption Key Receiving Step)

Using the communication device and via the network, for example, the decryption key receiving part 310 receives the decryption key sk_{Γ} transmitted by the key generation device 100. The decryption key receiving part 310 also receives the public parameter pk generated by the key generation device 100.

(S402: Information Input Step)

Using the input device, the information input part 320 takes as input an access structure S′:=(M′, ρ′) . The access structure S′ is to be set according to the conditions of the system to be implemented. Attribute information of a user capable of decrypting a re-encrypted ciphertext ctⁿ⁺¹_{S′} is set in ρ′ of the access structure S′, for example. Note that ρ′(i)=(t, v^{→′}ᵢ:=(v′_{i,1}, . . . , v′_{i,1}, . . . , v′_{i,nt})∈F_{q}^{nt}\{0^{→}}) (v′_{i,nt}≠0).

Using the input device, the information input part 320 also takes as input the number of re-encryption times n. The number of re-encryption times n to be input here indicates the number of times a ciphertext for which a re-encryption key for re-encryption is to be generated has been re-encrypted. Specifically, when a re-encryption key for re-encrypting a ciphertext ct⁰_{S} which has never been re-encrypted is to be generated, 0 is input as the number of re-encryption times n. When a re-encryption key for re-encrypting a ciphertext ct¹_{S} which has been re-encrypted once is to be generated, 1 is input as the number of re-encryption times n.

(S403: Random Number Generation Step)

Using the processing device, the random number generation part 331 generates random numbers, as indicated in Formula 137.

$${r}_{n + 1} , {δ}_{0. n}^{ran} , {ϕ}_{0. n}^{ran} {←}^{U} {𝔽}_{q} , \\ {{ϕ}^{->}}_{t . n}^{ran} {←}^{U} {𝔽}_{q}^{{z}_{t}} for ( t , {{x}^{->}}_{t} ) ∈ Γ \qquad [ Formula 137 ]$$

(S404: Random Number Encryption Step)

Using the processing device, the encryption part 332 encrypts the random number rₙ₊₁ (conversion information) as indicated in Formula 138, and thus generates a ciphertext ct′ⁿ⁺¹_{S′}. Note that a function Eₙ₊₁ is an encode function from F_{q} to G_{T.n+1}.

$${ct}_{{𝕊}^{′}}^{′ n + 1} := ( {𝕊}^{′} , {\{ {c}_{i . n + 1} \}}_{i = 0 , … , L} , {c}_{T . n + 1} ) {←}^{R} Enc ( pk , {E}_{n + 1} ( {r}_{n + 1} ) , {𝕊}^{′} = ( {M}^{′} , {ρ}^{′} ) ) \qquad [ Formula 138 ]$$

(S405: Decryption Key k*^{rk} Generation Step)

Using the processing device, the decryption key k*^{rk} generation part 333 generates a decryption key k*^{rk}_{0.n}, as indicated in Formula 139.

k*_{0.n}^{rk}:=(rₙ₊₁k*_{0.n}+(0, δₙ^{ran},0, φ_{0.n}^{ran}, 0) [symbol] _{*}_{_{0.n}}) [Formula 139]

Using the processing device, the decryption key k*^{rk} generation part 333 also generates a decryption key k*^{rk}_{t.n} for each integer t included in the attribute set Γ, as indicated in Formula 140.

k*_{t.n}^{rk}:=(rₙ₊₁k*_{t.n}+(δₙ^{ran}\vec{x}ₜ, 0^{w}ₜ, \vec{φ}_{t.n}^{ran}, 0) [symbol] *_{t.n})) for (t, \vec{x}ₜ)∈Γ [Formula 140 ]

(S406: Key Transmission Step)

Using the communication device and via the network, for example, the re-encryption key transmission part 340 transmits a re-encryption key rkⁿ_{Γ,S′}, having as elements, the attribute set Γ, the access structure S′, the decryption keys k*^{rk}_{0.n} and k*^{rk}_{t,n}, the ciphertext cf′ⁿ⁺¹_{S′}, and the number of re-encryption times n (the value input in (S402) here) to the re-encryption device 400 in secrecy. As a matter of course, the re-encryption key rkⁿ_{Γ,S′} may be transmitted to the re-encryption device 400 by another method.

In brief, in (S401) through (S405), the decryption device 300 generates the re-encryption key rkⁿ_{ΓS′} by executing the RKG algorithm indicated in Formula 141. In (S406), the decryption device 300 transmits the generated re-encryption key rkⁿ_{Γ,S′} to the re-encryption device 400.

$$RKG = ( pk , {sk}_{Γ} , n , {𝕊}^{′} ) \text{:} \\ {r}_{n + 1} , {δ}_{n}^{ran} , {ϕ}_{0. n}^{ran} {←}^{U} {𝔽}_{q} , \\ {{ϕ}^{->}}_{t . n}^{ran} {←}^{U} {𝔽}_{q}^{{z}_{t}} for ( t , {{x}^{->}}_{t} ) ∈ Γ , \\ {ct}_{{𝕊}^{′}}^{′ n + 1} := ( {𝕊}^{′} , {\{ {c}_{i . n + 1} \}}_{i = 0 , … , L} , {c}_{T . n + 1} ) {←}^{R} Enc ( pk , {E}_{n + 1} ( {r}_{n + 1} ) , \\ {𝕊}^{′} = ( {M}^{′} , {ρ}^{′} ) ) , \\ {k}_{0. n}^{* rk} := ( {r}_{n + 1} {k}_{0. n}^{*} + {( 0 , {δ}_{n}^{ran} , 0 , {ϕ}_{0. n}^{ran} , 0 )}_{{𝔹}_{0. n}^{*}} ) , \\ {k}_{t . n}^{* rk} := ( {r}_{n + 1} {k}_{t . n}^{*} + {( {δ}_{n}^{ran} {{x}^{->}}_{t} , {0}^{{w}_{t}} , {{ϕ}^{->}}_{t . n}^{ran} , 0 )}_{{𝔹}_{t . n}^{*}} ) ) \\ for ( t , {{x}^{->}}_{t} ) ∈ Γ , \\ return {rk}_{Γ , {𝕊}^{′}}^{n} := ( Γ , {𝕊}^{′} , {k}_{0. n}^{* rk} , {\{ {k}_{t . n}^{* rk} \}}_{( t , {{x}^{->}}_{t} ) ∈ Γ} , {ct}_{{𝕊}^{′}}^{′ n + 1} , n ) . \qquad [ Formula 141 ]$$

The function and operation of the re-encryption device 400 will be described.

As illustrated in FIG. 9, the re-encryption device 400 includes a public parameter receiving part 410, a ciphertext receiving part 420 (ciphertext acquisition part), a re-encryption key receiving part 430 (re-encryption key acquisition part), a span program computation part 440,a complementary coefficient computation part 450,a pairing operation part 460,and a re-encrypted ciphertext transmission part 470 (re-encrypted ciphertext output part).

With reference to FIG. 15, the process of the REnc algorithm will be described.

(S501: Public Parameter Receiving Step)

Using the communication device and via the network, for example, the public parameter receiving part 410 receives the public parameter pk generated by the key generation device 100.

(S502: Ciphertext Receiving Step)

Using the communication device and via the network, for example, the ciphertext receiving part 420 receives the ciphertext ctⁿ_{S} transmitted by the encryption device 200.

(S503: Re-encryption Key Receiving Step)

Using the communication device and via the network, for example, the re-encryption key receiving part 430 receives the re-encryption key rkⁿ_{Γ,S′} transmitted by the decryption device 300.

(S504: Span Program Computation Step)

Using the processing device, the span program computation part 440 determines whether or not the access structure S included in the ciphertext ctⁿ_{S} accepts Γ included in the re-encryption key rkⁿ_{Γ,S′}. The method for determining whether or not the access structure S accepts Γ is as described in “3. Concept for Implementing FPRE” in Embodiment 1.

If the access structure S accepts Γ (accept in S504), the span program computation part 440 advances the process to (S505). If the access structure S rejects Γ (reject in S504), the span program computation part 440 ends the process.

(S505: Complementary Coefficient Computation Step)

Using the processing device, the complementary coefficient computation part 450 computes I and a constant (complementary coefficient) {αᵢ}_{i∈I} such that Formula 142 is satisfied.

$${1}^{->} = {\sum }_{i ∈ I} {α}_{i} {M}_{i} \\ where {M}_{i} is the i \text{-} th row of M , \\ and I ⊆ \{ i ∈ \{ 1 , … , L \} \vert [ ρ ( i ) = ( t , {{v}^{->}}_{i} ) ⋀ ( t , {{x}^{->}}_{t} ) ∈ Γ ⋀ {{v}^{->}}_{i} \cdot {{x}^{->}}_{t} = 0 ] ⋁ [ ρ ( i ) = ( t , {{v}^{->}}_{i} ) ⋀ ( t , {{x}^{->}}_{t} ) ∈ Γ ⋀ {{v}^{->}}_{i} \cdot {{x}^{->}}_{t} \neq 0 ] \} \qquad [ Formula 142 ]$$

(S506: Pairing Operation Step)

Using the processing device, the pairing operation part 460 computes Formula 143, and thus generates a session key K′ₙ.

$${K}_{n}^{′} = e ( {c}_{0. n} , {k}_{0. n}^{* rk} ) \cdot {\prod }_{i ∈ I ⋀ ρ ( i ) = ( t , {{v}^{->}}_{i} )} {e ( {c}_{i . n} , {k}_{t . n}^{* rk} )}^{{α}_{i}} \cdot {\prod }_{i ∈ I ⋀ ρ ( i ) = ( t , {{v}^{->}}_{i} )} {e ( {c}_{i . n} , {k}_{t . n}^{* rk} )}^{{α}_{i} / ( {{v}^{->}}_{i} \cdot {{x}^{->}}_{t} )} \qquad [ Formula 143 ]$$

(S507: Re-encrypted Ciphertext Transmission Step)

Using the communication device and via the network, for example, the re-encrypted ciphertext transmission part 470 transmits a re-encrypted ciphertext having, as elements, the session key K′ₙ, the ciphertext c_{T.n}, the access structure S′, the ciphertext ct′ⁿ⁺¹_{S′}, and the number of re-encryption times n+1 (a value obtained by adding 1 to the number of re-encryption times n included in the ciphertext ctⁿ_{S} received in (S502) or the number of re-encryption times n included in the re-encryption key rkⁿ_{Γ,S′} received in (S503) here) to the re-encrypted ciphertext decryption device 500 in secrecy. As a matter of course, the re-encrypted ciphertext ctⁿ⁺¹_{S′} may be transmitted to the re-encrypted ciphertext decryption device 500 by another method.

The description herein assumes a case where the ciphertext ctⁿ_{S} (ct⁰_{S}) output by the encryption device 200 is re-encrypted. However, it is also possible to further re-encrypt the re-encrypted ciphertext ctⁿ⁺¹_{S′} output by the re-encryption device 400.

In this case, in (S502), the ciphertext receiving part 420 obtains the re-encrypted ciphertext ctⁿ⁺¹_{S′} output by the re-encryption device 400, in place of the ciphertext ctⁿ_{S} output by the encryption device 200, as the ciphertext ctⁿ_{S}. The ciphertext ctⁿ⁺¹_{S′} includes the access structure S′ as an element. For descriptive purposes, the access structure S′ is read as the access structure S. In the ciphertext ctⁿ⁺¹_{S′}, the number of re-encryption times is n+1. For descriptive purposes, the number of re-encryption times is read as n.

Then, in (S507), the re-encrypted ciphertext transmission part 470 transmits the re-encrypted ciphertext ctⁿ⁺¹_{S′} having, as elements, the above-described elements and also the elements included in the ciphertext ctⁿ_{S} obtained in (S502) (the session key {K′ⱼ}_{j=1, . . . , n} and the ciphertext {c_{T.j}}_{j=0, . . . , n-1}) to the re-encrypted ciphertext decryption device 500

The rest of the process is as described above.

In brief, in (S501) through (S506), the re-encryption device 400 generates the re-encrypted ciphertext ctⁿ⁺¹_{S′} by executing the REnc algorithm indicated in Formula 144. In (S507), the re-encryption device 400 transmits the generated re-encrypted ciphertext ctⁿ⁺¹_{S′} to the re-encrypted ciphertext decryption device 500.

$$REnc = ( pk , {rk}_{Γ , {𝕊}^{′}}^{n} , {ct}_{𝕊}^{n} ) \\ If 𝕊 accepts Γ , \\ then compute I and {\{ {α}_{i} \}}_{i ∈ I} such that \\ {1}^{->} = {\sum }_{i ∈ I} {α}_{i} {M}_{i} \\ where {M}_{i} is the i \text{-} th row of M , \\ and I ⊆ \{ i ∈ \{ 1 , … , L \} \vert [ ρ ( i ) = ( t , {{v}^{->}}_{i} ) ⋀ ( t , {{x}^{->}}_{t} ) ∈ Γ ⋀ {{v}^{->}}_{i} \cdot {{x}^{->}}_{t} = 0 ] ⋁ [ ρ ( i ) = ( t , {{v}^{->}}_{i} ) ⋀ ( t , {{x}^{->}}_{t} ) ∈ Γ ⋀ {{v}^{->}}_{i} \cdot {{x}^{->}}_{t} \neq 0 ] \} , \\ {K}_{n}^{′} = e ( {c}_{0. n} , {k}_{0. n}^{* rk} ) \cdot {\prod }_{i ∈ I ⋀ ρ ( i ) = ( t , {{v}^{->}}_{i} )} {e ( {c}_{i . n} , {k}_{t . n}^{* rk} )}^{{α}_{i}} \cdot {\prod }_{i ∈ I ⋀ ρ ( i ) = ( t , {{v}^{->}}_{i} )} {e ( {c}_{i . n} , {k}_{t . n}^{* rk} )}^{{α}_{i} / ( {{v}^{->}}_{i} \cdot {{x}^{->}}_{t} )} , \\ return {ct}_{{𝕊}^{′}}^{n + 1} := ( {𝕊}^{′} , {\{ {c}_{T . j} , {K}_{j}^{′} \}}_{j = 0 , … , n} , {ct}_{{𝕊}^{′}}^{′ n + 1} , n + 1 ) . \qquad [ Formula 144 ]$$

If the number of re-encryption times n included in the ciphertext ctⁿ_{S} received in (S502) does not coincide with the number of re-encryption times n included in the re-encryption key rkⁿ_{Γ,S′} received in (S503), re-encryption is not possible.

The function and operation of the re-encrypted ciphertext decryption device 500 will be described.

As illustrated in FIG. 10, the re-encrypted ciphertext decryption device 500 includes a decryption key receiving part 510, a ciphertext receiving part 520, a span program computation part 530, a complementary coefficient computation part 540, a pairing operation part 550, a random number computation part 560, and a message computation part 570.

With reference to FIG. 16, the process of the Dec1 algorithm will be described.

(S601: Decryption Key Receiving Step)

Using the communication device and via the network, for example, the decryption key receiving part 510 receives the decryption key sk_{Γ′} transmitted by the key generation device 100. The decryption key receiving part 310 also receives the public parameter pk generated by the key generation device 100.

(S602: Ciphertext Receiving Step)

Using the communication device and via the network, for example, the ciphertext receiving part 520 receives the re-encrypted ciphertext ctⁿ_{S′} transmitted by the re-encryption device 400.

It has been described that the REnc algorithm outputs the re-encrypted ciphertext ctⁿ⁺¹_{S′}. However, it is here represented by being changed to the re-encrypted ciphertext ctⁿ_{S′}. That is, when a ciphertext ctⁿ_{S} (ct⁰_{S}) whose number of re-encryption times is 0 (n=0) is re-encrypted with a re-encryption key rkⁿ_{Γ,S′} (rk⁰_{Γ,S′}) to generate a re-encrypted ciphertext ctⁿ⁺¹_{S}(ct⁰⁺¹_{S}), the re-encrypted ciphertext ctⁿ⁺¹_{S} (ct⁰⁺¹_{S}) is represented as a re-encrypted ciphertext ctⁿ_{S} (ct¹_{S}).

(S603: Span Program Computation Step)

Using the processing device, the span program computation part 530 determines whether or not the access structure S′ included in the re-encrypted ciphertext ctⁿ_{S′} accepts Γ′ included in the decryption key sk_{Γ′}. The method for determining whether or not the access structure S′ accepts Γ′ is as described in “3. Concept for Implementing FPRE” in Embodiment 1.

If the access structure S′ accepts Γ′ (accept in S603), the span program computation part 530 advances the process to (S604). If the access structure S′ rejects Γ′ (reject in S603), the span program computation part 530 ends the process.

(S604: Complementary Coefficient Computation Step)

Using the processing device, the complementary coefficient computation part 540 computes I and a constant (complementary coefficient) {αᵢ}_{i∈I} such that Formula 145 is satisfied.

$${1}^{->} = {\sum }_{i ∈ I} {α}_{i} {M}_{i}^{′} \\ where {M}_{i}^{′} is the i \text{-} th row of {M}^{′} , \\ and I ⊆ \{ i ∈ \{ 1 , … , L \} \vert [ {ρ}^{′} ( i ) = ( t , {{v}^{->}}_{i}^{′} ) ⋀ ( t , {{x}^{->}}_{t}^{′} ) ∈ {Γ}^{′} ⋀ {{v}^{->}}_{i}^{′} \cdot {{x}^{->}}_{t}^{′} = 0 ] ⋁ [ {ρ}^{′} ( i ) = ( t , {{v}^{->}}_{i}^{′} ) ⋀ ( t , {{x}^{->}}_{t}^{′} ) ∈ {Γ}^{′} ⋀ {{v}^{->}}_{i}^{′} \cdot {{x}^{->}}_{t}^{′} \neq 0 ] \} \qquad [ Formula 145 ]$$

(S605: Pairing Operation Step)

Using the processing device, the pairing operation part 550 computes Formula 146, and thus generates a session key K′ₙ.

$${K}_{n}^{′} = e ( {c}_{0. n} , {k}_{0. n}^{*} ) \cdot {\prod }_{i ∈ I ⋀ ρ ( i ) = ( t , {{v}^{->}}_{i} )} {e ( {c}_{i . n} , {k}_{t . n}^{*} )}^{{α}_{i}} \cdot {\prod }_{i ∈ I ⋀ ρ ( i ) = ( t , {{v}^{->}}_{i} )} {e ( {c}_{i . n} , {k}_{t . n}^{*} )}^{{α}_{i} / ( {{v}^{->}}_{i} \cdot {{x}^{->}}_{t} )} \qquad [ Formula 146 ]$$

(S606: Random Number Computation Step)

Using the processing device, the random number computation part 560 computes Formula 147, and thus generates a random number rₙ.

Eₙ(rₙ):=c_{T.n}/K′ₙ,

rₙ:=decode(Eₙ(rₙ)) [Formula 147]

Further, when n is 2 or more, the random number computation part 560 computes Formula 148 sequentially for each integer j=n−1, . . . , 1, and thus generates a random number r₁, using the processing device.

Eⱼ(rⱼ):=c_{T.j} /(K′ⱼ)^{r}^{ⱼ₊₁},

rⱼ:=decode(Eⱼ(rⱼ)) [Formula 148]

(S607: Message Computation Step)

Using the processing device, the message computation part 570 computes m=c_{T.0}/(K′₀)^{r1}, and thus generates a message m, where r1 signifies the random number r₁.

In brief, in (S601) through (S607), the re-encrypted ciphertext decryption device 500 generates the message m by executing the Dec1 algorithm indicated in Formula 149.

$$Dec 1 = ( pk , {sk}_{{Γ}^{′}} , {ct}_{{𝕊}^{′}}^{n} ) \\ If {𝕊}^{′} accepts {Γ}^{′} , \\ then compute I and {\{ {α}_{i} \}}_{i ∈ I} such that \\ {1}^{->} = {\sum }_{i ∈ I} {α}_{i} {M}_{i}^{′} \\ where {M}_{i}^{′} is the i \text{-} th row of {M}^{′} , \\ and I ⊆ \{ i ∈ \{ 1 , … , L \} \vert [ {ρ}^{′} ( i ) = ( t , {{v}^{->}}_{i}^{′} ) ⋀ ( t , {{x}^{->}}_{t}^{′} ) ∈ {Γ}^{′} ⋀ {{v}^{->}}_{i}^{′} \cdot {{x}^{->}}_{t}^{′} = 0 ] ⋁ [ {ρ}^{′} ( i ) = ( t , {{v}^{->}}_{i}^{′} ) ⋀ ( t , {{x}^{->}}_{t}^{′} ) ∈ {Γ}^{′} ⋀ {{v}^{->}}_{i}^{′} \cdot {{x}^{->}}_{t}^{′} \neq 0 ] \} , \\ {K}_{n}^{′} = e ( {c}_{0. n} , {k}_{0. n}^{*} ) \cdot {\prod }_{i ∈ I ⋀ ρ ( i ) = ( t , {{v}^{->}}_{i} )} {e ( {c}_{i . n} , {k}_{t . n}^{*} )}^{{α}_{i}} \cdot {\prod }_{i ∈ I ⋀ ρ ( i ) = ( t , {{v}^{->}}_{i} )} {e ( {c}_{i . n} , {k}_{t . n}^{*} )}^{{α}_{i} / ( {{v}^{->}}_{i} \cdot {{x}^{->}}_{t} )} , \\ {E}_{n} ( {r}_{n} ) := {c}_{T . n} / {K}_{n}^{′} , {r}_{n} := decode ( {E}_{n} ( {r}_{n} ) ) , \\ for j = n - 1 , … , 1 , \\ {E}_{j} ( {r}_{j} ) := {c}_{T . j} / {( {K}_{j}^{′} )}^{{r}_{j + 1}} , {r}_{j} := decode ( {E}_{j} ( {r}_{j} ) ) , \\ m := {c}_{T .0} / ( {K}_{0}^{′} ) {r}_{1} , \\ return m . \qquad [ Formula 149 ]$$

With reference to FIG. 17, the process of the Dec2 algorithm will be described.

(S701: Decryption Key Receiving Step)

Using the communication device and via the network, for example, the decryption key receiving part 310 receives the decryption key sk_{Γ} transmitted by the key generation device 100. The decryption key receiving part 310 also receives the public parameter pk generated by the key generation device 100.

(S702: Ciphertext Receiving Step)

Using the communication device and via the network, for example, the ciphertext receiving part 350 receives the ciphertext ctⁿ_{S} (ct⁰_{S}) transmitted by the encryption device 200.

(S703: Span Program Computation Step)

Using the processing device, the span program computation part 360 determines whether or not the access structure S included in the ciphertext ct_{S} accepts Γ included in the decryption key sk_{Γ}. The method for determining whether or not the access structure S accepts Γ is as described in “3. Concept for Implementing FPRE” in Embodiment 1.

If the access structure S accepts Γ (accept in S703), the span program computation part 360 advances the process to (S704). If the access structure S rejects Γ (reject in S703), the span program computation part 360 ends the process.

(S704: Complementary Coefficient Computation Step)

Using the processing device, the complementary coefficient computation part 370 computes I and a constant (complementary coefficient) {αᵢ}_{i∈I} such that Formula 150 is satisfied.

$${1}^{->} = {\sum }_{i ∈ I} {α}_{i} {M}_{i} \\ where {M}_{i} is the i \text{-} th row of M , \\ and I ⊆ \{ i ∈ \{ 1 , … , L \} \vert [ ρ ( i ) = ( t , {{v}^{->}}_{i} ) ⋀ ( t , {{x}^{->}}_{t} ) ∈ Γ ⋀ {{v}^{->}}_{i} \cdot {{x}^{->}}_{t} = 0 ] ⋁ [ ρ ( i ) = ( t , {{v}^{->}}_{i} ) ⋀ ( t , {{x}^{->}}_{t} ) ∈ Γ ⋀ {{v}^{->}}_{i} \cdot {{x}^{->}}_{t} \neq 0 ] \} \qquad [ Formula 150 ]$$

(S705: Pairing Operation Step)

Using the processing device, the pairing operation part 380 computes Formula 151, and thus generates a session key K₀.

$${K}_{0}^{′} = e ( {c}_{0.0} , {k}_{0.0}^{*} ) \cdot {\prod }_{i ∈ I ⋀ ρ ( i ) = ( t , {{v}^{->}}_{i} )} {e ( {c}_{i .0} , {k}_{t .0}^{*} )}^{{α}_{i}} \cdot {\prod }_{i ∈ I ⋀ ρ ( i ) = ( t , {{v}^{->}}_{i} )} {e ( {c}_{i .0} , {k}_{t .0}^{*} )}^{{α}_{i} / ( {{v}^{->}}_{i} \cdot {{x}^{->}}_{t} )} \qquad [ Formula 151 ]$$

(S706: Message Computation Step)

Using the processing device, the message computation part 390 computes m=c-_{T.0}/K₀, and thus generates a message m.

In brief, in (S701) through (S706), the decryption device 300 generates the message m by executing the Dec2 algorithm indicated in Formula 152.

$$Dec 2 = ( pk , {sk}_{Γ} , {ct}_{𝕊}^{0} ) \\ If 𝕊 accepts Γ , \\ then compute I and {\{ {α}_{i} \}}_{i ∈ I} such that \\ {1}^{->} = {\sum }_{i ∈ I} {α}_{i} {M}_{i} \\ where {M}_{i} is the i \text{-} th row of M , \\ and I ⊆ \{ i ∈ \{ 1 , … , L \} \vert [ ρ ( i ) = ( t , {{v}^{->}}_{i} ) ⋀ ( t , {{x}^{->}}_{t} ) ∈ Γ ⋀ {{v}^{->}}_{i} \cdot {{x}^{->}}_{t} = 0 ] ⋁ [ ρ ( i ) = ( t , {{v}^{->}}_{i} ) ⋀ ( t , {{x}^{->}}_{t} ) ∈ Γ ⋀ {{v}^{->}}_{i} \cdot {{x}^{->}}_{t} \neq 0 ] \} , \\ {K}_{0}^{′} = e ( {c}_{0.0} , {k}_{0.0}^{*} ) \cdot {\prod }_{i ∈ I ⋀ ρ ( i ) = ( t , {{v}^{->}}_{i} )} {e ( {c}_{i .0} , {k}_{t .0}^{*} )}^{{α}_{i}} \cdot {\prod }_{i ∈ I ⋀ ρ ( i ) = ( t , {{v}^{->}}_{i} )} {e ( {c}_{i .0} , {k}_{t .0}^{*} )}^{{α}_{i} / ( {{v}^{->}}_{i} \cdot {{x}^{->}}_{t} )} \\ m := {c}_{T .0} / {K}_{0} , \\ return m . \qquad [ Formula 152 ]$$

As described above, the cryptographic system 10 according to Embodiment 1 implements the CP-FPRE scheme. Thus, a ciphertext can be forwarded to a set of various types of users with a single re-encryption key.

In particular, in the cryptographic system 10 according to Embodiment 1, re-encrypting once increases the size of a ciphertext only by the size of constant-sized elements. Therefore, executing re-encryption n times increases the size of a ciphertext only by the size of polynomial elements each being multiplied relative to the number of re-encryption execution times n. This is very efficient compared with the conventional FPRE scheme, allowing the FPRE scheme to be applied more widely.

It has been described above that the decryption device 300 also functions as the re-encryption key generation device, and that the decryption device 300 executes the RKG algorithm as well as the Dec2 algorithm. However, a re-encryption key for further re-encrypting the re-encrypted ciphertext ctⁿ_{S′} is generated by the re-encrypted ciphertext decryption device 500 by executing the RKG algorithm as the re-encryption key generation device. In this case, therefore, the re-encrypted ciphertext decryption device 500 also includes functional components that are required to execute the RKG algorithm out of the functional components included in the decryption device 300.

The decryption device 300 (and the re-encrypted ciphertext decryption device 500) and the re-encryption key generation device may be implemented separately. In this case, the decryption device 300 executes the Dec2 algorithm, and the re-encryption key generation device executes the RKG algorithm. In this case, therefore, the decryption device 300 includes functional components that are required to execute the Dec2 algorithm, and the re-encryption key generation device includes functional components that are required to execute the RKG algorithm.

In the above description, nₜ+wₜ+zₜ+1 is set in Nₜ. However, nₜ+wₜ+zₜ+βₜ may be set in Nₜ, where βₜ is an integer of 0 or more.

In the above description, 5 is set in N₀. However, 1+1+w₀+z₀+β₀ may be set in N₀, where w₀, z₀, and β₀ are each an integer of 0 or more.

### Embodiment 2

In the FPRE scheme described in Embodiment 1, in the Setup algorithm, the value Q indicating the upper limit value of the number of re-encryption times is input, and a different basis B_{t.j} and a different basis B*_{t.j}are generated for each integer j=1, . . . , Q. For this reason, the size of the public parameter increases as the upper limit value of the number of re-encryption times becomes larger, thus adversely affecting the efficiency of the cryptographic processes.

Embodiment 2 describes an FPRE scheme in which an indexing technique is employed to eliminate the upper limit value of the number of re-encryption times and achieve a fixed size of the public parameter not depending on the number of re-encryption times.

In Embodiment 2, description will be omitted for portions that are the same as in Embodiment 1, and portions that are different from Embodiment 1 will be described.

The configuration of the cryptographic system 10 is the same as the configuration of the cryptographic system 10 according to Embodiment 1 illustrated in FIG. 5. However, it is not necessary to input the value Q in the Setup algorithm. The configuration of each device constituting the cryptographic system 10 is the same as the configuration of each device according to Embodiment 1 illustrated in FIG. 6 through FIG. 10.

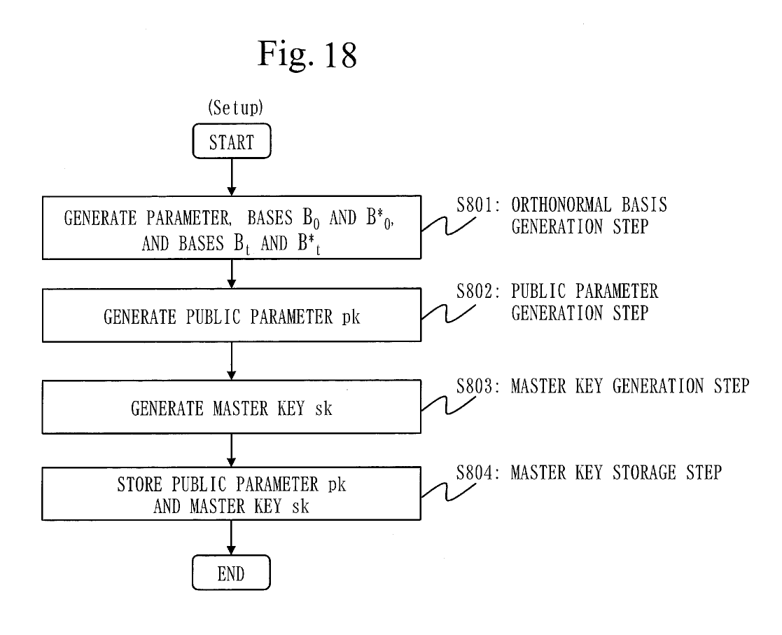

FIG. 18 is a flowchart illustrating the process of the Setup algorithm. The flows of the processes of the other algorithms are the same as the flows of the processes of those algorithms illustrated in FIG. 12 through FIG. 17. With regard to the REnc algorithm and the Dec2 algorithm, the content of the process is also the same as in Embodiment 1.

With reference to FIG. 18, the process of the Setup algorithm will be described.

(S801: Orthonormal Basis Generation Step)

Using the processing device, the master key generation part 110 computes Formula 153, and thus generates a parameter param_{n→}, a basis B₀ and a basis B*₀, and a basis Bₜ and a basis B*ₜ.

$${param}_{𝔾} := ( q , 𝔾 , {𝔾}_{T} , g , e ) {←}^{R} {𝒢}_{bpg} ( {1}^{λ} ) , \\ {N}_{0} := 5 , \\ {N}_{t} := 2 + {n}_{t} + {w}_{t} + {z}_{t} + 1 for t = 1 , … , d , \\ ψ {←}^{U} {𝔽}_{q}^{\times } , {g}_{T} := {e ( g , g )}^{ψ} , \\ for t = 0 , … , d , \\ {param}_{{𝕍}_{t}} := ( q , {𝕍}_{t} , {𝔾}_{T} , {𝔸}_{t} , e ) {←}^{R} {𝒢}_{dpvs} ( {1}^{λ} , {N}_{t} , {param}_{𝔾} ) , \\ {X}_{t} = ( \begin{matrix}{{χ}^{->}}_{t , 1} \\ ⋮ \\ {{χ}^{->}}_{t , {N}_{t}}\end{matrix} ) := {( {χ}_{t , i , j} )}_{i , j} {←}^{U} GL ( {N}_{t} , {𝔽}_{q} ) , \\ ( \begin{matrix}{{v}^{->}}_{t , 1} \\ ⋮ \\ {{v}^{->}}_{t , {N}_{t}}\end{matrix} ) := {( {v}_{t , i , j} )}_{i , j} := ψ \cdot {( {X}_{t}^{T} )}^{- 1} , \\ {b}_{t , i} := {\sum }_{j = 1}^{{N}_{t}} {χ}_{t , i , j} {a}_{t , j} , {𝔹}_{t} := ( {b}_{t , 1} , … , {b}_{t , {N}_{t}} ) , , \\ {b}_{t , i}^{*} := {\sum }_{j = 1}^{{N}_{t}} {v}_{t , i , j} {a}_{t , j} , {𝔹}_{t}^{*} := ( {b}_{t , 1}^{*} , … , {b}_{t , {N}_{t}}^{*} ) , \\ {param}_{{n}^{->}} := ( {g}_{T} , {\{ {param}_{t} \}}_{t = 0 , … , d} ) \qquad [ Formula 153 ]$$

(S802: Public Parameter Generation Step)

Using the processing device, the master key generation part 110 generates a subbasis B̂₀ of the basis B₀, a subbasis B̂ₜ of the basis Bₜ, a subbasis B̂*₀ of the basis B*₀, and a subbasis B̂*ₜ of the basis B*ₜ, as indicated in Formula 154.

[symbol]

₀:=(b_{0,1}, b_{0,2}, b_{0,5}),

[symbol]

ₜ:=(b_{t,1}, . . . , b_{t,2+n}_{ₜ}, b_{t,N}_{ₜ}) for t=1, . . . , d,

[symbol]

*₀:=(b_{0,2}, b*_{0,4}),

[symbol]

*ₜ:=(b*_{t,1}, . . . , b*_{t,2+n}_{ₜ}, b*_{t,2+n}_{ₜ}_{+w}_{ₜ}₊₁, . . . , b*_{t,2+n}_{ₜ}_{+w}_{ₜ}_{+z}_{ₜ}) for t=1, . . . , d, [Formula 154]

The master key generation part 110 generates a public parameter pk by putting together the security parameter λ, param_{n→}, and the subbases B̂₀, B̂ₜ, B̂*₀, and B̂*ₜ.

(S803: Master Key Generation Step)

The master key generation part 110 generates a master key sk which is constituted by the basis vector b*_{0.1}.

(S804: Master Key Storage Step)

The master key storage part 120 stores the public parameter pk generated in (S802) in the storage device. The master key storage part 120 also stores the master key sk generated in (S803) in the storage device.

In brief, in (S801) through (S803), the key generation device 100 generates the public parameter pk and the master key sk by executing the Setup algorithm indicated in Formula 155. In (S804), the key generation device 100 stores the generated public parameter pk and master key sk in the storage device.

$$[ Formula 155 ] \\ Setup ( {1}^{λ} , {n}^{->} = ( d ; {n}_{1} , … , {n}_{d} ; {w}_{1} , … , {w}_{d} ; {z}_{1} , … , {z}_{d} ) ) \text{:} \\ {param}_{𝔾} := ( q , 𝔾 , {𝔾}_{T} , g , e ) {←}^{R} {𝒢}_{bpg} ( {1}^{λ} ) , \\ {N}_{0} := 5 , {N}_{t} := 2 + {n}_{t} + {w}_{t} + {z}_{t} + 1 for t = 1 , … , d , \\ ψ {←}^{U} {𝔽}_{q}^{\times } , {g}_{T} := {e ( g , g )}^{ψ} , \\ for t = 0 , … , d , \\ {param}_{{𝕍}_{t}} := ( q , {𝕍}_{t} , {𝔾}_{T} , {𝔸}_{t} , e ) {←}^{R} {𝒢}_{dpvs} ( {1}^{λ} , {N}_{t} , {param}_{𝔾} ) , \\ {X}_{t} = ( \begin{matrix}{{χ}^{->}}_{t , 1} \\ ⋮ \\ {{χ}^{->}}_{t , {N}_{t}}\end{matrix} ) := {( {χ}_{t , i , j} )}_{i , j} {←}^{U} GL ( {N}_{t} , {𝔽}_{q} ) , \\ ( \begin{matrix}{{v}^{->}}_{t , 1} \\ ⋮ \\ {{v}^{->}}_{t , {N}_{t}}\end{matrix} ) := {( {v}_{t , i , j} )}_{i , j} := ψ \cdot {( {X}_{t}^{T} )}^{- 1} , \\ {b}_{t , i} := {\sum }_{j = 1}^{{N}_{t}} {χ}_{t , i , j} {a}_{t , j} , {𝔹}_{t} := ( {b}_{t , 1} , … , {b}_{t , {N}_{t}} ) , , \\ {b}_{t , i}^{*} := {\sum }_{j = 1}^{{N}_{t}} {v}_{t , i , j} {a}_{t , j} , {𝔹}_{t}^{*} := ( {b}_{t , 1}^{*} , … , {b}_{t , {N}_{t}}^{*} ) , \\ {param}_{{n}^{->}} := ( {g}_{T} , {\{ {param}_{t} \}}_{t = 0 , … , d} ) , \\ {\hat{𝔹}}_{0} := ( {b}_{0 , 1} , {b}_{0 , 2} , {b}_{0 , 5} ) , \\ {\hat{𝔹}}_{t} := ( {b}_{t , 1} , … , {b}_{t , 2 + {n}_{t}} , {b}_{t , {N}_{t}} ) for t = 1 , … , d , \\ {\hat{𝔹}}_{0}^{*} := ( {b}_{0 , 2}^{*} , {b}_{0 , 4}^{*} ) , \\ {\hat{𝔹}}_{t}^{*} := ( {b}_{t , 1}^{*} , … , {b}_{t , 2 + {n}_{t}}^{*} , {b}_{t , 2 + {n}_{t} + {w}_{t} + 1}^{*} , … , {b}_{t , 2 + {n}_{t} + {w}_{t} + {z}_{t}}^{*} ) \\ for t = 1 , … , d , , \\ return pk ( {1}^{λ} , {param}_{{n}^{->}} , {\{ {\hat{𝔹}}_{t} , {\hat{𝔹}}_{t}^{*} \}}_{t = 0 , … , d} ) , \\ sk = ( {b}_{0 , 1}^{*} ) . \qquad$$

With reference to FIG. 12, the process of the KG algorithm will be described.

The process of (S201) is the same as in Embodiment 1.

(S202: Random Number Generation Step)

Using the processing device, the random number generation part 141 generates random numbers, as indicated in Formula 156.

$$[ Formula 156 ] \\ δ , {ϕ}_{0} {←}^{U} {𝔽}_{q} , \\ {\vec{ϕ}}_{t} {←}^{U} {𝔽}_{q}^{{z}_{t}} for ( t , {{x}^{->}}_{t} ) ∈ Γ \qquad$$

(S203: Decryption Key k* Generation Step)

Using the processing device, the decryption key k* generation part 142 generates a decryption key k*₀, as indicated in Formula 157.

k*₀:=(1, δ, 0, φ₀, 0) [symbol] *₀ [Formula 157]

Using the processing device, the decryption key k* generation part 142 also generates a decryption key k*ₜ for each integer t included in the attribute set Γ, as indicated in Formula 158.

$$[ Formula 158 ] \\ {k}_{t .0}^{*} := {( \overbrace{{0}^{2} ,}^{2} \overbrace{δ {{x}^{->}}_{t} ,}^{{n}_{t}} \overbrace{{0}^{{w}_{t}} ,}^{{w}_{t}} \overbrace{{{ϕ}^{->}}_{t} ,}^{{z}_{t}} \overbrace{0}^{1} )}_{{𝔹}_{t}^{*}} for ( t , {{x}^{->}}_{t} ) , ∈ Γ \qquad$$

(S204: Key Transmission Step)

Using the communication device and via the network, for example, the key transmission part 150 transmits a decryption key sk_{Γ} having, as elements, the attribute set Γ and the decryption keys k*₀ and k*ₜ to the decryption device 300 in secrecy.

In brief, in (S201) through (S203), the key generation device 100 generates the decryption key sk_{Γ} by executing the KG algorithm indicated in Formula 159. In (S204), the key generation device 100 transmits the decryption key sk_{Γ} to the decryption device 300.

$$[ Formula 159 ] \\ KG = ( pk , sk , Γ = ( \{ t , {{x}^{->}}_{t} ) \vert {{x}^{->}}_{t} ∈ {𝔽}_{q}^{{n}_{t}} \backslash \{ {0}^{->} \} , 1 \leq t \leq d \} ) \text{:} \\ δ , {ϕ}_{0} {←}^{U} {𝔽}_{q} , {{ϕ}^{->}}_{t} {←}^{U} {𝔽}_{q}^{{z}_{t}} for ( t , {{x}^{->}}_{t} ) ∈ Γ , \\ {k}_{0.0}^{*} := {( 1 , δ , 0 , {ϕ}_{0} , 0 )}_{{𝔹}_{0}^{*}} , \\ {k}_{t .0}^{*} := {( \overbrace{{0}^{2} ,}^{2} \overbrace{δ {{x}^{->}}_{t} ,}^{{n}_{t}} \overbrace{{0}^{{w}_{t}} ,}^{{w}_{t}} \overbrace{{{ϕ}^{->}}_{t} ,}^{{z}_{t}} \overbrace{0}^{1} )}_{{𝔹}_{t}^{*}} for ( t , {{x}^{->}}_{t} ) , ∈ Γ , \\ return {sk}_{Γ} := ( Γ , {k}_{0}^{*} , {\{ {k}_{t}^{*} \}}_{( t , {{x}^{->}}_{t} ) ∈ Γ} ) . \qquad$$

With reference to FIG. 13, the process of the Enc algorithm will be described.

The process of (S301) through (S304) and (S307) are the same as in Embodiment 1.

(S305: Random Number Generation Step)

Using the processing device, the random number generation part 233 generates random numbers, as indicated in Formula 160.

$$[ Formula 160 ] \\ {η}_{0. n} , ζ , {μ}_{n} {←}^{U} {𝔽}_{q} , \\ {θ}_{i . n} , {η}_{i . n} , ζ , {μ}_{n} {←}^{U} {𝔽}_{q} for i = 1 , … , L \qquad$$

(S306: Ciphertext c Generation Step)

Using the processing device, the ciphertext c generation part 234 generates a ciphertext c_{0.n}, as indicated in Formula 161.

c_{0.n}:=(ζ, −s₀,0, 0, η_{0.n}) [symbol] ₀ [Formula 161]

The ciphertext c generation part 234 also generates a ciphertext c_{i.n} for each integer i=1, . . . , L, as indicated in Formula 162.

$$[ Formula 162 ] \\ for i = 1 , … , L , \\ if ρ ( i ) = ( t , {{v}^{->}}_{i} ) , \\ {c}_{i . n} := {( \overbrace{{μ}_{n} ( n , - 1 ) ,}^{2} \overbrace{{s}_{i} {{e}^{->}}_{t , 1} + {θ}_{i . n} {{v}^{->}}_{t} ,}^{{n}_{t}} \overbrace{{0}^{{w}_{t}} ,}^{{w}_{t}} { \overbrace{{0}^{{z}_{t}} ,}^{{z}_{t}}}^{ } \overbrace{{η}_{i . n}}^{1} )}_{{𝔹}_{t}} , \\ if ρ ( i ) = ( t , {{v}^{->}}_{i} ) , \\ {c}_{i . n} := {( \overbrace{{μ}_{n} ( n , - 1 ) ,}^{2} \overbrace{{s}_{i} {{v}^{->}}_{t ,}}^{{n}_{t}} \overbrace{{0}^{{w}_{t}} ,}^{{w}_{t}} { \overbrace{{0}^{{z}_{t}} ,}^{{z}_{t}}}^{ } \overbrace{{η}_{i . n}}^{1} )}_{{𝔹}_{t}} \qquad$$

Using the processing device, the ciphertext c generation part 234 also generates a ciphertext c_{T.n}, as indicated in Formula 163.

c_{T.n}:=m·g_{T}^{ζ} [Formula 163]

In brief, in (S301) through (S306), the encryption device 200 generates the ciphertext ctⁿ_{S} by executing the Enc algorithm indicated in Formula 164. In (S307), the encryption device 200 transmits the generated ciphertext ctⁿ_{S} to the decryption device 300.

$$[ Formula 164 ] \\ Enc = ( pk , m , 𝕊 = ( M , ρ ) , n ) \text{:} \\ {f}^{->} {←}^{U} {𝔽}_{q}^{r} , \\ {{s}^{->}}^{T} := {( {s}_{1} , … , {s}_{L} )}^{T} := M \cdot {{f}^{->}}^{T} , {s}_{0} := {1}^{->} \cdot {{f}^{->}}^{T} , \\ {η}_{0. n} , ζ , {μ}_{n} {←}^{U} {𝔽}_{q} , \\ {c}_{0. n} := {( ζ , - {s}_{0} , 0 , 0 , {η}_{0. n} )}_{{𝔹}_{0}} , {c}_{T . n} := m \cdot {g}_{T}^{ζ} , \\ for i = 1 , … , L , \\ if ρ ( i ) = ( t , {{v}^{->}}_{i} ) , {θ}_{i . n} , {η}_{i . n} {←}^{U} {𝔽}_{q} , \\ {c}_{i . n} := {( \overbrace{{μ}_{n} ( n , - 1 ) ,}^{2} \overbrace{{s}_{i} {{e}^{->}}_{t , 1} + {θ}_{i . n} {{v}^{->}}_{t} ,}^{{n}_{t}} \overbrace{{0}^{{w}_{t}} ,}^{{w}_{t}} { \overbrace{{0}^{{z}_{t}} ,}^{{z}_{t}}}^{ } \overbrace{{η}_{i . n}}^{1} )}_{{𝔹}_{t}} , \\ if ρ ( i ) = ( t , {{v}^{->}}_{i} ) , {θ}_{i} , {η}_{i} {←}^{U} {𝔽}_{q} , \\ {c}_{i . n} := {( \overbrace{{μ}_{n} ( n , - 1 ) ,}^{2} \overbrace{{s}_{i} {{v}^{->}}_{t ,}}^{{n}_{t}} \overbrace{{0}^{{w}_{t}} ,}^{{w}_{t}} { \overbrace{{0}^{{z}_{t}} ,}^{{z}_{t}}}^{ } \overbrace{{η}_{i . n}}^{1} )}_{{𝔹}_{t}} , \\ return {ct}_{𝕊}^{n} := ( 𝕊 , {\{ {c}_{i . n} \}}_{i = 0 , … , L} , {c}_{T . n} , n ) . \qquad$$

With reference to FIG. 14, the process of the RKG algorithm will be described.

The process of (S401) through (S402), (S404), and (S406) is the same as in Embodiment 1.

(S403: Random Number Generation Step)

Using the processing device, the random number generation part 331 generates random numbers, as indicated in Formula 165.

$$[ Formula 165 ] \\ {r}_{n + 1} , {δ}_{n}^{ran} , {ϕ}_{0. n}^{ran} , {σ}_{n} {←}^{U} {𝔽}_{q} , \\ {{ϕ}^{->}}_{t . n}^{ran} {←}^{U} {𝔽}_{q}^{{z}_{t}} for ( t , {{x}^{->}}_{t} ) ∈ Γ \qquad$$

(S405: Decryption Key k*^{rk} Generation Step)

Using the processing device, the decryption key k*^{rk} generation part 333 generates a decryption key k*^{rk}_{0.n}, as indicated in Formula 166.

k*_{0.n}^{rk}:=(rₙ₊₁k*_{0.n}+(0, δₙ^{ran},0, φ_{0.n}^{ran}, 0) [symbol] *₀ [Formula 166]

The decryption key k*^{rk} generation part 333 also generates a decryption key k*^{rk}_{t.n} for each integer t included in the attribute set Γ, as indicated in Formula 167.

k*_{t.n}^{rk}:=(rₙ₊₁k*_{t.n}+(σₙ(1,n),δₙ^{ran}\vec{x}ₜ,0^{w}ₜ, \vec{φ}_{t.n}^{ran},0) [symbol] *ₜ)) for (t, \vec{x}ₜ)∈Γ [Formula 167]

In brief, in (S401) through (S405), the decryption device 300 generates the re-encryption key rkⁿ_{Γ,S′} by executing the RKG algorithm indicated in Formula 168. In (S406), the decryption device 300 transmits the generated re-encryption key rkⁿ_{Γ,S′} to the re-encryption device 400.

$$[ Formula 168 ] \\ RKG = ( pk , {sk}_{Γ} , n , {𝕊}^{′} ) \text{:} \\ {r}_{n + 1} , {δ}_{n}^{ran} , {ϕ}_{0. n}^{ran} {←}^{U} {𝔽}_{q} , \\ {{ϕ}^{->}}_{t . n}^{ran} {←}^{U} {𝔽}_{q}^{{z}_{t}} for ( t , {{x}^{->}}_{t} ) ∈ Γ , \\ {ct}_{{𝕊}^{′}}^{′ n + 1} := ( {𝕊}^{′} , {\{ {c}_{i . n + 1} \}}_{i = 0 , … , L} , {c}_{T . n + 1} ) {←}^{R} Enc ( pk , {E}_{n + 1} ( {r}_{n + 1} ) , \\ {𝕊}^{′} = ( {M}^{′} , {ρ}^{′} ) ) , \\ {k}_{0. n}^{* rk} := ( {r}_{n + 1} {k}_{0. n}^{*} + {( 0 , {δ}_{n}^{ran} , 0 , {ϕ}_{0. n}^{ran} , 0 )}_{{𝔹}_{0}^{*}} ) , \\ {k}_{t . n}^{* rk} := ( {r}_{n + 1} {k}_{t . n}^{*} + ( {σ}_{n} ( 1 , n ) {( {δ}_{n}^{ran} {{x}^{->}}_{t} , {0}^{{w}_{t}} , {{ϕ}^{->}}_{t . n}^{ran} , 0 )}_{{𝔹}_{t}^{*}} ) ) \\ for ( t , {{x}^{->}}_{t} ) ∈ Γ , \\ return {rk}_{Γ , {𝕊}^{′}}^{n} := ( Γ , {𝕊}^{′} , {k}_{0. n}^{* rk} , {\{ {k}_{t . n}^{* rk} \}}_{( t , {{x}^{->}}_{t} ) ∈ Γ} , {ct}_{{𝕊}^{′}}^{′ n + 1} , n ) . \qquad$$

With reference to FIG. 16, the process of the Dec1 algorithm will be described.

The process of (S601) through (S604) and (S606) through (S607) is the same as in Embodiment 1.

(S605: Pairing Operation Step)

Using the processing device, the pairing operation part 550 computes Formula 169, and thus generates a session key Kₙ.

$$[ Formula 169 ] \\ {K}_{n}^{′} = e ( {c}_{0. n} , {k}_{0.0}^{*} ) \cdot {\prod }_{i ∈ I ⋀ ρ ( i ) = ( t , {{v}^{->}}_{i} )} {e ( {c}_{i . n} , {k}_{t .0}^{*} )}^{{α}_{i}} \cdot {\prod }_{i ∈ I ⋀ ρ ( i ) = ( t , {{v}^{->}}_{i} )}^{ } {e ( {c}_{i . n} , {k}_{t .0}^{*} )}^{{α}_{i} / ( {{v}^{->}}_{i} \cdot {{x}^{->}}_{t} )} \qquad$$

In brief, in (S601) through (S607), the re-encrypted ciphertext decryption device 500 generates the message m by executing the Dec1 algorithm indicated in Formula 170.

$$[ Formula 170 ] \\ Dec 1 = ( pk , {sk}_{{Γ}^{′}} , {ct}_{{𝕊}^{′}}^{n} ) \\ If {𝕊}^{′} accepts {Γ}^{′} , then compute I and {\{ {α}_{i} \}}_{i ∈ I} such that \\ {1}^{->} = {\sum }_{i ∈ I} {α}_{i} {M}_{i}^{′} \\ where {M}_{i}^{′} is the i \text{-} th row of {M}^{′} , \\ and I ⊆ \{ i ∈ \{ 1 , … , L \} \vert [ {ρ}^{′} ( i ) = ( t , {{v}^{->}}_{i}^{′} ) ⋀ ( t , {{x}^{->}}_{t}^{′} ) ∈ {Γ}^{′} ⋀ {{v}^{->}}_{i}^{′} \cdot {{x}^{->}}_{t}^{′} = 0 ] ⋁ [ {ρ}^{′} ( i ) = ( t , {{v}^{->}}_{i}^{′} ) ⋀ ( t , {{x}^{->}}_{t}^{′} ) ∈ {Γ}^{′} ⋀ {{v}^{->}}_{i}^{′} \cdot {{x}^{->}}_{t}^{′} \neq 0 ] \} , \\ {K}_{n}^{′} = e ( {c}_{0. n} , {k}_{0.0}^{*} ) \cdot {\prod }_{i ∈ I ⋀ ρ ( i ) = ( t , {{v}^{->}}_{i} )} {e ( {c}_{i . n} , {k}_{t .0}^{*} )}^{{α}_{i}} \cdot {\prod }_{i ∈ I ⋀ ρ ( i ) = ( t , {{v}^{->}}_{i} )} {e ( {c}_{i . n} , {k}_{t .0}^{*} )}^{{α}_{i} / ( {{v}^{->}}_{i} \cdot {{x}^{->}}_{t} )} , \\ {E}_{n} ( {r}_{n} ) := {c}_{T . n} / {K}_{n}^{′} , {r}_{n} := decode ( {E}_{n} ( {r}_{n} ) ) , \\ for j = n - 1 , … , 1 , \\ {E}_{j} ( {r}_{j} ) := {c}_{T . j} / {( {K}_{j}^{′} )}^{{r}_{j + 1}} , {r}_{j} := decode ( {E}_{j} ( {r}_{j} ) ) , \\ m := {c}_{T .0} / ( {K}_{0}^{′} ) {r}_{1} , \\ return m . \qquad$$

As described above, in the cryptographic system 10 according to Embodiment 2, index μₙ(n, −1) is set in the leading two basis vectors of the ciphertext c_{i.0} and index σₙ(1, n) is embedded in the leading two basis vectors of the decryption key k*^{rk}_{t.n}. This makes it possible to perform re-encryption using the same bases without using different bases each time re-encryption is performed.

As a result, the need to set the upper limit value of the number of re-encryption times is eliminated, and the size of the public parameter can be fixed, not depending on the upper limit value of the number of re-encryption times.

For the portions where the indices are set, it is required that 0 be obtained as a result of an inner-product operation of these portions. Therefore, although the indices are set in two dimensions in the leading two vectors in the above description, this is not limiting and indices may be set in three or higher dimensions. The values to be set as indices are not limited to those described above and may be different values.

### Embodiment 3

The CP-FPRE scheme has been described in Embodiment 1. In Embodiment 3, a key-policy FPRE scheme (KP-FPRE) scheme will be described.

In Embodiment 3, description will be omitted for portions that are the same as in Embodiment 1, and portions that are different from Embodiment 1 will be described.

First, a basic structure of the KP-FPRE scheme will be described. Then, a basic configuration of a cryptographic system 10 that implements the KP-FPRE scheme will be described. Then, the KP-FPRE scheme and the cryptographic system 10 according to this embodiment will be described in detail.

The structure of the KP-FPRE scheme will be briefly described. KP (key policy) means that a policy, namely an access structure, is embedded in a key.

<1-1. Basic Structure of KP-FPRE Scheme>

The KP-FPRE scheme includes seven algorithms: Setup, KG, Enc, RKG, REnc, Dec1 , and Dec2.

(Setup)

A Setup algorithm is a probabilistic algorithm that takes as input a security parameter λ, an attribute format n^{→}:=(d; n₁, . . . , n_{d}; w₁, . . . , w_{d}; z₁, . . . , z_{d}), and a value Q indicating an upper limit value of the number of re-encryption times, and outputs a public parameter pk and a master key sk.

(KG)

A KG algorithm is a probabilistic algorithm that takes as input an access structure S=(M, ρ), the public parameter pk, and the master key sk, and outputs a decryption key skₛ.

(Enc)

An Enc algorithm is a probabilistic algorithm that takes as input a message m, an attribute set Γ:={(t, x^{→}ₜ)|x^{→}ₜ∈F_{q}^{nt}, 1≦t≦d}, and the public parameter pk, and outputs a ciphertext ctⁿ_{Γ}.

(RKG)

An RKG algorithm is a probabilistic algorithm that takes as input the decryption key sk_{S}, an attribute set Γ′:={(t, x′^{→}ₜ)|x′^{→}ₜ∈F_{q}^{nt}, 1≦t≦d}, and the public parameter pk, and output a re-encryption key rkⁿ_{S,Γ′}.

(REnc)

An REnc algorithm is a probabilistic algorithm that takes as input the ciphertext ctⁿ_{Γ}, the re-encryption key rkⁿ_{S,Γ′}, and the public parameter pk, and outputs a re-encrypted ciphertext ctⁿ⁺¹_{Γ′}.

(Dec1 )

A Dec1 algorithm is an algorithm that takes as input a re-encrypted ciphertext ctⁿ_{Γ′}, a decryption key sk_{S′}, and the public parameter pk, and outputs the message m or a distinguished symbol ⊥.

(Dec2)

A Dec2 algorithm is an algorithm that takes as input a ciphertext ctⁿ_{Γ} (ct⁰_{Γ}), the decryption key sk_{S}, and the public parameter pk, and outputs the message m or a distinguished symbol ⊥.

<1-2. Cryptographic System 10>

The cryptographic system 10 that executes the algorithms of the KP-FPRE scheme will be described.

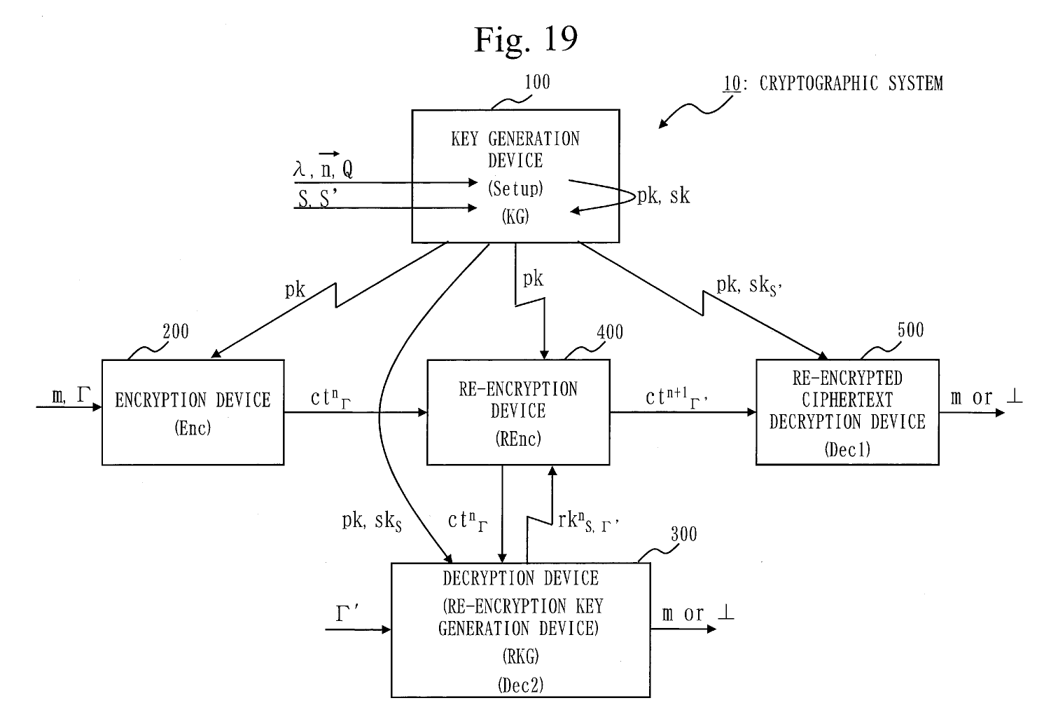

FIG. 19 is a configuration diagram of the cryptographic system 10 that implements the KP-FPRE scheme.

Like the cryptographic system 10 illustrated in FIG. 5, the cryptographic system 10 includes a key generation device 100, an encryption device 200, a decryption device 300 (re-encryption key generation device), a re-encryption device 400, and a re-encrypted ciphertext decryption device 500 (re-encryption key generation device).

The key generation device 100 executes the Setup algorithm taking as input a security parameter λ, an attribute format n^{→}:=(d; n₁, . . . , n_{d}; w₁, . . . , w_{d}; z₁, . . . , z_{d}), and a value Q, and thus generates a public parameter pk and a master key sk.

Then, the key generation device 100 publishes the public parameter pk. The key generation device 100 also executes the KG algorithm taking as input an access structure S, and thus generates a decryption key sk_{S}, and transmits the decryption key sk_{S} to the decryption device 300 in secrecy. The key generation device 100 also executes the KG algorithm taking as input an access structure S′, and thus generates a decryption key sk_{S′}, and transmits the decryption key sk_{S′} to the re-encrypted ciphertext decryption device 500 in secrecy.

The encryption device 200 executes the Enc algorithm taking as input a message m, an attribute set Γ, and the public parameter pk, and thus generates a ciphertext ctⁿ_{Γ}. The encryption device 200 transmits the ciphertext ctⁿ_{Γ} to the re-encryption device 400.

The decryption device 300 executes the RKG algorithm taking as input the public parameter pk, the decryption key sk_{S}, an attribute set Γ′, and a value n, and thus generates a re-encryption key rkⁿ_{S,Γ′}. The decryption device 300 transmits the re-encryption key rkⁿ_{S,Γ′} to the re-encryption device 400 in secrecy.

The decryption device 300 also executes the Dec2 algorithm taking as input the public parameter pk, the decryption key sk_{S}, and the ciphertext ctⁿ_{Γ} (ct⁰_{Γ}), and outputs the message m or a distinguished symbol ⊥.

The re-encryption device 400 executes the REnc algorithm taking as input the public parameter pk, the re-encryption key rkⁿ_{S,Γ′}, and the ciphertext ctⁿ_{Γ}, and thus generates a re-encrypted ciphertext ctⁿ⁺¹_{Γ′}. The re-encryption device 400 transmits the re-encrypted ciphertext ctⁿ⁺¹_{Γ′} to the re-encrypted ciphertext decryption device 500.

The re-encrypted ciphertext decryption device 500 executes the Dec1 algorithm taking as input the public parameter pk, the decryption key sk_{S′}, and the re-encrypted ciphertext rctⁿ⁺¹_{Γ′}, and outputs the message m or a distinguished symbol ⊥.

<1-4. KP-FPRE Scheme and Cryptographic System 10 in Detail>

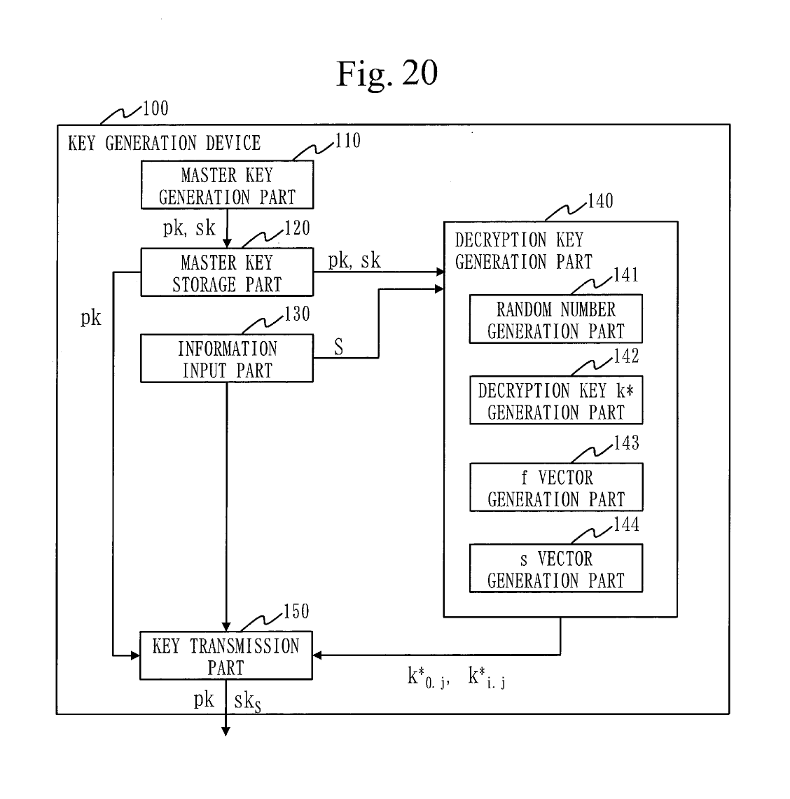

With reference to FIG. 20 through FIG. 30, the KP-FPRE scheme and the function and operation of the cryptographic system 10 that implements the KP-FPRE scheme will be described.

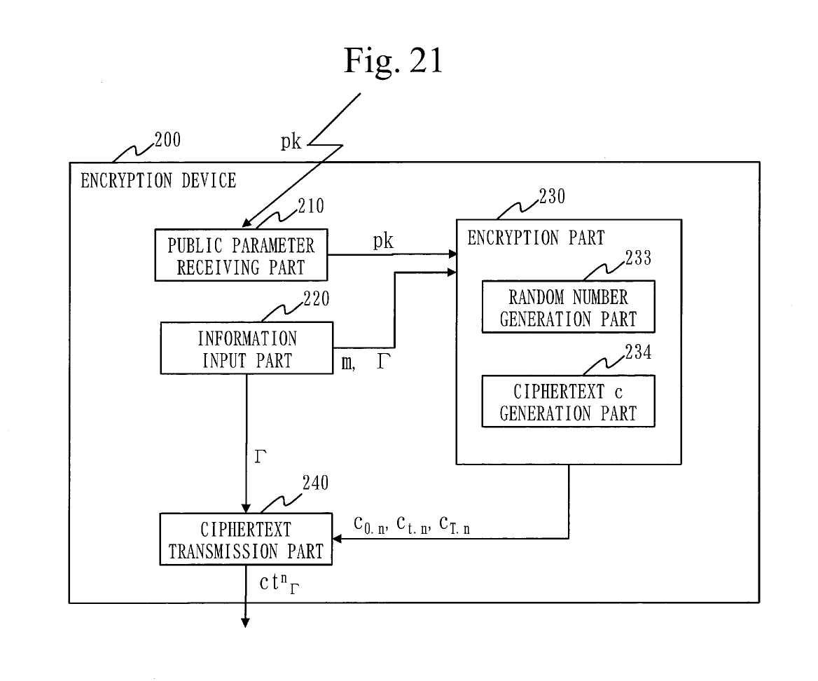

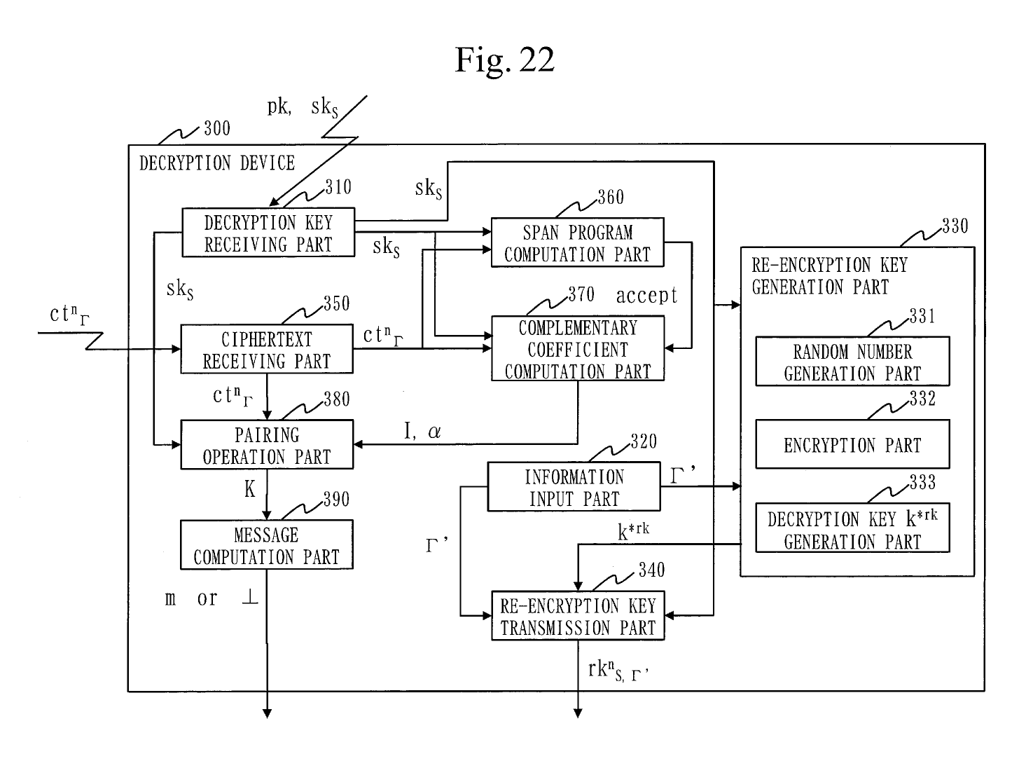

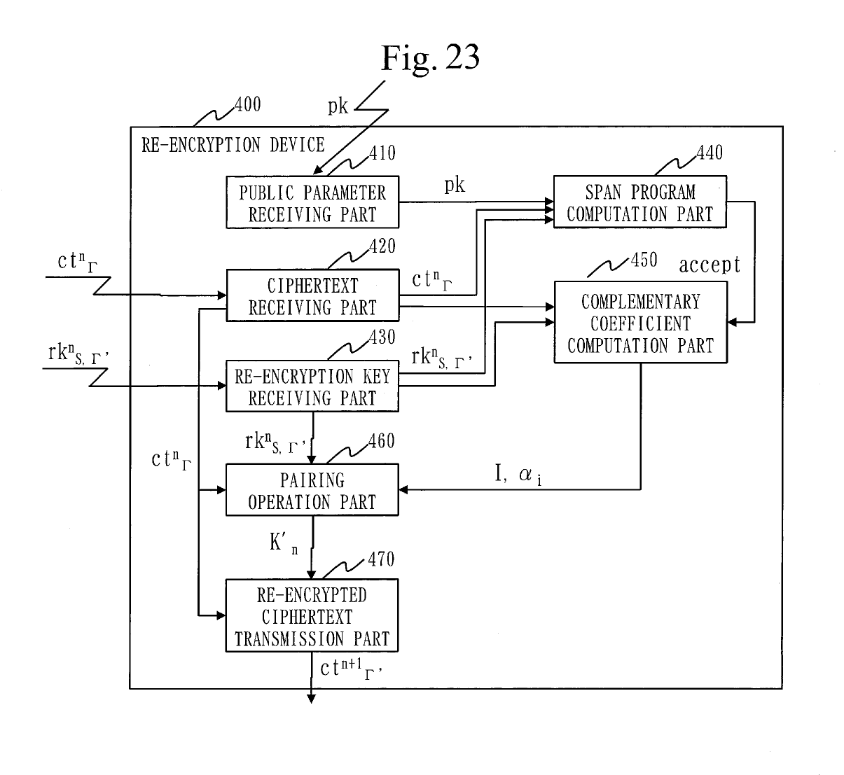

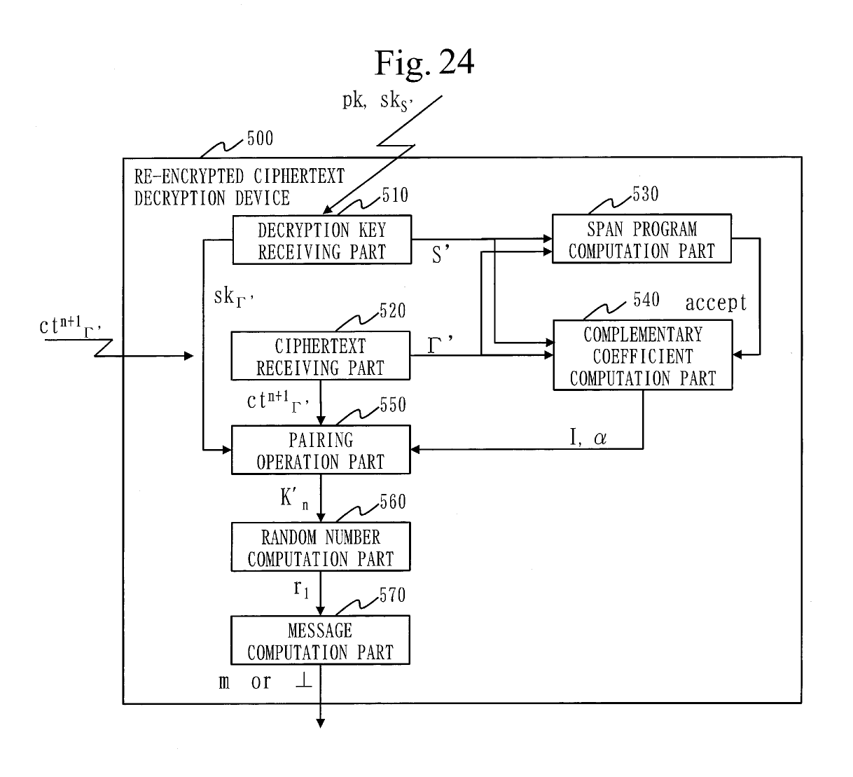

FIG. 20 is a functional block diagram illustrating the function of the key generation device 100. FIG. 21 is a functional block diagram illustrating the function of the encryption device 200. FIG. 22 is a functional block diagram illustrating the function of the decryption device 300. FIG. 23 is a functional block diagram illustrating the function of the re-encryption device 400. FIG. 24 is a functional block diagram illustrating the function of the re-encrypted ciphertext decryption device 500.

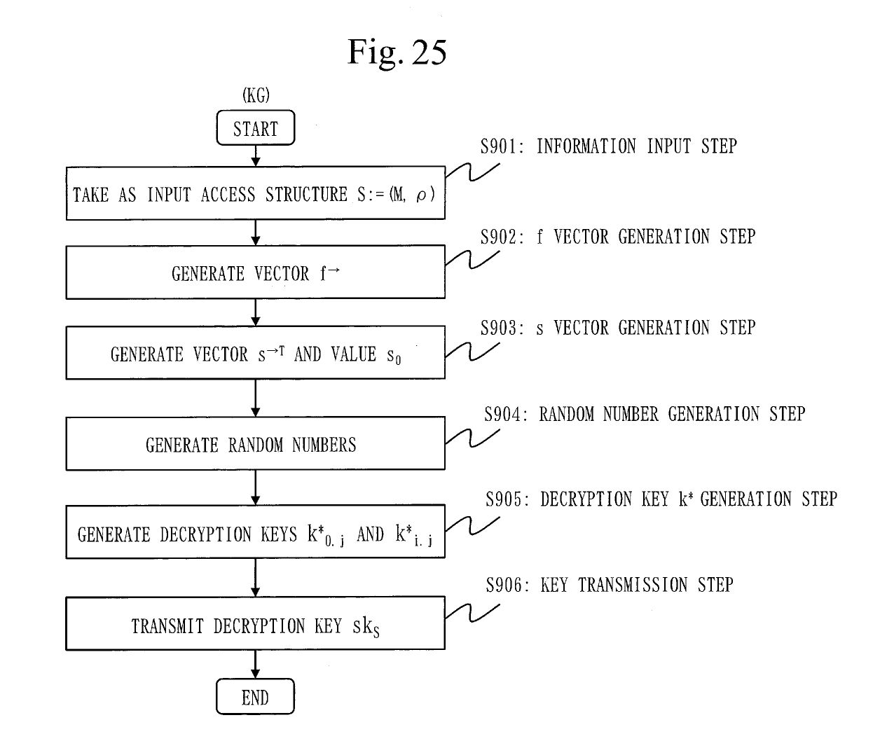

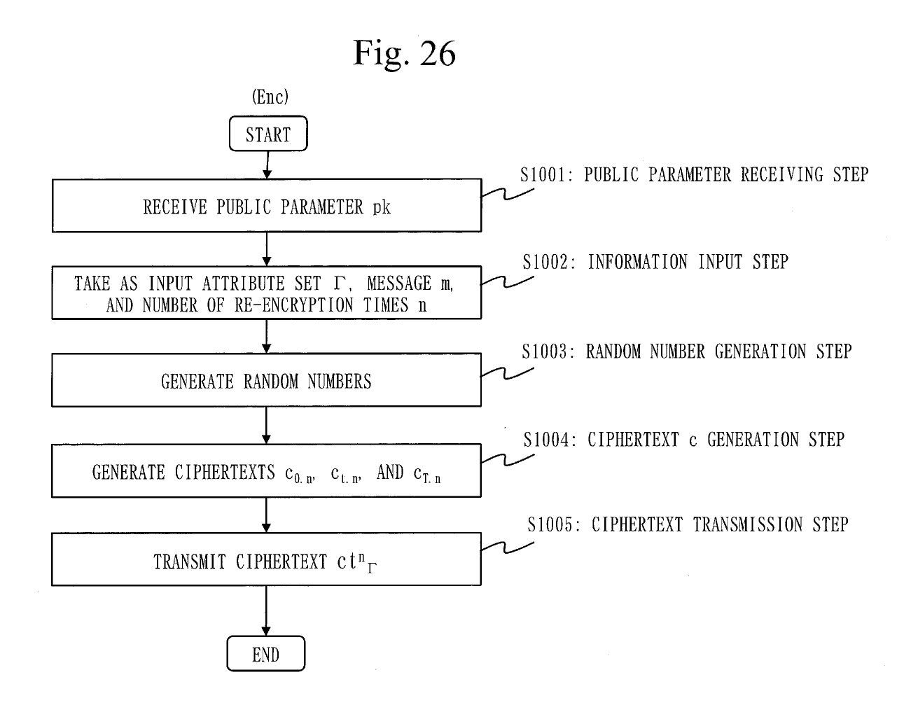

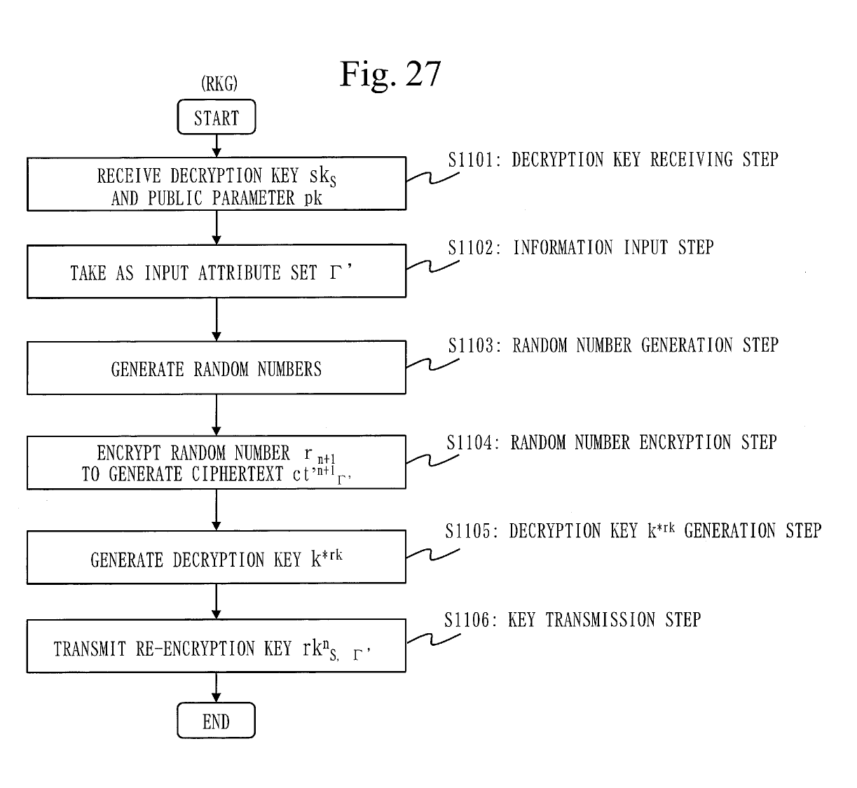

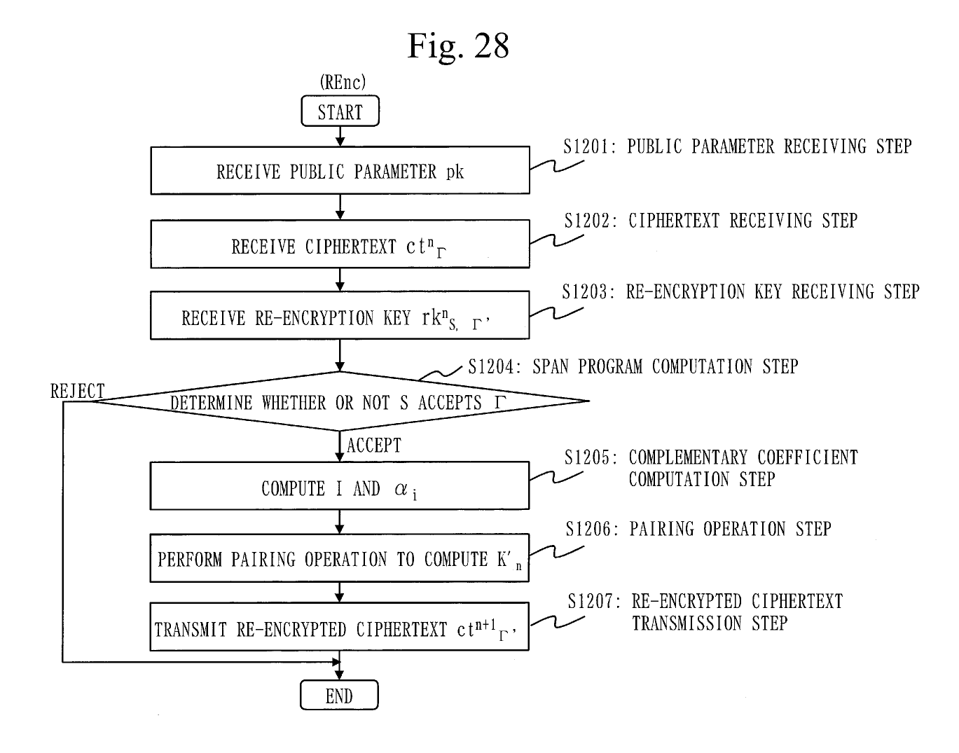

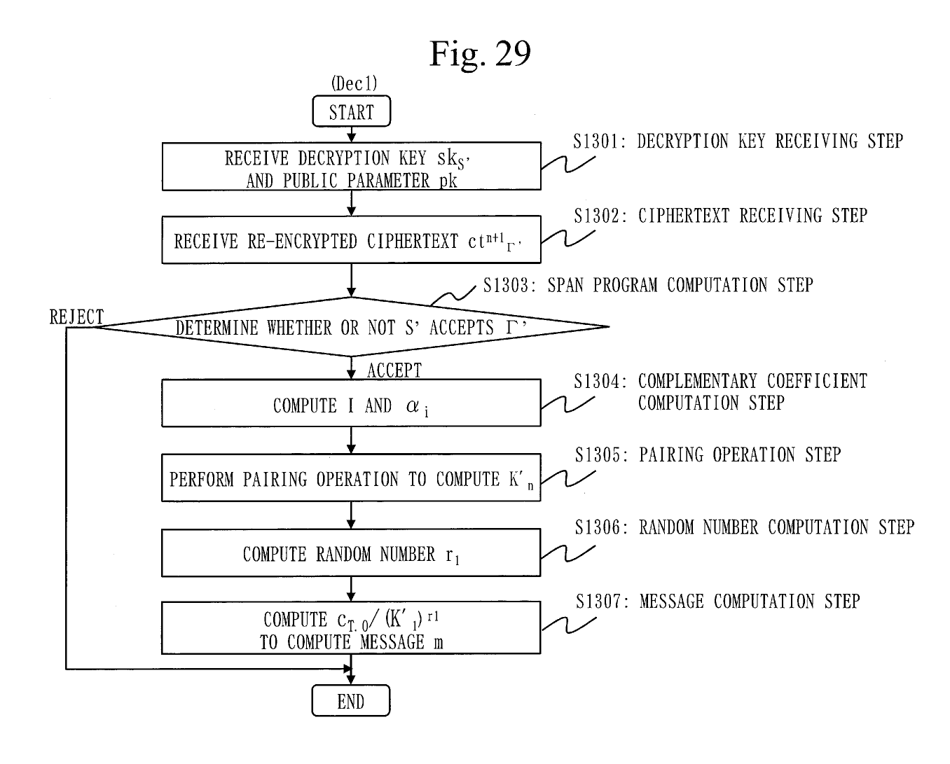

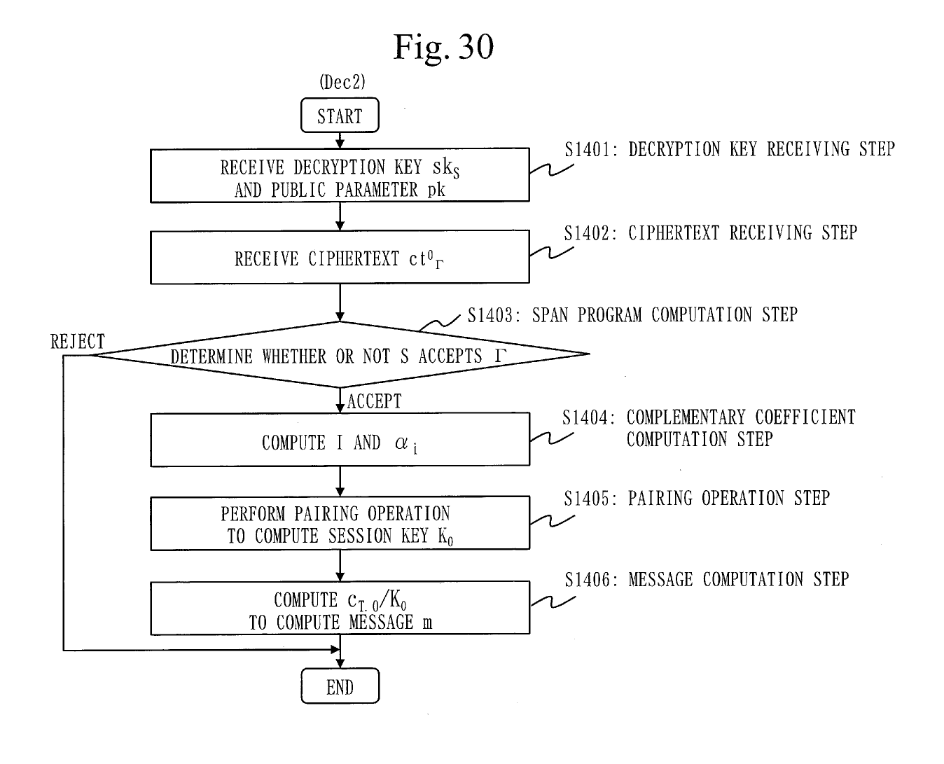

FIG. 25 is a flowchart illustrating the operation of the key generation device 100 and illustrating the process of the KG algorithm. FIG. 26 is a flowchart illustrating the operation of the encryption device 200 and illustrating the process of the Enc algorithm. FIG. 27 is a flowchart illustrating the operation of the decryption device 300 and illustrating the process of the RKG algorithm. FIG. 28 is a flowchart illustrating the operation of the re-encryption device 400 and illustrating the process of the REnc algorithm. FIG. 29 is a flowchart illustrating the operation of the re-encrypted ciphertext decryption device 500 and illustrating the process of the Dec 1 algorithm. FIG. 30 is a flowchart illustrating the operation of the decryption device 300 and illustrating the process of the Dec2 algorithm.

The function and operation of the key generation device 100 will be described.

As illustrated in FIG. 20, the key generation device 100 includes a master key generation part 110, a master key storage part 120, an information input part 130, a decryption key generation part 140, and a key transmission part 150 (key output part). The decryption key generation part 140 includes a random number generation part 141, a decryption key k* generation part 142, an f vector generation part 143, and an s vector generation part 144.

The process of the Setup algorithm is basically the same as the process of the Setup algorithm described in Embodiment 1, and thus description thereof will be omitted. However, the basis vectors included in the basis B̂₀, the basis B̂ₜ, the basis B*̂₀, and the basis B*̂ₜ are different from those in Embodiment 1.

The key generation device 100 executes the Setup algorithm indicated in Formula 171, and thus generates a public parameter pk and a master key sk.

$$[ Formula 171 ] \\ Setup ( {1}^{λ} , {n}^{->} = ( d ; {n}_{1} , … , {n}_{d} ; {w}_{1} , … , {w}_{d} ; {z}_{1} , … , {z}_{d} ) ) \text{:} \\ {param}_{𝔾} := ( q , 𝔾 , {𝔾}_{T} , g , e ) {←}^{R} {𝒢}_{bpg} ( {1}^{λ} ) , \\ {N}_{0} := 5 , {N}_{t} := {n}_{t} + {w}_{t} + {z}_{t} + 1 for t = 1 , … , d , \\ for j = 0 , … , Q , \\ {ψ}_{j} {←}^{U} {𝔽}_{q}^{\times } , {g}_{T . j} := {e ( g , g )}^{{ψ}_{j}} , \\ for t = 0 , … , d , \\ {param}_{{𝕍}_{t}} := ( q , {𝕍}_{t} , {𝔾}_{T} , {𝔸}_{t} , e ) {←}^{R} {𝒢}_{dpvs} ( {1}^{λ} , {N}_{t} , {param}_{𝔾} ) , \\ {X}_{t} = ( \begin{matrix}{{χ}^{->}}_{t , 1} \\ ⋮ \\ {{χ}^{->}}_{t , {N}_{t}}\end{matrix} ) := {( {χ}_{t , i , {j}^{′}} )}_{i , {j}^{′}} {←}^{U} GL ( {N}_{t} , {𝔽}_{q} ) , \\ ( \begin{matrix}{{v}^{->}}_{t , 1} \\ ⋮ \\ {{v}^{->}}_{t , {N}_{t}}\end{matrix} ) := {( {v}_{t , i , {j}^{′}} )}_{i , {j}^{′}} := ψ \cdot {( {X}_{t}^{T} )}^{- 1} , \\ {b}_{t . j , i} := {\sum }_{j = 1}^{{N}_{t}} {χ}_{t , i , {j}^{′}} {a}_{t , {j}^{′}} , {𝔹}_{t . j} := ( {b}_{t . j , 1} , … , {b}_{t . j , {N}_{t}} ) , , \\ {b}_{t . j , i}^{*} := {\sum }_{j = 1}^{{N}_{t}} {v}_{t , i , {j}^{′}} {a}_{t , {j}^{′}} , {𝔹}_{t . j}^{*} := ( {b}_{t . j , 1}^{*} , … , {b}_{t . j , {N}_{t}}^{*} ) , \\ {param}_{{n}^{->} . j} := ( {g}_{T . j} , {\{ {param}_{{𝕍}_{t}} \}}_{t = 0 , … , d} ) , \\ {\hat{𝔹}}_{0. j} := ( {b}_{0. j , 1} , {b}_{0. j , 2} , {b}_{0. j , 4} ) , \\ {\hat{𝔹}}_{t . j} := ( {b}_{t . j , 1} , … , {b}_{t . j , {n}_{t}} , {b}_{t . j , {n}_{t} + {w}_{t} + 1} , … , {b}_{t . j , {n}_{t} + {w}_{t} + {z}_{t}} ) \\ for t = 1 , … , d , \\ {\hat{𝔹}}_{0. j}^{*} := ( {b}_{0. j , 2}^{*} , {b}_{0. j , 5}^{*} ) , \\ {\hat{𝔹}}_{t . j}^{*} := ( {b}_{t . j , 1}^{*} , … , {b}_{t . j , {n}_{t}}^{*} , {b}_{t . j , {N}_{t}}^{*} ) \\ for t = 1 , … , d , \\ return pk ( {1}^{λ} , {\{ {param}_{{n}^{->} . j} \}}_{j = 0 , … , Q} , {\{ {\hat{𝔹}}_{t . j} , {\hat{𝔹}}_{t . j}^{*} \}}_{t = 0 , … , d ; j = 0 , … , Q} ) , \\ sk = ( {\{ {b}_{0. j , 1}^{*} \}}_{j = 0 , … , Q} ) . \qquad$$

With reference to FIG. 25, the process of the KG algorithm will be described.

(S901: Information Input Step)

Using the input device, the information input part 130 takes as input an access structure S:=(M, ρ). The matrix M of the access structure S is to be set according to the conditions of a system to be implemented. Attribute information of a user of a decryption key sk_{S} is set in ρ of the access structure S, for example. Note that p(i)=(t, v^{→}ᵢ:=(v_{i,1}, . . . , v_{i.nt})∈F_{q}^{nt}\{0^{→}})(v_{i,nt}≠0).

(S902: f Vector Generation Step)

Using the processing device, the f vector generation part 143 generates a vector f^{→}, as indicated in Formula 172.

$$\vec{f} {}^{ U} {𝔽}_{q}^{r} \qquad [ Formula 172 ]$$

(S903: s Vector Generation Step)

Using the processing device, the s vector generation part 144 generates a vector s^{→T}:=(s₁, . . . , S_{L})^{T}, as indicated in Formula 173.

\vec{s}^{T}:=(s₁, . . . , s_{L})^{T}:=M·f^{T} [Formula 173]

Using the processing device, the s vector generation part 144 also generates a value s₀, as indicated in Formula 174.

s₀:=\vec{1}·\vec{f}T [Formula 174]

(S904: Random Number Generation Step)

Using the processing device, the random number generation part 141 generates random numbers, as indicated in Formula 175.

$$[ Formula 175 ] \\ {η}_{0. j} {←}^{U} {𝔽}_{q} , j = 0 , … , Q , \\ {θ}_{i} , {η}_{i . j} {←}^{U} {𝔽}_{q} for i = 1 , … , L ; j = 0 , … , Q , \qquad$$

(S905: Decryption Key k* Generation Step)

Using the processing device, the decryption key k* generation part 142 generates a decryption key k*_{0.j} for each integer j=0, . . . , Q, as indicated in Formula 176.

k*_{0.j}:=(1, −s₀, 0, 0, η_{0.j}) [symbol] *_{0.j} for j=0, . . . , Q [Formula 176]

Using the processing device, the decryption key k* generation part 142 also generates a decryption key k*_{i.j} for each integer i=1, . . . , L and each integer j=0, . . . Q, as indicated in Formula 177.

$$for i = 1 , … , L ; j = 0 , … , Q , \\ if ρ ( i ) = ( t , {\vec{v}}_{i} ) , \\ {k}_{i . j}^{*} := {( \overbrace{{s}_{i} {\vec{e}}_{t , 1} + {θ}_{i} {\vec{v}}_{t} ,}^{{n}_{t}} \overbrace{{0}^{{w}_{t}} ,}^{{w}_{t}} \overbrace{{0}^{{z}_{t}} ,}^{{z}_{t}} \overbrace{{η}_{i . j}}^{1} )}_{{𝔹}_{t . j}^{*}} , \\ if ρ ( i ) = ( t , {\vec{v}}_{i} ) , \\ {k}_{i . j}^{*} := {( \overbrace{{s}_{i} {\vec{v}}_{t} ,}^{{n}_{t}} \overbrace{{0}^{{w}_{t}} ,}^{{w}_{t}} \overbrace{{0}^{{z}_{t}} ,}^{{z}_{t}} \overbrace{{η}_{i . j}}^{1} )}_{{𝔹}_{t . j}^{*}} \qquad [ Formula 177 ]$$

(S906: Key Transmission Step)

Using the communication device and via the network, for example, the key transmission part 150 transmits the decryption key sk_{S} having, as elements, the access structure S and the decryption keys k*_{0.j} and k*_{i.j} to the decryption device 300 in secrecy. As a matter of course, the decryption key sk_{S} may be transmitted to the decryption device 300 by another method.

In brief, in (S901) through (S905), the key generation device 100 generates the decryption key sk_{S} by executing the KG algorithm indicated in Formula 178. In (S906), the key generation device 100 transmits the generated decryption key sk_{S} to the decryption device 300.

$$KG = ( p k , sk , 𝕊 = ( M , ρ ) ) \text{:} \\ \vec{f} {}^{U} {𝔽}_{q}^{r} , \\ {\vec{s}}^{T} := {( {s}_{1} , … , {s}_{L} )}^{T} := M \cdot {\vec{f}}^{T} , {s}_{0} := \vec{1} \cdot {\vec{f}}^{T} , \\ for j = 0 , … , Q \\ {η}_{0. j} {}^{U} {𝔽}_{q} , \\ {k}_{0. j}^{*} := {( 1 , - {s}_{0} , 0 , 0 , {η}_{0. j} )}_{{𝔹}_{0 ds . j}^{*}} , \\ for i = 1 , … , L , \\ if ρ ( i ) = ( t , {\vec{v}}_{i} ) , {θ}_{i} , {η}_{i . j} {}^{U} {𝔽}_{q} , \\ {k}_{i . j}^{*} := {( \overbrace{{s}_{i} {\vec{e}}_{t , 1} + {θ}_{i} {\vec{v}}_{t} ,}^{{n}_{t}} \overbrace{{0}^{{w}_{t}} ,}^{{w}_{t}} \overbrace{{0}^{{z}_{t}} ,}^{{z}_{t}} \overbrace{{η}_{i . j}}^{1} )}_{{𝔹}_{t . j}^{*}} , \\ if ρ ( i ) = ( t , {\vec{v}}_{i} ) , {θ}_{i} , {η}_{i . j} {}^{U} {𝔽}_{q} , \\ {k}_{i . j}^{*} := {( \overbrace{{s}_{i} {\vec{v}}_{t} ,}^{{n}_{t}} \overbrace{{0}^{{w}_{t}} ,}^{{w}_{t}} \overbrace{{0}^{{z}_{t}} ,}^{{z}_{t}} \overbrace{{η}_{i . j}}^{1} )}_{{𝔹}_{t . j}^{*}} , \\ return {sk}_{Γ} := ( 𝕊 , \{ {k}_{i . j}^{*} \} i = 0 , … , L ; j = 0 , … , Q ) . \qquad [ Formula 178 ]$$

In (S901), the key generation device 100 generates a decryption key sk_{S′} by executing the KG algorithm taking as input an access structure S′:=(M′, ρ′) in which attribute information of a user of the decryption key sk_{S′} is set. Then, the decryption key sk_{S′}:=(S′, k′*₀, k′*ᵢ) is transmitted to the re-encrypted ciphertext decryption device 500. Note that ρ′(i)=(t, v^{→}′ᵢ:=(v′_{i.1}, . . . , v ′_{i.nt} \{0^{→}})(v′_{i,nt}≠0).

The function and operation of the encryption device 200 will be described.

As illustrated in FIG. 21, the encryption device 200 includes a public parameter receiving part 210, an information input part 220, an encryption part 230, and a ciphertext transmission part 240 (ciphertext output part). The encryption part 230 includes a random number generation part 233 and a ciphertext c generation part 234.

With reference to FIG. 26, the process of the Enc algorithm will be described.

(S1001: Public Parameter Receiving Step)

Using the communication device and via the network, for example, the public parameter receiving part 210 receives the public parameter pk generated by the key generation device 100.

(S1002: Information Input Step)

Using the input device, the information input part 220 takes as input an attribute set Γ:={(t, x^{→}ₜ:=(x_{t.1}, . . . , x_{t.nt}∈Fq^{nt}))|1≦t≦d}. Note that t may be at least some of integers from 1 to d, instead of being all of integers from 1 to d. Attribute information of a user capable of decryption is set in the attribute set Γ, for example.

Using the input device, the information input part 220 also takes as input a message m to be transmitted to the decryption device 300.

Using the input device, the information input part 220 also takes as input the number of re-encryption times n. The number of re-encryption times n to be input here is normally 0, and takes a value specified in the RKG algorithm when the Enc algorithm is invoked in the RKG algorithm to be described later.

(S1003: Random Number Generation Step)

Using the processing device, the random number generation part 233 generates random numbers, as indicated in Formula 179.

$$ζ , {δ}_{0} , {ϕ}_{0. n} {}^{U} {𝔽}_{q} , \\ {\vec{ϕ}}_{t . n} {}^{U} {𝔽}_{q}^{{z}_{t}} , for ( t , {\vec{x}}_{t} ) ∈ Γ \qquad [ Formula 179 ]$$

(S1004: Ciphertext c Generation Step)

Using the processing device, the ciphertext c generation part 234 generates a ciphertext c_{0.n}, as indicated in Formula 180.

c_{0.n}:=(ζ, δ₀, 0, φ_{0.n}, 0) [symbol] _{0.n} [Formula 180]

Using the processing device, the ciphertext c generation part 234 also generates a ciphertext c_{t.n} for each integer t included in the attribute information Γ, as indicated in Formula 181.

$${c}_{t . n} := {( \overbrace{{δ}_{0} {\vec{x}}_{t} ,}^{{n}_{t}} \overbrace{{0}^{{w}_{t}} ,}^{{w}_{t}} \overbrace{{0}^{{z}_{t}} ,}^{{z}_{t}} \overbrace{0}^{1} )}_{{𝔹}_{t . n}} for ( t , {\vec{x}}_{t} ) , ∈ Γ \qquad [ Formula 181 ]$$

Using the processing device, the ciphertext c generation part 234 also generates a ciphertext c_{T.n}, as indicated in Formula 182.

c_{T.n}:=m·g_{T.n}^{ζ} [Formula 182]

(S1005: Ciphertext Transmission Step)

Using the communication device and via the network, for example, the ciphertext transmission part 240 transmits a ciphertext ctⁿ_{Γ} having, as elements, the attribute set Γ and the ciphertexts c_{0.n}, c_{t.n}, and c_{T.n} to the decryption device 300. As a matter of course, the ciphertext ctⁿ₁may be transmitted to the decryption device 300 by another method.

In brief, in (S1001) through (S1004), the encryption device 200 generates the ciphertext ctⁿ_{Γ} by executing the Enc algorithm indicated in Formula 183. In (S1005), the encryption device 200 transmits the generated ciphertext ctⁿ_{Γ} to the decryption device 300.

$$[ Formula 183 ]$$

$$Enc = ( p k , m , Γ = ( \{ t , {\vec{x}}_{t} ) \vert {\vec{x}}_{t} ∈ {𝔽}_{q}^{{n}_{t}} \backslash \{ \vec{0} \} , 1 \leq t \leq d \} , n ) \text{:}$$

$$ζ , {δ}_{0} , {ϕ}_{0. n} {}^{U} {𝔽}_{q} , \\ {\vec{ϕ}}_{t . n} {}^{U} {𝔽}_{q}^{{z}_{t}} , for ( t , {\vec{x}}_{t} ) ∈ Γ , \\ {c}_{0. n} := {( ζ , {δ}_{0} , 0 , {ϕ}_{0. n} , 0 )}_{{𝔹}_{0. n}} , {c}_{T . n} := m \cdot {g}_{T . n}^{ζ} , \\ {c}_{t . n} := {( \overbrace{{δ}_{0} {\vec{x}}_{t} ,}^{{n}_{t}} \overbrace{{0}^{{w}_{t}} ,}^{{w}_{t}} \overbrace{{\vec{ϕ}}_{t . n} ,}^{{z}_{t}} \overbrace{0}^{1} )}_{{𝔹}_{t . n}} for ( t , {\vec{x}}_{t} ) , ∈ Γ , \\ return {ct}_{Γ}^{n} := ( Γ , {c}_{0. n} , {\{ {c}_{t . n} \}}_{( t , {\vec{x}}_{t} ) , ∈ Γ} , {c}_{T . n} , n ) .$$

The function and operation of the decryption device 300 will be described.

As illustrated in FIG. 22, the decryption device 300 includes a decryption key receiving part 310, an information input part 320, a re-encryption key generation part 330, a re-encryption key transmission part 340 (re-encryption key output part), a ciphertext receiving part 350, a span program computation part 360, a complementary coefficient computation part 370, a pairing operation part 380, and a message computation part 390. The re-encryption key generation part 330 includes a random number generation part 331, an encryption part 332, and a decryption key k*^{rk} generation part 333.

With reference to FIG. 27, the process of RKG algorithm will now be described. The Dec2 algorithm will be described later.

(S1101: Decryption Key Receiving Step)

Using the communication device and via the network, for example, the decryption key receiving part 310 receives the decryption key sk_{S} transmitted by the key generation device 100. The decryption key receiving part 310 also receives the public parameter pk generated by the key generation device 100.

(S1102: Information Input Step)

Using the input device, the information input part 320 takes as input an attribute set Γ′:={(t, x′^{→}ₜ:=(x′_{t.1}, . . . , x′_{t.nt}∈F_{q}^{nt}\{0^{→}}))|1≦t≦d}. Note that t may be at least some of integers from 1 to d, instead of being all of integers from 1 to d. Attribute information of a user who can decrypt a re-encrypted ciphertext ctⁿ⁺¹_{Γ′} is set in the attribute set Γ′, for example.

Using the input device, the information input part 320 also takes as input the number of re-encryption times n. The number of re-encryption times n to be input here indicates the number of times a ciphertext for which a re-encryption key for re-encryption is to be generated has been re-encrypted.

(S1103: Random Number Generation Step)

Using the processing device, the random number generation part 331 generates random numbers, as indicated in Formula 184.

$${r}_{n + 1} , {η}_{0. n}^{ran} {}^{U} {𝔽}_{q} , \\ {η}_{i . n}^{ran} {}^{U} {𝔽}_{q} for i = 1 , … , L \qquad [ Formula 184 ]$$

(S1104: Random Number Encryption Step)

Using the processing device, the encryption part 332 encrypts the random number rₙ₊₁ (conversion information) as indicated in Formula 185, and thus generates a ciphertext ct′ⁿ⁺¹_{Γ′}. Note that a function Eₙ₊₁ is an encode function from F_{q} to G_{T.n+1}.

$${ct}_{{Γ}^{′}}^{′ n + 1} := ( {Γ}^{′} , {c}_{0. n + 1} , {\{ {c}_{i . n + 1} \}}_{( t , {\vec{x}}_{t} ) , ∈ Γ} , {c}_{T . n + 1} ) {}^{R} Enc ( p k , {E}_{n + 1} ( {r}_{n + 1} ) , {Γ}^{′} ) \qquad [ Formula 185 ]$$

(S1105: Decryption Key k*^{rk} Generation Step)

Using the processing device, the decryption key k*^{rk} generation part 333 generates a decryption key k*^{rk}_{0.n}, as indicated in Formula 186.

k*_{0.n}^{rk}:=(rₙ₊₁k*_{0.n}+(0, 0, 0, 0, η_{0.n}^{ran}) [symbol] *_{0.n}) [Formula 186]

Using the processing device, the decryption key k*^{rk} generation part 333 also generates a decryption key k*^{rk}_{i.n} for each integer i=1, . . . , L, as indicated in Formula 187.

k*_{i.n}^{rk}:=(rₙ₊₁k*_{i.n}+(0ⁿ^{ₜ}, 0^{w}^{ₜ}, 0^{z}^{ₜ}, η_{i.n}^{ran}) [symbol] *_{i.n})) for i=1, . . . , L [Formula 187]

(S1106: Key Transmission Step)

Using the communication device and via the network, for example, the re-encryption key transmission part 340 transmits a re-encryption key rkⁿ_{SΓ′} having, as elements, the access structure S, the attribute set Γ′, the decryption keys k*^{rk}_{0.n} and k*^{rk}_{i.n}, the ciphertext ct′ⁿ⁺¹_{Γ′}, and the number of re-encryption times n (the value input in (S 1102) here) to the re-encryption device 400 in secrecy. As a matter of course, the re-encryption key rkⁿ_{S,Γ′} may be transmitted to the re-encryption device 400 by another method.

In brief, in (S1101) through (S1105), the decryption device 300 generates the re-encryption key rkⁿ_{S,Γ′} by executing the RKG algorithm indicated in Formula 188. In (S1106), the decryption device 300 transmits the generated re-encryption key rkⁿ_{S,Γ′} to the re-encryption device 400.

$$[ Formula 188 ] \\ RKG = ( p k , {sk}_{Γ} , n , {𝕊}^{′} ) \text{:} \\ {r}_{n + 1} , {η}_{0. n}^{ran} {}^{U} {𝔽}_{q} , \\ {η}_{i . n}^{ran} {}^{U} {𝔽}_{q} for i = 1 , … , L \\ {ct}_{{Γ}^{′}}^{′ n + 1} := ( {Γ}^{′} , {c}_{0. n + 1} , {\{ {c}_{i . n + 1} \}}_{( t , {\vec{x}}_{t} ) , ∈ Γ} , {c}_{T . n + 1} ) {}^{R} Enc ( p k , {E}_{n + 1} ( {r}_{n + 1} ) , {Γ}^{′} ) , \\ {k}_{0. n}^{* rk} := ( {r}_{n + 1} {k}_{0. n}^{*} + {( 0 , 0 , 0 , 0 , {η}_{0. n}^{ran} )}_{{𝔹}_{0. n}^{*}} ) , \\ {k}_{i . n}^{* rk} := ( {r}_{n + 1} {k}_{i . n}^{*} + {( {0}^{{n}_{t}} , {0}^{{w}_{t}} , {0}^{{z}_{t}} , {η}_{i . n}^{ran} )}_{{𝔹}_{i . n}^{*}} ) ) for i = 1 , … , L , \\ return {rk}_{𝕊 , {Γ}^{′}}^{n} := ( 𝕊 , {Γ}^{′} , {k}_{0. n}^{* rk} , {\{ {k}_{i . n}^{* rk} \}}_{i = 1 , … , L ,} {ct}_{{Γ}^{′}}^{′ n + 1} n ) .$$

The function and operation of the re-encryption device 400 will be described.

As illustrated in FIG. 23, the re-encryption device 400 includes a public parameter receiving part 410, a ciphertext receiving part 420, a re-encryption key receiving part 430, a span program computation part 440, a complementary coefficient computation part 450, a pairing operation part 460, and a re-encrypted ciphertext transmission part 470 (re-encrypted ciphertext output part).

With reference to FIG. 28, the process of the REnc algorithm will be described.

(S1201: Public Parameter Receiving Step)

Using the communication device and via the network, for example, the public parameter receiving part 410 receives the public parameter pk generated by the key generation device 100.

(S1202: Ciphertext Receiving Step)

Using the communication device and via the network, for example, the ciphertext receiving part 420 receives the ciphertext ctⁿ_{Γ} (ct⁰_{Γ}) transmitted by the encryption device 200.

(S1203: Re-encryption Key Receiving Step)

Using the communication device and via the network, for example, the re-encryption key receiving part 430 receives the re-encryption key rkⁿ_{S,Γ′} transmitted by the decryption device 300.

(S1204: Span Program Computation Step)

Using the processing device, the span program computation part 440 determines whether or not the access structure S included in the re-encryption key rkⁿ_{S,Γ′} accepts Γ included in the ciphertext ctⁿ_{Γ}. The method for determining whether or not the access structure S accepts Γ is as described in “3. Concept for Implementing FPRE” in Embodiment 1.

If the access structure S accepts Γ (accept in S1204), the span program computation part 440 advances the process to (S1205). If the access structure S rejects Γ (reject in S1204), the span program computation part 440 ends the process.

(S1205: Complementary Coefficient Computation Step)

Using the processing device, the complementary coefficient computation part 450 computes I and a constant (complementary coefficient) {αᵢ}_{i∈I} such that Formula 189 is satisfied.

$$\vec{1} = {\sum }_{i ∈ I} {α}_{i} {M}_{i} \qquad [ Formula 189 ]$$

where Mᵢ is the i-th row of M,
and I⊂{i∈{1, . . . , L }|[ρ(i)=(t, \vec{v}ᵢ) [symbol] (t, \vec{x}ₜ)∈Γ [symbol] \vec{v}ᵢ·\vec{x}ₜ=0] [symbol] [ρ(i)= [symbol] (t, \vec{v}ᵢ) [symbol] (t\vec{x}ₜ)∈Γ [symbol] \vec{v}ᵢ·\vec{x}ₜ≠0]}

(S1206: Pairing Operation Step)

Using the processing device, the pairing operation part 460 computes Formula 190, and thus generates a session key K′ₙ.

$${K}_{n}^{′} := e ( {c}_{0. n} , {k}_{0. n}^{* rk} ) \cdot {\prod }_{i ∈ I ⋀ ρ ( i ) = ( t , {\vec{v}}_{i} )} {e ( {c}_{t . n} , {k}_{i . n}^{* rk} )}^{{α}_{i}} \cdot {\prod }_{i ∈ I ⋀ ρ ( i ) = ( t , {\vec{v}}_{i} )} {e ( {c}_{t . n} , {k}_{i . n}^{* rk} )}^{{α}_{i} / ( {\vec{v}}_{i} \cdot {\vec{x}}_{t} )} \qquad [ Formula 190 ]$$

(S1207: Re-encrypted Ciphertext Transmission Step)

Using the communication device and via the network, for example, the re-encrypted ciphertext transmission part 470 transmits a re-encrypted ciphertext ctⁿ⁺¹_{Γ′} having, as elements, the session key K′ₙ, the ciphertext c_{T.n}, the attribute set Γ′, the ciphertext ct′ⁿ⁺¹_{Γ′}, and the number of re-encryption times n+1 (a value obtained by adding 1 to the number of re-encryption times n included in the ciphertext ctⁿ_{Γ} received in (S1202) or the number of re-encryption times n included in the re-encryption key rkⁿ_{S,Γ′} received in (S1203) here) to the re-encrypted ciphertext decryption device 500 in secrecy. As a matter of course, the re-encrypted ciphertext ctⁿ⁺¹_{Γ′} may be transmitted to the re-encrypted ciphertext decryption device 500 by another method.

The description herein assumes a case where the ciphertext ctⁿ_{Γ} output by the encryption device 200 is re-encrypted. However, it is also possible to further re-encrypt the re-encrypted ciphertext ctⁿ⁺_{Γ′} output by the re-encryption device 400.

In this case, in (S1202), the ciphertext receiving part 420 obtains the re-encrypted ciphertext ctⁿ⁺¹_{Γ′} output by the re-encryption device 400, in place of the ciphertext ct⁰_{Γ} output by the encryption device 200, as the ciphertext ctⁿ_{Γ}. The ciphertext ctⁿ⁺¹_{Γ′} includes the attribute set Γ′ as an element. For descriptive purposes, the attribute set Γ′ is read as the attribute set Γ. In the ciphertext ctⁿ⁺¹_{Γ′}, the number of re-encryption times is n+1. For descriptive purposes, the number of re-encryption times is read as n.

Then, in (S1207), the re-encrypted ciphertext transmission part 470 transmits the re-encrypted ciphertext ctⁿ⁺¹_{Γ′} having, as elements, the above-described elements and also the elements included in the ciphertext ctⁿ_{Γ} obtained in (S1202) (the session key {K′ⱼ}_{j=1, . . . , n} and the ciphertext {c_{T.j}}_{j=0, . . . , n-1}) to the re-encrypted ciphertext decryption device 500.

The rest of the process is as described above.

In brief, in (S1201) through (S1206), the re-encryption device 400 generates the re-encrypted ciphertext ctⁿ⁺¹_{Γ′} by executing the REnc algorithm indicated in Formula 191. In (S1207), the re-encryption device 400 transmits the generated re-encrypted ciphertext ctⁿ⁺¹_{Γ′} to the re-encrypted ciphertext decryption device 500.

$$[ Formula 191 ]$$

$$REnc = ( p k , {rk}_{𝕊 , {Γ}^{′}}^{n} , {ct}_{Γ}^{n} )$$

$$If 𝕊 accepts Γ , then compute I and {\{ {α}_{i} \}}_{i ∈ I} such that$$

$$\vec{1} = {\sum }_{i ∈ I} {α}_{i} {M}_{i}$$

$$where {M}_{i} is the i \text{-} th row of M , \\ and I ⊆ \{ i ∈ \{ 1 , … , L \} \vert [ ρ ( i ) = ( t , {\vec{v}}_{i} ) ⋀ ( t , {\vec{x}}_{t} ) ∈ Γ ⋀ {\vec{v}}_{i} \cdot {\vec{x}}_{t} = 0 ] ⋁ [ ρ ( i ) = ( t , {\vec{v}}_{i} ) ⋀ ( t , {\vec{x}}_{t} ) ∈ Γ ⋀ {\vec{v}}_{i} \cdot {\vec{x}}_{t} \neq 0 ] \} , \\ {K}_{n}^{′} := e ( {c}_{0. n} , {k}_{0. n}^{* rk} ) \cdot {\prod }_{i ∈ I ⋀ ρ ( i ) = ( t , {\vec{v}}_{i} )} {e ( {c}_{t . n} , {k}_{i . n}^{* rk} )}^{{α}_{i}} \cdot {\prod }_{i ∈ I ⋀ ρ ( i ) = ( t , {\vec{v}}_{i} )} {e ( {c}_{t . n} , {k}_{i . n}^{* rk} )}^{{α}_{i} / ( {\vec{v}}_{i} \cdot {\vec{x}}_{t} )} , \\ return {ct}_{{Γ}^{′}}^{n + 1} := ( {Γ}^{′} , {\{ {c}_{T . J} , {K}_{j}^{′} \}}_{j = 0 , … , n} , {ct}_{{Γ}^{′}}^{′ n + 1} , n + 1 ) .$$

If the number of re-encryption times n included in the ciphertext ctⁿ_{Γ} received in (S1202) does not coincide with the number of re-encryption times n included in the re-encryption key rkⁿ_{S,Γ′} received in (S1203), re-encryption is not possible.

The function and operation of the re-encrypted ciphertext decryption device 500 will be described.

As illustrated in FIG. 24, the re-encrypted ciphertext decryption device 500 includes a decryption key receiving part 510, a ciphertext receiving part 520, a span program computation part 530, a complementary coefficient computation part 540, a pairing operation part 550, a random number computation part 560, and a message computation part 570.

With reference to FIG. 29, the process of the Dec1 algorithm will be described.

(S1301: Decryption Key Receiving Step)

Using the communication device and via the network, for example, the decryption key receiving part 510 receives the decryption key sk_{S,′} transmitted by the key generation device 100. The decryption key receiving part 310 also receives the public parameter pk generated by the key generation device 100.

(S1302: Ciphertext Receiving Step)

Using the communication device and via the network, for example, the ciphertext receiving part 520 receives the re-encrypted ciphertext ctⁿ_{Γ′} transmitted by the re-encryption device 400.

It has been described that the REnc algorithm outputs the re-encrypted ciphertext ctⁿ⁺¹_{Γ′}. However, it is represented here by being changed to the re-encrypted ciphertext ctⁿ_{Γ′}.

(S1303: Span Program Computation Step)

Using the processing device, the span program computation part 530 determines whether or not the access structure S′ included in the decryption key sk_{S′} accepts Γ′ included in the re-encrypted ciphertext ctⁿ_{Γ′}. The method for determining whether or not the access structure S′ accepts Γ′ is as described in “3. Concept for Implementing FPRE” in Embodiment 1.

If the access structure S′ accepts Γ′ (accept in S1303), the span program computation part 530 advances the process to (S1304). If the access structure S′ rejects Γ′ (reject in S1303), the span program computation part 530 ends the process.

(S1304: Complementary Coefficient Computation Step)

Using the processing device, the complementary coefficient computation part 540 computes I and a constant (complementary coefficient) {αᵢ}_{i∈I} such that Formula 192 is satisfied.

$$\vec{1} = {\sum }_{i ∈ I} {α}_{i} {M}_{i}^{′} \qquad [ Formula 192 ]$$

where M′ᵢ is the i-th row of M′,
and I⊂{i∈{1, . . . , L}|[ρ′(i)=(t, \vec{v}′ᵢ) [symbol] (t, \vec{x}′ₜ)∈Γ′ [symbol] \vec{v}′ᵢ·\vec{x}′ₜ=0] [symbol] [ρ′(i)= [symbol] (t, \vec{v}′ᵢ) [symbol] (t, \vec{x}′ₜ)∈Γ′ [symbol] \vec{v}′ᵢ·\vec{x}′ₜ≠0]}

(S1305: Pairing Operation Step)

Using the processing device, the pairing operation part 550 computes Formula 193, and thus generates a session key K′ₙ.

$$[ Formula 193 ]$$

$${K}_{n}^{′} := e ( {c}_{0. n} , {k}_{0. n}^{*} ) \cdot {\prod }_{i ∈ I ⋀ ρ ( i ) = ( t , {\vec{v}}_{i} )} {e ( {c}_{t . n} , {k}_{i . n}^{*} )}^{{α}_{i}} \cdot {\prod }_{i ∈ I ⋀ ρ ( i ) = ( t , {\vec{v}}_{i} )} {e ( {c}_{t . n} , {k}_{i . n}^{*} )}^{{α}_{i} / ( {\vec{v}}_{i} \cdot {\vec{x}}_{t} )}$$

The process of (S1306) through (S1307) is the same as the process of (S606) through (S607) in Embodiment 1 illustrated in FIG. 16.

In brief, in (S1301) through (S1307), the re-encrypted ciphertext decryption device 500 generates the message m by executing the Dec1 algorithm indicated in Formula 194.

$$[ Formula 194 ]$$

$$Dec 1 = ( p k , {sk}_{{𝕊}^{′}} , {ct}_{{Γ}^{′}}^{n} )$$

$$If {𝕊}^{′} accepts {Γ}^{′} , then compute I and {\{ {α}_{i} \}}_{i ∈ I} such that$$

$$\vec{1} = {\sum }_{i ∈ I} {α}_{i} {M}_{i}^{′}$$

$$where {M}_{i}^{′} is the i \text{-} th row of {M}^{′} , \\ and I ⊆ \{ i ∈ \{ 1 , … , L \} \vert [ {ρ}^{′} ( i ) = ( t , {\vec{v}}_{i}^{′} ) ⋀ ( t , {\vec{x}}_{t}^{′} ) ∈ {Γ}^{′} ⋀ {\vec{v}}_{i}^{′} \cdot {\vec{x}}_{t}^{′} = 0 ] ⋁ [ {ρ}^{′} ( i ) = ( t , {\vec{v}}_{i}^{′} ) ⋀ ( t , {\vec{x}}_{t}^{′} ) ∈ {Γ}^{′} ⋀ {\vec{v}}_{i}^{′} \cdot {\vec{x}}_{t}^{′} \neq 0 ] \} , \\ {K}_{n}^{′} := e ( {c}_{0. n} , {k}_{0. n}^{*} ) \cdot {\prod }_{i ∈ I ⋀ ρ ( i ) = ( t , {\vec{v}}_{i} )} {e ( {c}_{t . n} , {k}_{i . n}^{*} )}^{{α}_{i}} \cdot {\prod }_{i ∈ I ⋀ ρ ( i ) = ( t , {\vec{v}}_{i} )} {e ( {c}_{t . n} , {k}_{i . n}^{*} )}^{{α}_{i} / ( {\vec{v}}_{i} \cdot {\vec{x}}_{t} )} , \\ {E}_{n} ( {r}_{n} ) := {c}_{T . n} / {K}_{n}^{′} , {r}_{n} := decode ( {E}_{n} ( {r}_{n} ) ) , \\ for j = n - 1 , … , 1 , \\ {E}_{j} ( {r}_{j} ) := {c}_{T . j} / {( {K}_{j}^{′} ) }^{{r}_{j + 1}} , {r}_{j} := decode ( {E}_{j} ( {r}_{j} ) ) , \\ m := {c}_{T .0} / {( {K}_{0}^{′} )}^{{r}_{1}} , \\ return m .$$

With reference to FIG. 30, the process of the Dec2 algorithm will be described.

(S1401: Decryption Key Receiving Step)

Using the communication device and via the network, for example, the decryption key receiving part 310 receives the decryption key sk_{S} transmitted by the key generation device 100. The decryption key receiving part 310 also receives the public parameter pk generated by the key generation device 100.

(S1402: Ciphertext Receiving Step)

Using the communication device and via the network, for example, the ciphertext receiving part 350 receives the ciphertext ct⁰_{Γ} transmitted by the re-encryption device 400.

(S1403: Span Program Computation Step)

Using the processing device, the span program computation part 360 determines whether or not the access structure S included in the decryption key sk_{S} accepts Γ included in the ciphertext ct_{Γ}. The method for determining whether or not the access structure S accepts Γ is as described in “3. Concept for Implementing FPRE” in Embodiment 1.

If the access structure S accepts Γ (accept in S1403), the span program computation part 360 advances the process to (S1404). If the access structure S rejects Γ (reject in S1403), the span program computation part 360 ends the process.

(S1404: Complementary Coefficient Computation Step)

Using the processing device, the complementary coefficient computation part 370 computes I and a constant (complementary coefficient) {αᵢ}_{i∈I} such that Formula 195 is satisfied.

$$\vec{1} = {\sum }_{i ∈ I} {α}_{i} {M}_{i} \qquad [ Formula 195 ]$$

where Mᵢ is the i-th row of M,
and I⊂{i∈{1, . . . , L}|[ρ(i)=(t, \vec{v}ᵢ) [symbol] (t, \vec{x}ₜ)∈Γ [symbol] \vec{v}ᵢ·\vec{x}ₜ=0] [symbol] [ρ(i)= [symbol] (t, \vec{v}ᵢ) [symbol] (t, \vec{x}ₜ)∈Γ [symbol] \vec{v}ᵢ·\vec{x}ₜ≠0]}

(S1405: Pairing Operation Step)

Using the processing device, the pairing operation part 380 computes Formula 196, and thus generates a session key K₀.

$${K}_{0}^{′} := e ( {c}_{0 \cdot 0} , {k}_{0 \cdot 0}^{*} ) \cdot {\prod }_{i ∈ I ⋀ ρ ( i ) = ( t , {\vec{v}}_{i} )} e ( {c}_{t \cdot 0} , {k}_{i \cdot 0}^{*} ) {α}_{i} \cdot {\prod }_{i ∈ I ⋀ ρ ( i ) = ( t , {\vec{v}}_{i} )} e ( {c}_{t \cdot 0} , {k}_{i \cdot 0}^{*} ) {α}_{i} / ( {\vec{v}}_{i} \cdot {\vec{x}}_{t} ) \qquad [ Formula 196 ]$$

(S1406: Message Computation Step)

Using the processing device, the message computation part 390 computes m=c_{T.0}/K₀, and thus generates a message m.

In brief, in (S1401) through (S1406), the decryption device 300 generates the message m by executing the Dec2 algorithm indicated in Formula 197.

$$Dec 2 = ( pk , , {ct}_{Γ}^{0} ) \\ If accepts Γ , \\ then compute I and {\{ {α}_{i} \}}_{i ∈ 1} such that \\ \vec{I} = {\sum }_{i ∈ I} {α}_{i} {M}_{i} \\ where \\ {M}_{i} is the i \text{-} th row of M , \\ and \\ I ⊆ \{ i ∈ \{ 1 , … , L \} \vert [ ρ ( i ) = ( t , {\vec{v}}_{i} ) ⋀ ( t , {\vec{x}}_{t} ) ∈ Γ ⋀ {\vec{v}}_{i} \cdot {\vec{x}}_{t} = 0 ] ⋁ [ ρ ( i ) = ( t , {\vec{v}}_{i} ) ⋀ ( t , {\vec{x}}_{t} ) ∈ Γ ⋀ {\vec{v}}_{i} \cdot {\vec{x}}_{t} \neq 0 ] \} , \\ {K}_{0} := e ( {c}_{0 \cdot 0} , {k}_{0 \cdot 0}^{*} ) \cdot {\prod }_{i ∈ I ⋀ ρ ( i ) = ( t , {\vec{v}}_{i} )} e ( {c}_{t \cdot 0} , {k}_{i \cdot 0}^{*} ) {α}_{i} \cdot {\prod }_{i ∈ I ⋀ ρ ( i ) = ( t , {\vec{v}}_{i} )} e ( {c}_{t \cdot 0} , {k}_{i \cdot 0}^{*} ) {α}_{i} / ( {\vec{v}}_{i} \cdot {\vec{x}}_{t} ) , \\ m := {c}_{T \cdot 0} / {K}_{0} , \\ return m . \qquad [ Formula 197 ]$$

As described above, the cryptographic system 10 according to Embodiment 3 implements the KP-FPRE scheme. Thus, a ciphertext can be forwarded to a set of various types of users with a single re-encryption key.

Embodiment 2 has described the scheme in which the indexing technique is applied to the CP-FPRE scheme described in Embodiment 1. Embodiment 2 realizes the CP-FPRE scheme in which the upper limit value of the number of re-encryption times is eliminated and the size of the pubic parameter is fixed not depending on the upper limit value of the number of re-encryption times.

Similarly, the indexing technique can be applied to the KP-FPRE scheme described in Embodiment 3, as indicated in Formula 198 through Formula 201. With regard to the RKG algorithm, the REnc algorithm, and the Dec2 algorithm, the content of the process is also the same as in the KP-FPRE scheme described above.

This makes it possible to implement a KP-FPRE scheme in which the upper limit value of the number of re-encryption times is eliminated and the size of the public parameter is fixed not depending on the upper limit value of the number of re-encryption times.

$$\begin{matrix}Setup ( {1}^{λ} , \vec{n} = ( d ; {n}_{1} , … , {n}_{d} ; {w}_{1} , … , {w}_{d} ; {z}_{1} , … , {z}_{d} ) ) \text{:} \\ {param}_{} := ( q , , {T}_{} , g , e , ) {}^{R} {bpg}_{} ( {1}^{λ} ) , \\ {N}_{0} := 5 , \\ {N}_{t} := 2 + {n}_{t} + {w}_{t} + {z}_{t} + 1 \\ for \\ t = 1 , … , d , \\ ψ {}^{U} {q}_{\times }^{} , \\ {g}_{T} := {e ( g , g )}^{ψ} , \\ for \\ t = 0 , … , d , \\ {param}_{{t}_{}} := ( q , {t}_{} , {T}_{} , {t}_{} , e ) {}^{R} {dpvs}_{} ( {1}^{λ} , {N}_{t} , {param}_{} ) , \\ {X}_{t} = ( \begin{matrix}{\vec{χ}}_{t , 1 } \\ ⋮ \\ {\vec{χ}}_{t , {N}_{t}}\end{matrix} ) := {( {χ}_{t , i , j} )}_{i , j} {}^{U} GL ( {N}_{t} , {q}_{} ) , \\ ( \begin{matrix}{\vec{v}}_{t , 1 } \\ ⋮ \\ {\vec{v}}_{t , {N}_{t}}\end{matrix} ) := {( {v}_{t , i , j} )}_{i , j} := ψ \cdot {( {X}_{t}^{T} )}^{- 1} , \\ {b}_{t , i} := {\sum }_{j = 1}^{{N}_{t}} {χ}_{t , i , j} {a}_{t , j} , \\ {t}_{} := ( {b}_{t , 1} , … , {b}_{t , {N}_{t}} ) , , \\ {b}_{t , i}^{*} := {\sum }_{j = 1}^{{N}_{t}} {v}_{t , i , j} {a}_{t , j} , \\ {t}_{*}^{} := ( {b}_{t , 1}^{*} , … , {b}_{t , {N}_{t}}^{*} ) , \\ {param}_{\vec{n}} := ( {g}_{T} , {\{ {param}_{t} \}}_{t = 0 , … , d} ) , \\ {{\hat{}}^{}}_{0} := ( {b}_{0 , 1} , {b}_{0 , 2} , {b}_{0 , 4} ) , \\ {{\hat{}}^{}}_{t} := ( {b}_{t , 1} , … , {b}_{t , 2 + {n}_{t}} , {b}_{t \cdot j , 2 + {n}_{t} + {w}_{t} + 1} , … , {b}_{t \cdot j , 2 + {n}_{t} + {w}_{t} + {z}_{t}} ) \\ for \\ t = 1 , … , d , \\ {0}_{*}^{} := ( {b}_{0 , 2}^{*} , {b}_{0 , 5}^{*} ) , \\ {t}_{*}^{} := ( {b}_{t , 1}^{*} , … , {b}_{t , 2 + {n}_{t}}^{*} , {b}_{t , {N}_{t}}^{*} ) \\ for \\ t = 1 , … , d , , \\ return pk = ( {1}^{λ} , {param}_{\vec{n}} {\{ {{\hat{}}^{}}_{t} , {t}_{*}^{} \}}_{t = 0 , … , d} ) , \\ sk = ( {b}_{0 , 1}^{*} ) . & [ Formula 198 ] \\ KG = ( pk , sk , = ( M , ρ ) ) \text{:} \\ \vec{f} {}^{U} {q}_{r}^{} , \\ {\vec{s}}^{T} := {( {s}_{1} , … , {s}_{L} )}^{T} := M \cdot {\vec{f}}^{T} , \\ {s}_{0} := \vec{1} \cdot {\vec{f}}^{T} , \\ {η}_{0} {}^{U} {q}_{} , \\ {k}_{0 \cdot 0}^{*} := {( 1 , - {s}_{0} , 0 , 0 , {η}_{0} )}_{{0}_{*}^{}} , \\ for \\ j = 0 , … , Q \\ for \\ i = 1 , … , L \\ if \\ ρ ( i ) = ( t , {\vec{v}}_{j} ) , \\ {μ}_{j} , {θ}_{i} , {η}_{i \cdot j} {}^{U} {q}_{} , \\ {k}_{i \cdot j} := {( \overbrace{{μ}_{j} ( j , - 1 ) ,}^{2} \overbrace{{s}_{i} {\vec{e}}_{t , 1} + {θ}_{i} {\vec{v}}_{t} ,}^{{n}_{t}} \overbrace{{0}^{{w}_{t}} ,}^{{w}_{t}} \overbrace{{0}^{{z}_{t}} ,}^{{z}_{t}} \overbrace{{η}_{i , j}}^{1} )}_{} , \\ if \\ ρ ( i ) = ( t , {\vec{v}}_{j} ) , \\ {μ}_{j} , {θ}_{i} , {η}_{i \cdot j} {}^{U} {q}_{} , \\ {k}_{i \cdot j} := {( \overbrace{{μ}_{j} ( j , - 1 ) ,}^{2} \overbrace{{s}_{i} {\vec{v}}_{t} ,}^{{n}_{t}} \overbrace{{0}^{{w}_{t}} ,}^{{w}_{t}} \overbrace{{0}^{{z}_{t}} ,}^{{z}_{t}} \overbrace{{η}_{i , j}}^{1} )}_{} , \\ return {sk}_{Γ} := ( , {\{ {k}_{i \cdot j}^{*} \}}_{i = 0 , … , L ; j = 0 , … , Q} ) . & [ Formula 199 ] \\ Enc = ( pk , m , Γ = ( \{ t , {\vec{x}}_{t} ) \vert {\vec{x}}_{t} ∈ {q}_{{n}_{t}}^{} \backslash \{ \vec{0} \} , 1 \leq t \leq d \} , n ) \text{:} \\ ζ , {δ}_{0} , {σ}_{n} , {ϕ}_{0 \cdot n} {}^{U} {q}_{} , \\ {\vec{ϕ}}_{t \cdot n} {}^{U} {q}_{{z}_{t}}^{} \\ for \\ ( t , {\vec{x}}_{t} ) ∈ Γ , \\ {c}_{0 \cdot n} := {( ζ , {δ}_{0} , 0 , {ϕ}_{0 \cdot n} )}_{{0}_{}} , \\ {c}_{T \cdot n} := m \cdot {g}_{T}^{ζ} , \\ {c}_{t \cdot n} := {( \overbrace{{σ}_{n} ( 1 , n ) ,}^{2} \overbrace{{δ}_{0} {\vec{x}}_{t} ,}^{{n}_{t}} \overbrace{{0}^{{w}_{t}} ,}^{{w}_{t}} \overbrace{{\vec{ϕ}}_{t \cdot n} ,}^{{z}_{t}} \overbrace{0}^{1} )}_{} \\ for \\ ( t , {\vec{x}}_{t} ) , ∈ Γ , \\ return \\ {ct}_{Γ}^{0} := ( Γ , {c}_{0 \cdot n} , {\{ {c}_{t \cdot n} \}}_{( t , {\vec{x}}_{t} ) , ∈ Γ} , {c}_{T \cdot n} , n ) . & [ Formula 200 ] \\ Dec 1 = ( pk , , {ct}_{Γ}^{n} ) \\ If { }^{′} accepts {Γ}^{′} , \\ then compute I and {\{ {α}_{i} \}}_{i ∈ I} such that \\ \vec{I} = {\sum }_{i ∈ I} {α}_{i} {M}_{i}^{′} \\ where \\ {M}_{i}^{′} is the i \text{-} th row of {M}^{′} , \\ and \\ I ⊆ \{ i ∈ \{ 1 , … , L \} \vert [ {ρ}^{′} ( i ) = ( t , {\vec{v}}_{i}^{′} ) ⋀ ( t , {\vec{x}}_{t}^{′} ) ∈ {Γ}^{′} ⋀ {\vec{v}}_{i}^{′} \cdot {\vec{x}}_{t}^{′} = 0 ] ⋁ [ {ρ}^{′} ( i ) = ( t , {\vec{v}}_{i}^{′} ) ⋀ ( t , {\vec{x}}_{t}^{′} ) ∈ {Γ}^{′} ⋀ {\vec{v}}_{i}^{′} \cdot {\vec{x}}_{t}^{′} \neq 0 ] \} , \\ {K}_{n}^{′} := e ( {c}_{0 \cdot n} , {k}_{0 \cdot 0}^{*} ) \cdot {\prod }_{i ∈ I ⋀ ρ ( i ) = ( t , {\vec{v}}_{i} )} e ( {c}_{t \cdot n} , {k}_{i \cdot n}^{*} ) {α}_{i} \cdot {\prod }_{i ∈ I ⋀ ρ ( i ) = ( t , {\vec{v}}_{i} )} e ( {c}_{t \cdot n} , {k}_{i \cdot n}^{*} ) {α}_{i} / ( {\vec{v}}_{i} \cdot {\vec{x}}_{t} ) , \\ {E}_{n} ( {r}_{n} ) := {c}_{T \cdot n} / {K}_{n}^{′} , \\ {r}_{n} := decode ( {E}_{n} ( {r}_{n} ) ) , \\ for \\ j = n - 1 , … , 1 , \\ {E}_{j} ( {r}_{j} ) := {c}_{T \cdot j} / {( {K}_{j}^{′} )}^{{r}_{j + 1}} , \\ {r}_{j} := decode ( {E}_{j} ( {r}_{j} ) ) , \\ m := {c}_{T \cdot 0} / {( {K}_{0}^{′} )}^{{r}_{1}} , \\ return m . & [ Formula 201 ]\end{matrix}$$

Embodiment 4

In the above embodiments, the methods for implementing the cryptographic processes in dual vector spaces have been described. In Embodiment 4, a method for implementing the cryptographic processes in dual modules will be described.

That is, in the above embodiments, the cryptographic processes are implemented in cyclic groups of prime order q. However, when a ring R is expressed using a composite number M as indicated in Formula 202, the cryptographic processes described in the above embodiments can be adapted to a module having the ring R as a coefficient.

[symbol]

:= [symbol] /M [symbol] [Formula 202]
where
[symbol] : integer, and
M: composite number.

By changing F_{q} to R in the algorithms described in the above embodiments, the cryptographic processes in dual additive groups can be implemented.

In the above embodiments, it has been described that the re-encryption device 400 re-encrypts a ciphertext and changes the destination of the ciphertext, assuming a case where a message is encrypted with FE and is transmitted to the destination.

FE can be used not only to encrypt a message and transmit the encrypted message to the destination, but also to implement searchable encryption which allows searching without decrypting a ciphertext. When searchable encryption is implemented with FE, a specified search keyword can be changed with the algorithms described in the above embodiments.

In the above embodiments, a user capable of decryption is specified by attribute information which is set in a ciphertext. Then, the destination of the ciphertext is changed by changing the attribute information. When searchable encryption is implemented with FE, a part of attribute information which is set in a ciphertext specifies a user capable of searching, and a part of the remaining attribute information specifies a search keyword. Thus, it is possible to change the specified search keyword by changing the part that specifies the search keyword in the attribute information with the algorithms described in the above embodiments.

In the above embodiments, a single key generation device 100 generates a decryption key. However, it is possible to arrange that a single decryption key is generated by a plurality of key generation devices 100 by combining the algorithms of the above embodiments with a multi-authority scheme described in Non-Patent Literature 5.

In the above embodiments, adding an attribute category (increasing the value of d in the attribute format n^{→}) requires that the public parameter be re-issued. However, it is possible to arrange that an attribute category can be added without re-issuing the public parameter by combining the algorithms of the above embodiments with an unbounded scheme described in Non-Patent Literature 6.

In the above embodiments, when the length of vectors used for inner-product encryption is defined as N, the size of the public parameter and the master secret key is proportional to N², and it takes time proportional to N² to generate or encrypt a decryption key to be given to a user. However, it is possible to reduce the size of the public parameter and the master secret key and reduce the time necessary for generating or encrypting the decryption key to be given to the user by combining the algorithms of the above embodiments with a scheme described in Non-Patent Literature 7.

In the above embodiments, it has been described that a key and a ciphertext are transmitted to a destination device. Alternatively, however, it may be arranged such that a key and a ciphertext are output to a storage medium such as a CD or DVD and a destination device reads the storage medium. Accordingly, “transmit” may be read as “output”, and “receive” may be read as “obtain”.

From the view point of security proof, in the above embodiments, ρ(i) for each integer i=1, . . . , L may be limited to a positive tuple (t, v^{→}) or negative tuple [symbol] (t, v^{→}) for respectively different identification information t.

In other words, when ρ(i)=(t, v^{→}) or ρ(i)= [symbol] (t, v^{→}), let a function ρ^{˜} be map of {1, . . . , L}→{1, . . . , d} such that ρ^{˜}(i)=t. In this case, ρ^{˜} may be limited to injection. Note that ρ(i) is ρ(i) in the access structure S:=(M, ρ(i)) described above.

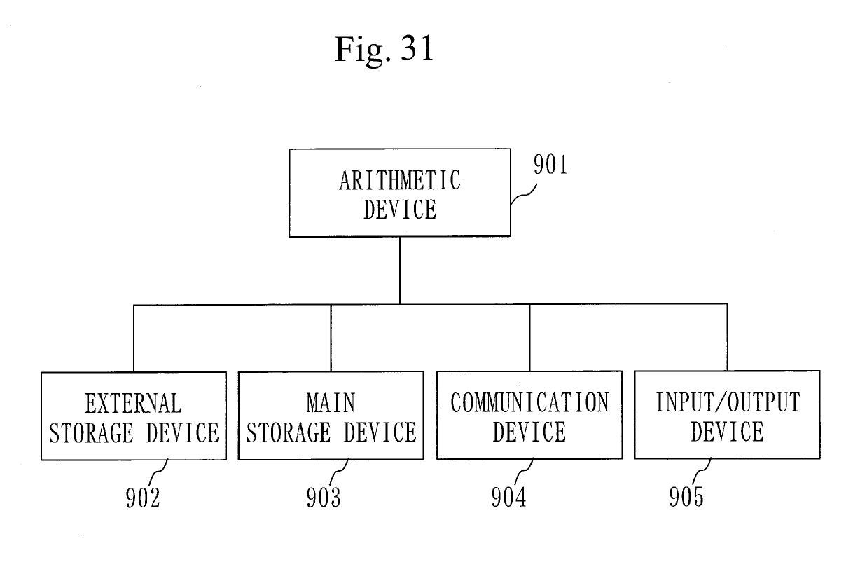

FIG. 31 is a diagram illustrating an example of a hardware configuration of each device (the key generation device 100, the encryption device 200, the decryption device 300, the re-encryption device 400, and the re-encrypted ciphertext decryption device 500) of the cryptographic system 10 presented in Embodiments 1 to 4.

Each device of the cryptographic system 10 is a computer, and each element of each device of the cryptographic system 10 can be implemented by a program.

As the hardware configuration of each device of the cryptographic system 10, an arithmetic device 901, an external storage device 902, a main storage device 903, a communication device 904, and an input/output device 905 are connected to a bus.

The arithmetic device 901 is a CPU (Central Processing Unit) or the like that executes programs. The external storage device 902 is, for example, a ROM (Read Only Memory), a flash memory, a hard disk device, or the like. The main storage device 903 is, for example, a RAM (Random Access Memory) or the like. The communication device 904 is, for example, a communication board or the like. The input/output device 905 is, for example, a mouse, a keyboard, a display device, or the like.

The programs are normally stored in the external storage device 902. The programs loaded into the main storage device 903 to be sequentially read and executed by the arithmetic device 901.

The programs are those that implement the functions described as the master key generation part 110, the master key storage part 120, the information input part 130, the decryption key generation part 140, the key transmission part 150, the public parameter receiving part 210, the information input part 220, the encryption part 230, the ciphertext transmission part 240, the decryption key receiving part 310, the information input part 320, the re-encryption key generation part 330, the re-encryption key transmission part 340, the ciphertext receiving part 350, the span program computation part 360, the complementary coefficient computation part 370, the pairing operation part 380, the message computation part 390, the public parameter receiving part 410, the ciphertext receiving part 420, the re-encryption key receiving part 430, the span program computation part 440,the complementary coefficient computation part 450, the pairing operation part 460,the re-encrypted ciphertext transmission part 470, the decryption key receiving part 510, the ciphertext receiving part 520, the span program computation part 530, the complementary coefficient computation part 540, the pairing operation part 550, the random number computation part 560, and the message computation part 570.

Further, an operating system (OS) is also stored in the external storage device 902. At least part of the OS is loaded into the main storage device 903, and the arithmetic device 901 executes the above-described programs while executing the OS.

Information, data, signal values, and variable values described as the “public parameter pk”, the “master secret key sk”, the “decryption keys sk_{S} and sk_{Γ}”, the “ciphertexts ctⁿ_{Γ} and ctⁿ_{S}”, the “re-encryption keys rkⁿ_{Γ,S′} and rkⁿ_{S,Γ′}”, the “re-encrypted ciphertexts ctⁿ_{S′} and ctⁿ_{Γ′}”, the “access structures S and S”, the “attribute sets Γ and Γ”, the “message m”, and so on in the description of Embodiments 1 to 5 are stored as files in the main storage device 903.

The configuration of FIG. 31 indicates an example of the hardware configuration of each device of the cryptographic system 10. The hardware configuration of each device of the cryptographic system 10 is not limited to the configuration of FIG. 31, and may be a different configuration.

### REFERENCE SIGNS LIST

10: cryptographic system, 100: key generation device, 110: master key generation part, 120: master key storage part, 130: information input part, 140: decryption key generation part, 141: random number generation part, 142: decryption key k* generation part, 143: f vector generation part, 144: s vector generation part, 150: key transmission part, 200: encryption device, 210: public parameter receiving part, 220: information input part, 230: encryption part, 231: f vector generation part, 232: s vector generation part, 233: random number generation part, 234: ciphertext c generation part, 240: ciphertext transmission part, 300: decryption device, 310: decryption key receiving part, 320: information input part, 330: re-encryption key generation part, 331: random number generation part, 332: encryption part, 333: decryption key k*^{rk} generation part, 340: re-encryption key transmission part, 350: ciphertext receiving part, 360: span program computation part, 370: complementary coefficient computation part, 380: pairing operation part, 390: message computation part, 400: re-encryption device, 410: public parameter receiving part, 420: ciphertext receiving part, 430: re-encryption key receiving part, 440: span program computation part, 450: complementary coefficient computation part, 460: pairing operation part, 470: re-encrypted ciphertext transmission part, 500: re-encrypted ciphertext decryption device, 510: decryption key receiving part, 520: ciphertext receiving part, 530: span program computation part, 540: complementary coefficient computation part , 550: pairing operation part, 560: random number computation part, 570: message computation part

1. A cryptographic system to implement a proxy re-encryption function in a cryptographic scheme according to which when two pieces of information correspond to each other, a ciphertext in which is set one of the two pieces of information is capable of being decrypted with a decryption key in which is set the other one of the two pieces of information, the cryptographic system comprising:
an encryption device to output a ciphertext ct₀ in which is set one of attribute information x₀ and attribute information v₀ corresponding to each other;
a re-encryption key generation device to acquire a decryption key k* in which is set the other one of the attribute information x₀ and the attribute information v₀, and output a re-encryption key rk₁ that includes a decryption key k*^{rk}₀ obtained by multiplying the acquired decryption key k* by conversion information r₁, and includes a ciphertext ct′₁ obtained by encrypting the conversion information r₁ with one of attribute information x₁ and attribute information v₁ corresponding to each other being set; and
a re-encryption device to output a re-encrypted ciphertext ct₁ that includes a session key K′₀ generated by computinga pairing operation between the ciphertext ct₀ and the decryption key k*^{rk}₀, and includes the ciphertext ct′₁.

2. The cryptographic system according to claim 1, further comprising:
a re-encrypted ciphertext decryption device to acquire a decryption key k*′ in which is set the other one of the attribute information x₁ and the attribute information v₁, generate the conversion information r₁ by computing a pairing operation between the ciphertext ct′₁ and the acquired decryption key k*′, and generate a message m from the generated conversion information r₁ and the session key K′₀.

3. The cryptographic system according to claim 2,
wherein the re-encrypted ciphertext decryption device outputs a re-encryption key rk₂ that includes a decryption key k*^{rk}₁ obtained by converting the decryption key k*′ with conversion information r₂, and includes a ciphertext ct′₂ obtained by encrypting the conversion information r₂ with one of attribute information x₂ and attribute information v₂ corresponding to each other being set, and
wherein the re-encryption device outputs a re-encrypted ciphertext ct₂ that includes a session key K′₁ generated by computing a pairing operation between the re-encrypted ciphertext ct₁ and the decryption key k*^{rk}₁, and includes the ciphertext ct′₂.

4. The cryptographic system according to claim 1,
wherein the encryption device outputs the ciphertext ct₀ indicated in Formula 1,
wherein the re-encryption key generation device acquires the decryption key k* indicated in Formula 2, and outputs the re-encryption key rk₁ that includes the decryption key k*^{rk}₀ indicated in Formula 3 and the ciphertext ct′₁ indicated in Formula 4, and
wherein the re-encryption device outputs the re-encrypted ciphertext ct₁ that includes the session key K′₀ indicated in Formula 5
$${c}_{0 \cdot 0} := {( ζ , - {s}_{0} )}_{{B}_{0 \cdot 0}} , \\ for \\ i = 1 , … , L , \\ if \\ ρ ( i ) = ( t , {\vec{v}}_{i} ) , \\ {c}_{i \cdot 0} := {( \overbrace{{s}_{i} {\vec{e}}_{t , 1} + {θ}_{i \cdot 0} {\vec{v}}_{t}}^{{n}_{t}} )}_{{B}_{t \cdot 0}} , \\ if \\ ρ ( i ) = ( t , {\vec{v}}_{i} ) , \\ {c}_{i \cdot 0} := {( \overbrace{{s}_{i} {\vec{v}}_{i}}^{{n}_{t}} )}_{{B}_{t \cdot 0}} , \\ {c}_{T \cdot 0} := m \cdot {g}_{T \cdot 0}^{ζ} , \\ {ct}_{0} := ( {c}_{0 \cdot 0} , {\{ {c}_{i \cdot 0} \}}_{i = 1 , … , L} {c}_{T \cdot 0} ) \\ where \\ \vec{f} {}^{U} {F}_{q}^{r} , \\ {\vec{s}}^{T} := {( {s}_{1} , … , {s}_{L} )}^{T} := M \cdot {\vec{f}}^{T} , \\ {s}_{0} := \vec{1} \cdot {\vec{f}}^{T} , \\ ζ , {θ}_{i \cdot 0} {}^{U} {F}_{q} , \\ {v}_{0} := {\vec{v}}_{i} := ( {v}_{1 \cdot 1} , … , {v}_{i \cdot {n}_{i}} ) , \qquad [ Formula 1 ]$$
M is a matrix of L rows and r columns, and
nₜ is an integer of 1 or more,
$$\begin{matrix}{k}_{0 \cdot 0}^{*} := {( 1 , {δ}_{0} )}_{{B}_{0 \cdot 0}^{*}} , \\ {k}_{t \cdot 0}^{*} := {( \overbrace{{δ}_{0} {\vec{x}}_{t}}^{{n}_{t}} )}_{{B}_{t \cdot 0}^{*}} \\ for \\ ( t , {\vec{x}}_{t} ) , ∈ Γ , \\ {k}^{*} := ( {k}_{0 , 0}^{*} , \{ {k}_{t \cdot 0}^{*} \} ( t , {\vec{x}}_{t} ) , ∈ Γ ) \\ where \\ {δ}_{0} {}^{U} {F}_{q} , \\ Γ = ( \{ t , {\vec{x}}_{t} ) , 1 \leq t \leq d \} , \\ {x}_{0} := {\vec{x}}_{t} := ( {x}_{t , 1} , … , {x}_{t , {n}_{t}} ) & [ Formula 2 ] \\ {k}_{0 \cdot 0}^{* rk} := ( {r}_{1} {k}_{0 \cdot 0}^{*} + {( 0 , {δ}_{0}^{ran} )}_{{B}_{0 \cdot 0}^{*}} ) , \\ {k}_{t \cdot 0}^{* rk} := ( {r}_{1} {k}_{t \cdot 0}^{*} + {( {δ}_{0}^{ran} {\vec{x}}_{t} )}_{{B}_{t \cdot 0}^{*}} ) ) \\ for \\ ( t , {\vec{x}}_{t} ) ∈ Γ , \\ {k}_{0}^{* rk} := ( {k}_{0 \cdot 0}^{* rk} , {\{ {k}_{t \cdot 0}^{* rk} \}}_{( t , {\vec{x}}_{t} ) ∈ Γ} ) \\ where \\ {δ}_{0}^{ran} {}^{U} {F}_{q} & [ Formula 3 ] \\ {c}_{0 \cdot 1} := {( {ζ}^{′} , - {s}_{0}^{′} )}_{{B}_{0 \cdot 1}} , \\ for \\ i = 1 , … , {L}^{′} , \\ if \\ {ρ}^{′} ( i ) = ( t , {\vec{v}}_{i}^{′} ) \\ {c}_{i \cdot 1} := {( \overbrace{{s}_{i}^{′} {\vec{e}}_{t , 1} + {θ}_{i \cdot 1}^{′} {\vec{v}}_{t}^{′}}^{{n}_{t}} )}_{{B}_{t \cdot 1}} , \\ if \\ {ρ}^{′} ( i ) = ( t , {\vec{v}}_{i}^{′} ) , \\ {c}_{i \cdot 1} := {( \overbrace{{s}_{i}^{′} {\vec{v}}_{i}^{′}}^{{n}_{t}} )}_{{B}_{t \cdot 1}} , \\ {c}_{T \cdot 1} := ( {E}_{1} ( {r}_{1} ) ) \cdot {g}_{T \cdot 1}^{{ζ}^{′}} , \\ {ct}_{1}^{′} := ( {c}_{0 \cdot 1} , {\{ {c}_{i \cdot 1} \}}_{i = 1 , … , {L}^{′}} , {c}_{T \cdot 1} ) \\ where \\ {\vec{f}}^{′} {}^{U} {F}_{q}^{{r}^{′}} , \\ {\vec{s}}^{′ T} := {( {s}_{1}^{′} , … , {s}_{L}^{′} )}^{T} := {M}^{′} \cdot {\vec{f}}^{′ T} , \\ {s}_{0}^{′} := \vec{1} \cdot {\vec{f}}^{′ T} , \\ {ζ}^{′} , {θ}_{i \cdot 1}^{′} {}^{U} {F}_{q} , \\ {v}_{1} := {\vec{v}}_{i}^{′} := ( {v}_{i \cdot 1}^{′} , … , {v}_{i \cdot {n}_{t}}^{′} ) , & [ Formula 4 ]\end{matrix}$$
E₁ is an encode function,
$${K}_{0}^{′} := e ( {c}_{0 \cdot 0} , {k}_{0 \cdot 0}^{* rk} ) \cdot {\prod }_{i ∈ I ⋀ ρ ( i ) = ( t , {\vec{v}}_{i} )} e ( {c}_{t \cdot 0} , {k}_{t \cdot 0}^{* rk} ) {α}_{i} \cdot {\prod }_{i ∈ I ⋀ ρ ( i ) = ( t , {\vec{v}}_{i} )} e ( {c}_{i \cdot 0} , {k}_{t \cdot 0}^{* rk} ) {α}_{i} / ( {\vec{v}}_{i} \cdot {\vec{x}}_{t} ) \\ where \\ \vec{I} = {\sum }_{i ∈ I} {α}_{i} {M}_{i} \qquad [ Formula 5 ]$$
where Mᵢ is the i-th row of M,
and I⊂{i∈{1, . . . , L}|[ρ(i)=(t, \vec{v}ᵢ) [symbol] (t, \vec{x}ₜ)∈Γ [symbol] \vec{v}ᵢ·\vec{x}ₜ=0] [symbol] [ρ(i)= [symbol] (t, \vec{v}ᵢ) [symbol] (t, \vec{x}ₜ)∈Γ [symbol] \vec{v}ᵢ·\vec{x}ₜ≠0]}.

5. The cryptographic system according to claim 1,
wherein the encryption device outputs the ciphertext ct₀ indicated in Formula 6,
wherein the re-encryption key generation device acquires the decryption key k* indicated in Formula 7, and outputs the re-encryption key rk₁ that includes the decryption key k*^{rk}₀ indicated in Formula 8 and the ciphertext ct′₁ indicated in Formula 9, and
wherein the re-encryption device outputs the re-encrypted ciphertext ct₁ that includes the session key K′₀ indicated in Formula 10
$${c}_{0 \cdot 0} := {( ζ , - {s}_{0} )}_{{B}_{0}} , \\ for \\ i = 1 , … , L , \\ if \\ ρ ( i ) = ( t , {\vec{v}}_{i} ) , \\ {c}_{i \cdot 0} := ( \overbrace{{μ}_{0} ( 0 , - 1 ) ,}^{2} {( \overbrace{{s}_{i} {\vec{e}}_{t , 1} + {θ}_{i \cdot 0} {\vec{v}}_{t}}^{{n}_{t}} )}_{{B}_{t}} \\ if \\ ρ ( i ) = ( t , {\vec{v}}_{i} ) , \\ {c}_{i \cdot 0} := ( \overbrace{{μ}_{0} ( 0 , - 1 ) ,}^{2} {( \overbrace{{s}_{i} {\vec{v}}_{t}}^{{n}_{t}} )}_{{B}_{t}} , \\ {c}_{T \cdot 0} := m \cdot {g}_{T}^{ζ} , \\ {ct}_{0} := ( {c}_{0 \cdot 0} , {\{ {c}_{i \cdot 0} \}}_{i = 1 , … , L} , {c}_{T \cdot 0} ) \\ where \\ \vec{f} {}^{U} {F}_{q}^{r} , \\ {\vec{s}}^{ T} := {( {s}_{1} , … , {s}_{L} )}^{T} := M \cdot {\vec{f}}^{ T} , \\ {s}_{0} := \vec{1} \cdot {\vec{f}}^{ T} , \\ ζ , {θ}_{i \cdot 1} , {μ}_{0} {}^{U} {F}_{q} , \\ {v}_{0} := {\vec{v}}_{i} := ( {v}_{i \cdot 1} , … , {v}_{i \cdot {n}_{t}} ) , \qquad [ Formula 6 ]$$
M is a matrix of L rows and r columns, and
nₜ is an integer of 1 or more,
$$\begin{matrix}{k}_{0 \cdot 0}^{*} := {( 1 , {δ}_{0} )}_{{B}_{0}^{*}} , \\ {k}_{t \cdot 0}^{*} := {( \overbrace{{0}^{2} ,}^{2} \overbrace{{δ}_{0} {\vec{x}}_{t}}^{{n}_{t}} )}_{{B}_{t}^{*}} \\ for \\ ( t , {\vec{x}}_{t} ) , ∈ Γ , \\ {k}^{*} := ( {k}_{0 , 0}^{*} , \{ {k}_{t \cdot 0}^{*} \} ( t , {\vec{x}}_{t} ) , ∈ Γ ) \\ where \\ {δ}_{0} {}^{U} {F}_{q} , \\ Γ = ( \{ t , {\vec{x}}_{t} ) , 1 \leq t \leq d \} , \\ {x}_{0} := {\vec{x}}_{t} := ( {x}_{t , 1} , … , {x}_{t , {n}_{t}} ) & [ Formula 7 ] \\ {k}_{0 \cdot 0}^{* rk} := ( {r}_{1} {k}_{0 \cdot 0}^{*} + {( 0 , {δ}_{0}^{ran} )}_{{B}_{0}^{*}} ) , \\ {k}_{t \cdot 0}^{* rk} := ( {r}_{1} {k}_{t \cdot 0}^{*} + ( {σ}_{0} ( 1 , 0 ) , {( {δ}_{0}^{ran} {\vec{x}}_{t} )}_{{B}_{t}^{*}} ) ) \\ for \\ ( t , {\vec{x}}_{t} ) ∈ Γ , \\ {k}_{0}^{* rk} := ( {k}_{0 \cdot 0}^{* rk} , {\{ {k}_{t \cdot 0}^{* rk} \}}_{( t , {\vec{x}}_{t} ) ∈ Γ} ) \\ where \\ {δ}_{0}^{ran} , {σ}_{0} {}^{U} {F}_{q} & [ Formula 8 ] \\ {c}_{0 \cdot 1} := {( {ζ}^{′} , - {s}_{0}^{′} )}_{{B}_{0}} , \\ for \\ i = 1 , … , {L}^{′} , \\ if \\ {ρ}^{′} ( i ) = ( t , {\vec{v}}_{i}^{′} ) \\ {c}_{i \cdot 1} := {( \overbrace{{μ}_{1} ( 1 , - 1 ) ,}^{2} \overbrace{{s}_{i}^{′} {\vec{e}}_{t , 1} + {θ}_{i}^{′} {\vec{v}}_{t}^{′} ,}^{{n}_{t}} )}_{{B}_{t}} , \\ if \\ {ρ}^{′} ( i ) = ( t , {\vec{v}}_{i}^{′} ) , \\ {c}_{i \cdot 1} := {( \overbrace{{μ}_{1} ( 1 , - 1 ) ,}^{2} \overbrace{{s}_{i}^{′} {\vec{v}}_{t}^{′} ,}^{{n}_{t}} )}_{{B}_{t}} , \\ {c}_{T \cdot 1} := ( {E}_{1} ( {r}_{1} ) ) \cdot {g}_{T}^{{ζ}^{′}} , \\ {ct}_{1}^{′} := ( {c}_{0 \cdot 1} , {\{ {c}_{i \cdot 1} \}}_{i = 1 , … , {L}^{′}} , {c}_{T \cdot 1} ) \\ where \\ {\vec{f}}^{′} {}^{U} {F}_{q}^{{r}^{′}} , \\ {\vec{s}}^{′ T} := {( {s}_{1}^{′} , … , {s}_{L}^{′} )}^{T} := {M}^{′} \cdot {\vec{f}}^{′ T} , \\ {s}_{0}^{′} := \vec{1} \cdot {\vec{f}}^{′ T} , \\ {ζ}^{′} , {θ}_{i \cdot 1}^{′} , {μ}_{1} {}^{U} {F}_{q} , \\ {v}_{1} := {\vec{v}}_{i}^{′} := ( {v}_{i \cdot 1}^{′} , … , {v}_{i \cdot {n}_{t}}^{′} ) , & [ Formula 9 ]\end{matrix}$$
E₁ is an encode function,
$${K}_{0}^{′} := e ( {c}_{0 \cdot 0} , {k}_{0 \cdot 0}^{* rk} ) \cdot {\prod }_{i ∈ I ⋀ ρ ( i ) = ( t , {\vec{v}}_{i} )} e ( {c}_{i \cdot 0} , {k}_{t \cdot 0}^{* rk} ) {α}_{i} \cdot {\prod }_{i ∈ I ⋀ ρ ( i ) = ( t , {\vec{v}}_{i} )} e ( {c}_{i \cdot 0} , {k}_{t \cdot 0}^{* rk} ) {α}_{i} / ( {\vec{v}}_{i} \cdot {\vec{x}}_{t} ) \\ where \\ \vec{I} = {\sum }_{i ∈ I} {α}_{i} {M}_{i} \qquad [ Formula 10 ]$$
where Mᵢ is the i-th row of M,
and I⊂{i∈{1, . . . , L}|[ρ(i) =(t, \vec{v}ᵢ) [symbol] (t, \vec{x}ₜ)∈Γ [symbol] \vec{v}ᵢ·\vec{x}ₜ=0] [symbol] [ρ(i)= [symbol] (t, \vec{v}ᵢ) [symbol] (t, \vec{x}ₜ)∈Γ [symbol] \vec{v}ᵢ·\vec{x}ₜ≠0]}.

6. The cryptographic system according to claim 1,
wherein the encryption device outputs the ciphertext ct₀ indicated in Formula 11,
wherein the re-encryption key generation device acquires the decryption key k* indicated in Formula 12, and outputs the re-encryption key rk₁ that includes the decryption key k*^{rk}₀ indicated in Formula 13 and the ciphertext ct′₁ indicated in Formula 14, and
wherein the re-encryption device outputs the re-encrypted ciphertext ct₁ that includes the session key K′₀ indicated in Formula 15
$${c}_{0 \cdot 0} := {( ζ , {δ}_{0} )}_{{B}_{0 \cdot 0}} , \\ {c}_{t \cdot 0} := {( \overbrace{{δ}_{0} {\vec{v}}_{i}}^{{n}_{t}} )}_{{B}_{t \cdot 0}} \\ for \\ ( t , {\vec{x}}_{t} ) , ∈ Γ , \\ {c}_{T \cdot 0} := m \cdot {δ}_{T \cdot 0}^{ζ} , \\ {ct}_{0} := ( {c}_{0 \cdot 0} , {\{ {c}_{t \cdot 0} \}}_{( t , {\vec{x}}_{t} ) , ∈ Γ} , {c}_{T \cdot 0} ) \\ where \\ ζ , {δ}_{0} {}^{U} {F}_{q} , \\ Γ = ( \{ t , {\vec{x}}_{t} ) , 1 \leq t \leq d \} , \\ {x}_{0} := {\vec{x}}_{t} := ( {x}_{t , 1} , … , {x}_{t , {n}_{t}} ) , \qquad [ Formula 11 ]$$
nₜ is an integer of 1 or more,
$${k}_{0 \cdot 0}^{*} := {( 1 , - {s}_{0} )}_{{B}_{0 \cdot 0}^{*}} , \\ for \\ i = 1 , … , L , \\ if \\ ρ ( i ) = ( t , {\vec{v}}_{i} ) , \\ {k}_{i \cdot 0} := {( \overbrace{{s}_{i} {\vec{e}}_{t , 1} + {θ}_{i} {\vec{v}}_{t}}^{{n}_{t}} )}_{{B}_{t \cdot 0}^{*}} , \\ if \\ ρ ( i ) = ( t , {\vec{v}}_{i} ) , \\ {k}_{i \cdot 0} := {( \overbrace{{s}_{i} {\vec{v}}_{t}}^{{n}_{t}} )}_{{B}_{t \cdot 0}^{*}} , \\ {k}^{*} := ( {k}_{0 \cdot 0}^{*} , {\{ {k}_{i \cdot 0}^{*} \}}_{i = 1 , … , L} ) \\ where \\ \vec{f} {}^{U} {F}_{q}^{r} , \\ {\vec{s}}^{ T} := {( {s}_{1} , … , {s}_{L} )}^{T} := M \cdot {\vec{f}}^{ T} , \\ {s}_{0} := \vec{1} \cdot {\vec{f}}^{ T} , \\ ζ , {θ}_{i \cdot 0} {}^{U} {F}_{q} , \\ {v}_{0} := {\vec{v}}_{i} := ( {v}_{i \cdot 1} , … , {v}_{i \cdot {n}_{t}} ) , \qquad [ Formula 12 ]$$
M is a matrix of L rows and r columns,
$$\begin{matrix} {k}_{0 \cdot 0}^{* rk} := {r}_{1} {k}_{0 \cdot 0}^{*} , \\ {k}_{i \cdot 0}^{* rk} := {r}_{1} {k}_{i \cdot 0}^{*} \\ for \\ i = 1 , … , L , \\ {k}_{0}^{* rk} := ( {k}_{0 \cdot 0}^{* rk} , {\{ {k}_{i \cdot 0}^{* rk} \}}_{i = 1 , … , L} ) & [ Formula 13 ] \\ {c}_{0 \cdot 1} := {( {ζ}^{′} , {δ}_{1} )}_{{B}_{0 \cdot 1}} , \\ {c}_{t \cdot 1} := {( \overbrace{{δ}_{1} {\vec{x}}_{t}^{′}}^{{n}_{t}} )}_{{B}_{t \cdot 1}} \\ for \\ ( t , {\vec{x}}_{t}^{′} ) , ∈ Γ , \\ {c}_{T \cdot 1} := m \cdot {g}_{T \cdot 1}^{ζ} , \\ {ct}_{1}^{′} := ( {c}_{0 \cdot 1} , {\{ {c}_{t \cdot 1} \}}_{( t , {\vec{x}}_{t}^{′} ) , ∈ Γ} , {c}_{T \cdot 1} ) \\ where \\ {ζ}^{′} , {δ}_{1} {}^{U} {F}_{q} , \\ {Γ}^{′} = ( \{ t , {\vec{x}}_{t}^{′} ) , 1 \leq t \leq d \} , \\ {x}_{1} := {\vec{x}}_{t}^{′} := ( {x}_{t , 1}^{′} , … , {x}_{t , {n}_{t}}^{′} ) , & [ Formula 14 ] \\ {K}_{0}^{′} := e ( {c}_{0 \cdot 0} , {k}_{0 \cdot 0}^{* rk} ) \cdot {\prod }_{i ∈ I ⋀ ρ ( i ) = ( t , {\vec{v}}_{i} )} e ( {c}_{t \cdot 0} , {k}_{i \cdot 0}^{* rk} ) {α}_{i} \cdot {\prod }_{i ∈ I ⋀ ρ ( i ) = ( t , {\vec{v}}_{i} )} e ( {c}_{t \cdot 0} , {k}_{i \cdot 0}^{* rk} ) {α}_{i} / ( {\vec{v}}_{i} \cdot {\vec{x}}_{t} ) \\ where \\ \vec{I} = {\sum }_{i ∈ I} {α}_{i} {M}_{i} & [ Formula 15 ]\end{matrix}$$
where Mᵢ is the i-th row of M,
and I⊂{i∈{1, . . . , L}|[ρ(i)=(t, \vec{v}ᵢ) [symbol] (t, \vec{x}ₜ)∈Γ [symbol] \vec{v}ᵢ·\vec{x}ₜ=0] [symbol] [ρ(i)= [symbol] (t, \vec{v}ᵢ) [symbol] (t, \vec{x}ₜ)∈Γ [symbol] \vec{v}ᵢ·\vec{x}ₜ≠0]}

7. The cryptographic system according to claim 1,
wherein the encryption device outputs the ciphertext ct₀ indicated in Formula 16,
wherein the re-encryption key generation device acquires the decryption key k* indicated in Formula 17, and outputs the re-encryption key rk₁ that includes the decryption key k*^{rk}₀ indicated in Formula 18 and the ciphertext ct′₁ indicated in Formula 19, and
wherein the re-encryption device outputs the re-encrypted ciphertext ct₁ that includes the session key K′₀ indicated in Formula 20
$${c}_{0 \cdot 0} := {( ζ , {δ}_{0} )}_{{B}_{0 \cdot 0}} , \\ {c}_{t \cdot 0} := {( \overbrace{{σ}_{0} ( 1 , 0 ) ,}^{2} \overbrace{{δ}_{0} {\vec{x}}_{t} ,}^{{n}_{t}} )}_{{B}_{t}} \\ for \\ ( t , {\vec{x}}_{t} ) , ∈ Γ , \\ {c}_{T \cdot 0} := m \cdot {δ}_{T \cdot 0}^{ζ} , \\ {ct}_{0} := ( {c}_{0 \cdot 0} , {\{ {c}_{t \cdot 0} \}}_{( t , {\vec{x}}_{t} ) , ∈ Γ} , {c}_{T \cdot 0} ) \\ where \\ ζ , {δ}_{0} , {σ}_{0} {}^{U} {F}_{q} , \\ Γ = ( \{ t , {\vec{x}}_{t} ) , 1 \leq t \leq d \} , \\ {x}_{0} := {\vec{x}}_{t} := ( {x}_{t , 1} , … , {x}_{t , {n}_{t}} ) , \qquad [ Formula 16 ]$$
nₜ is an integer 1 or more,
$${k}_{0 \cdot 0}^{*} := {( 1 , - {s}_{0} )}_{{B}_{0 \cdot 0}^{*}} , \\ for \\ i = 1 , … , L , \\ if \\ ρ ( i ) = ( t , {\vec{v}}_{i} ) , \\ {k}_{i \cdot 0} := {( \overbrace{{μ}_{0} ( 0 , - 1 ) ,}^{2} \overbrace{{s}_{i} {\vec{e}}_{t , 1} + {θ}_{i} {\vec{v}}_{t} ,}^{{n}_{t}} )}_{{B}_{t}^{*}} , \\ if \\ ρ ( i ) = ( t , {\vec{v}}_{i} ) , \\ {k}_{i \cdot 0} := {( \overbrace{{μ}_{0} ( 0 , - 1 ) ,}^{2} \overbrace{{s}_{i} {\vec{v}}_{t} ,}^{{n}_{t}} )}_{{B}_{t}^{*}} , \\ {k}^{*} := ( {k}_{0 \cdot 0}^{*} , {\{ {k}_{i \cdot 0}^{*} \}}_{i = 1 , … , L} ) \\ where \\ \vec{f} {}^{U} {F}_{q}^{r} , \\ {\vec{s}}^{ T} := {( {s}_{1} , … , {s}_{L} )}^{T} := M \cdot {\vec{f}}^{ T} , \\ {s}_{0} := \vec{1} \cdot {\vec{f}}^{ T} , \\ ζ , {θ}_{i \cdot 0} {{μ}_{0}}^{U} {F}_{q} , \\ {v}_{0} := {\vec{v}}_{i} := ( {v}_{i \cdot 1} , … , {v}_{i \cdot {n}_{t}} ) , \qquad [ Formula 17 ]$$
M is a matrix of L rows and r columns,
$$\begin{matrix} {k}_{0 \cdot 0}^{* rk} := {r}_{1} {k}_{0 \cdot 0}^{*} , \\ {k}_{i \cdot 0}^{* rk} := {r}_{1} {k}_{i \cdot 0}^{*} \\ for \\ i = 1 , … , L , \\ {k}_{0}^{* rk} := ( {k}_{0 \cdot 0}^{* rk} , {\{ {k}_{i \cdot 0}^{* rk} \}}_{i = 1 , … , L} ) & [ Formula 18 ] \\ {c}_{0 \cdot 1} := {( {ζ}^{′} , {δ}_{1} )}_{{B}_{0}} , \\ {c}_{t \cdot 1} := {( \overbrace{{σ}_{1} ( 1 , 1 ) ,}^{2} \overbrace{{δ}_{1} {\vec{x}}_{t}^{′}}^{{n}_{t}} )}_{{B}_{t}} \\ for \\ ( t , {\vec{x}}_{t}^{′} ) , ∈ Γ , \\ {c}_{T \cdot 1} := m \cdot {g}_{T}^{ζ} , \\ {ct}_{1}^{′} := ( {c}_{0 \cdot 1} , {\{ {c}_{t \cdot 1} \}}_{( t , {\vec{x}}_{t}^{′} ) , ∈ Γ} , {c}_{T \cdot 1} ) \\ where \\ {ζ}^{′} , {δ}_{1} , {σ}_{1} {}^{U} {F}_{q} , \\ {Γ}^{′} = ( \{ t , {\vec{x}}_{t}^{′} ) , 1 \leq t \leq d \} , \\ {x}_{1} := {\vec{x}}_{t}^{′} := ( {x}_{t , 1}^{′} , … , {x}_{t , {n}_{t}}^{′} ) , & [ Formula 19 ] \\ {K}_{0}^{′} := e ( {c}_{0 \cdot 0} , {k}_{0 \cdot 0}^{* rk} ) \cdot {\prod }_{i ∈ I ⋀ ρ ( i ) = ( t , {\vec{v}}_{i} )} e ( {c}_{t \cdot 0} , {k}_{i \cdot 0}^{* rk} ) {α}_{i} \cdot {\prod }_{i ∈ I ⋀ ρ ( i ) = ( t , {\vec{v}}_{i} )} e ( {c}_{t \cdot 0} , {k}_{i \cdot 0}^{* rk} ) {α}_{i} / ( {\vec{v}}_{i} \cdot {\vec{x}}_{t} ) \\ where \\ \vec{I} = {\sum }_{i ∈ I} {α}_{i} {M}_{i} & [ Formula 20 ]\end{matrix}$$
where Mᵢ is the i-th row of M,
and I⊂{i∈{1, . . . , L}|[ρ(i)=(t, \vec{v}ᵢ) [symbol] (t, \vec{x}ₜ)∈Γ [symbol] \vec{v}ᵢ·\vec{x}ₜ=0] [symbol] [ρ(i)= [symbol] (t, \vec{v}ᵢ) [symbol] (t, \vec{x}ₜ)∈Γ [symbol] \vec{v}ᵢ·\vec{x}ₜ≠0]}.

8. A re-encryption key generation device in a cryptographic system to implement a proxy re-encryption function in a cryptographic scheme according to which when two pieces of information correspond to each other, a ciphertext in which is set one of the two pieces of information is capable of being decrypted with a decryption key in which is set the other one of the two pieces of information, the re-encryption key generation device comprising:
processing circuitry to:
acquire a decryption key k* in which is set the other one of attribute information x₀ and attribute information v₀ corresponding to each other; and
output a re-encryption key rk₁ that includes a decryption key k*^{rk}₀ obtained by multiplying the decryption key k* by conversion information r₁, and includes a ciphertext ct′₁ obtained by encrypting the conversion information r₁ with one of attribute information x₁ and attribute information v₁ corresponding to each other being set.

9. A re-encryption device in a cryptographic system to implement a proxy re-encryption function in a cryptographic scheme according to which when two pieces of information correspond to each other, a ciphertext in which is set one of the two pieces of information is capable of being decrypted with a decryption key in which is set the other one of the two pieces of information, the re-encryption device comprising:
processing circuitry to:
acquire a ciphertext ct₀ in which is set one of attribute information x₀ and attribute information v₀ corresponding to each other; acquire a re-encryption key rk₁ that includes a decryption key k*^{rk}₀ obtained by multiplying a decryption key k* in which is set the other one of the attribute information x₀ and the attribute information v₀ by conversion information r₁, and includes a ciphertext ct′₁ obtained by encrypting the conversion information r₁ with one of attribute information x₁ and attribute information v₁ corresponding to each other being set; and
output a re-encrypted ciphertext ct₁ that includes a session key K′₀ generated by computing a pairing operation between the ciphertext ct₀ and the decryption key k*^{rk}₀, and includes the ciphertext ct′₁.

10. A non-transitory computer readable medium storing a cryptographic program for implementing a proxy re-encryption function in a cryptographic scheme according to which when two pieces of information correspond to each other, a ciphertext in which is set one of the two pieces of information is capable of being decrypted with a decryption key in which is set the other one of the two pieces of information, the cryptographic program causing a computer to execute:
an encryption process of outputting a ciphertext ct₀ in which is set one of attribute information x₀ and attribute information v₀ corresponding to each other;
a re-encryption key generation process of acquiring a decryption key k* in which is set the other one of the attribute information x₀ and the attribute information v₀, and outputting a re-encryption key rk₁ that includes a decryption key k*^{rk}₀ obtained by converting multiplying the acquired decryption key k* by conversion information r₁, and includes a ciphertext ct′₁ obtained by encrypting the conversion information r₁ with one of attribute information x₁ and attribute infoimation v₁ corresponding to each other being set; and
a re-encryption process of outputting a re-encrypted ciphertext ct₁ that includes a session key K′₀ generated by computing a pairing operation between the ciphertext ct₀ with the decryption key k*^{rk}₀, and includes the ciphertext ct′₁.
